(19) United States
(12) Patent Application Publication
(10) Pub. No.: US 2024/0254146 A1
(43) Pub. Date: Aug. 1, 2024

(54) FLUORINATED POLY(PYRIDYL)-BORATE LIGANDS

(71) Applicant: BOARD OF REGENTS, THE UNIVERSITY OF TEXAS SYSTEM, Austin, TX (US)

(72) Inventors: Rasika Dias, Arlington, TX (US); Mukundam Vanga, Arlington, TX (US)

(21) Appl. No.: 18/394,113

(22) Filed: Dec. 22, 2023

Related U.S. Application Data
(60) Provisional application No. 63/477,034, filed on Dec. 23, 2022.

(51) Int. Cl. C07F 5/02; C07F 1/00; C07F 1/08

(52) U.S. Cl. CPC C07F 5/027; C07F 1/00; C07F 1/08

(57) ABSTRACT

Disclosed herein are poly(pyridyl)borate ligands and metal complexes comprising the poly(pyridyl)borate ligands. Also disclosed herein are methods of making and methods of using said poly(pyridyl)borate ligands and metal complexes comprising the poly(pyridyl)borate ligands. Also disclosed herein are methods of preparing a poly(pyridyl)borate ligand comprising reacting a boron precursor comprising a trifluoroborate to form the poly(pyridyl)borate ligand.

### CROSS-REFERENCE TO RELATED APPLICATIONS

The application claims the benefit of priority to, and the benefit of, U.S. Provisional Application No. 63/477,034 filed on Dec. 23, 2022, the disclosure of which is hereby expressly incorporated by reference herein in its entirety.

### STATEMENT ACKNOWLEDGING GOVERNMENT SUPPORT

This invention was made with government support under Grant No. CHE-1954456 awarded by the National Science Foundation. The Government has certain rights in the invention.

### BACKGROUND

Poly(pyrazolyl)borates (which belong to a family known as scorpionates) are useful supporting ligands in metal coordination chemistry. These ligands are uniquely desirable for many important applications ranging from catalysis to the isolation of reaction intermediates. The pyridine-based poly(pyridyl)borates are a recent addition to the scorpionate family. Tris(pyridyl)borates present a different steric profile to the coordinated metal site, boron-carbon links and a different ligand backbone. However, current poly(pyridyl)borates are limited in their applications.

### SUMMARY

Disclosed herein are compounds, compositions, methods for making and using such compounds and compositions.

In some examples, the poly(pyridyl)borate ligand is defined by Formula I:

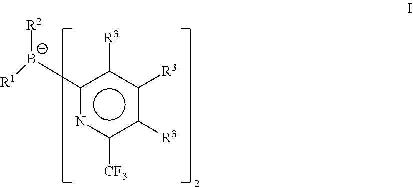

wherein
R¹ and R² are independently selected from hydrogen, a substituted or unsubstituted C₁-C₄ alkyl, a substituted or unsubstituted C₆-C₁₀ aryl or C₄-C₁₀ heteroaryl, or a halogen; and each R³ is independently hydrogen, a halogen, a substituted or unsubstituted C₁-C₄ alkyl, or a substituted or unsubstituted C₁-C₄ alkoxy.

In some examples, the poly(pyridyl)borate ligand is defined by Formula II:

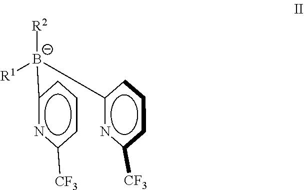

wherein
R¹ and R² are independently selected from hydrogen, a substituted or unsubstituted C₁-C₄ alkyl, a substituted or unsubstituted C₆-C₁₀ aryl or C₄-C₁₀ heteroaryl, or a halogen.

In some examples, the poly(pyridyl)borate ligand is further defined by Formula III:

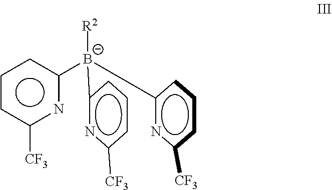

wherein
R² is selected from hydrogen, a substituted or unsubstituted C₁-C₄ alkyl, a substituted or unsubstituted C₆-C₁₀ aryl or C₄-C₁₀ heteroaryl, or a halogen.

The present disclosure additionally relates to metal complexes comprising the poly(pyridyl)borate ligand described herein. In some examples, the metal complex is defined by Formula IV:

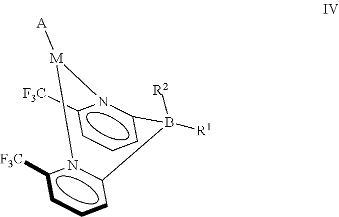

wherein
R¹ and R² are independently selected from hydrogen, a substituted or unsubstituted C₁-C₄ alkyl, a substituted or unsubstituted C₆-C₁₀ aryl or C₄-C₁₀ heteroaryl, or a halogen; M is a transition metal; and A is an olefin, isocyanide, or CO.

In some examples, the metal complex is defined by Formula V:

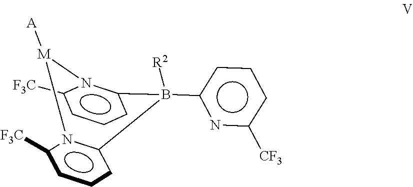

wherein
R² is selected from hydrogen, a substituted or unsubstituted C₁-C₄ alkyl, a substituted or unsubstituted C₆-C₁₀ aryl or C₄-C₁₀ heteroaryl, or a halogen;
M is a metal; and
A is an olefin, isocyanide, or CO.

Also provided herein is a method of preparing a poly(pyridyl)borate ligand comprising: contacting a boron precursor comprising a trifluoroborate with a pyridine reagent to form the poly(pyridyl)borate ligand.

Additional advantages of the disclosed subject matter will be set forth in part in the description that follows and the Figures, and in part will be obvious from the description, or can be learned by practice of the aspects described below. The advantages described below will be realized and attained by means of the elements and combinations particularly pointed out in the appended claims. It is to be understood that both the foregoing general description and the following detailed description are exemplary and explanatory only and are not restrictive.

### BRIEF DESCRIPTION OF THE FIGURES

The accompanying figures, which are incorporated in and constitute a part of this specification, illustrate several aspects described below.

FIG. 1. Fluorinated tris(2-pyridyl)borate, [t-BuPhB(6-(CF₃)Py)₃]⁻ (1A) and a tris(pyrazolyl)borate analog [PhB(3-(CF₃)Pz)₃]⁻ (2A).

FIG. 2. Molecular structures of [t-BuPhB(6-(CF₃)Py)₃]M(C₂H₄) (M=Cu (3A), top-left; Ag top-right (4A); Au bottom (5A)).

FIG. 3. Structures of a tris(pyrazolyl)borate [HB(3,5-(CF₃)₂Pz)₃]⁻ (1B), bis(pyrazolyl)borate [H₂B(3,5-(CF₃)₂Pz)₂]⁻ (2B), tris(2-pyridyl)borate [t-BuC₆H₄B(6-(CF₃)Py)₃]⁻ (3B) and bis(2-pyridyl)borate [Ph₂B(6-(CF₃)Py)₂]⁻ (4B).

FIG. 4. Molecular structure of [Ph₂B(6-(CF₃)Py)₂]Cu(CNBu^{t}) (6B) (Top-left), [Ph₂B(6-(CF₃)Py)₂]Ag(CNBu^{t}) (7B) (Top-right), [t-BuC₆H₄B(6-(CF₃)Py)₃]Cu(CNBu^{t}) (8B) (Bottom-left) and [t-BuC₆H₄B(6-(CF₃)Py)₃]Ag(CNBu^{t}) (9B) (Bottom-right). Selected bond distances (Å) and angles (°) are given in Table 5.

FIG. 5. Molecular structure of [Ph₂B(6-(CF₃)Py)₂]Cu(CO) (11B) (Top), [t-BuC₆H₄B(6-(CF₃)Py)₃]Cu(CO) (13B) (Bottom-left) and [t-BuC₆H₄B(6-(CF₃)Py)₃]Ag(CO) (14B) (Bottom-right). Selected bond distances (Å) and angles (°) are given in Table 7.

FIG. 6. Molecular structure of [PhB(3-(CF₃)Pz)₃]Cu(CO) (15B). Selected bond distances (Å) and angles (°): Cu—N2 2.0742(18), Cu—N4 2.0248(18), Cu—N6 2.0563(18), Cu—C19 1.804(2), O—C19 1.126(3), N4-Cu—N2 90.02(7), N4-Cu—N6 88.39(7), N6-Cu—N2 90.82(7), O—C19-Cu 176.0(2).

FIG. 7. Bis(pyridyl)borate (1) and tris(pyridyl)borate (2) ligands, and the recently reported coinage metal complexes 3-7 of pyridyl-ring substituted, B-arylated ligand analogs, and the B-methylated ligands 8 and 9 described in this disclosure.

FIG. 8. B-phenyl and B-methyl substituted, tris(pyrazolyl)borate silver(I) complexes of ethylene, [PhB(3-(CF₃)Pz)₃]Ag(C₂H₄) and [MeB(3-(CF₃)Pz)₃]Ag(C₂H₄) (10, 11).

FIG. 9. Molecular structures of the B-methylated tris(pyridyl)borate [MeB(6-(CF₃)Py)₃]H (left, 9-H), and bis(pyridyl)borate [Me₂B(6-(CF₃)Py)₂]H (right, 8-H).

FIG. 10. Molecular structures of the B-methylated tris(pyridyl)borate [MeB(6-(CF₃)Py)₃]Cu(C₂H₄) (top-left, 12), [MeB(6-(CF₃)Py)₃]Ag(C₂H₄) (top-right, 13), and [MeB(6-(CF₃)Py)₃]Au(C₂H₄) (bottom, 14).

FIG. 11. Molecular structures of the B-methylated bis(pyridyl)borate [Me₂B(6-(CF₃)Py)₂]Cu(C₂H₄) (left, 15) and [Me₂B(6-(CF₃)Py)₂]Au(C₂H₄) (right, 17).

### DETAILED DESCRIPTION

The materials, compounds, compositions, articles, and methods described herein may be understood more readily by reference to the following detailed description of specific aspects of the disclosed subject matter and the Examples and Figures included therein.

Before the present materials, compounds, compositions, and methods are disclosed and described, it is to be understood that the aspects described below are not limited to specific synthetic methods or specific reagents, as such may, of course, vary. It is also to be understood that the terminology used herein is for the purpose of describing particular aspects only and is not intended to be limiting.

Also, throughout this specification, various publications are referenced. The disclosures of these publications in their entireties are hereby incorporated by reference into this application in order to more fully describe the state of the art to which the disclosed matter pertains. The references disclosed are also individually and specifically incorporated by reference herein for the material contained in them that is discussed in the sentence in which the reference is relied upon.

### General Definitions

In this specification and in the claims that follow, reference will be made to a number of terms, which shall be defined to have the following meanings:

Throughout the description and claims of this specification the word “comprise” and other forms of the word, such as “comprising” and “comprises,” means including but not limited to, and is not intended to exclude, for example, other additives, components, integers, or steps.

As used in the description and the appended claims, the singular forms “a,” “an,” and “the” include plural referents unless the context clearly dictates otherwise. Thus, for example, reference to “a composition” includes mixtures of two or more such compositions, reference to “the compound” includes mixtures of two or more such compounds, reference to “an agent” includes mixture of two or more such agents, and the like.

“Optional” or “optionally” means that the subsequently described event or circumstance can or cannot occur, and that the description includes instances where the event or circumstance occurs and instances where it does not.

It is understood that throughout this specification the identifiers “first” and “second” are used solely to aid in distinguishing the various components and steps of the disclosed subject matter. The identifiers “first” and “second” are not intended to imply any particular order, amount, preference, or importance to the components or steps modified by these terms.

### Chemical Definitions

As used herein, the term “substituted” is contemplated to include all permissible substituents of organic compounds. In a broad aspect, the permissible substituents include acyclic and cyclic, branched and unbranched, carbocyclic and heterocyclic, and aromatic and nonaromatic substituents of organic compounds. Illustrative substituents include, for example, those described below. The permissible substituents can be one or more and the same or different for appropriate organic compounds. For purposes of this disclosure, the heteroatoms, such as nitrogen, can have hydrogen substituents and/or any permissible substituents of organic compounds described herein which satisfy the valences of the heteroatoms. This disclosure is not intended to be limited in any manner by the permissible substituents of organic compounds. Also, the terms “substitution” or “substituted with” include the implicit proviso that such substitution is in accordance with permitted valence of the substituted atom and the substituent, and that the substitution results in a stable compound, e.g., a compound that does not spontaneously undergo transformation such as by rearrangement, cyclization, elimination, etc.

“Z¹,” “Z²,” “Z³,” and “Z⁴” are used herein as generic symbols to represent various specific substituents. These symbols can be any substituent, not limited to those disclosed herein, and when they are defined to be certain substituents in one instance, they can, in another instance, be defined as some other substituents.

The term “aliphatic” as used herein refers to a non-aromatic hydrocarbon group and includes branched and unbranched, alkyl, alkenyl, or alkynyl groups.

The term “alkyl” as used herein is a branched or unbranched saturated hydrocarbon group of 1 to 24 carbon atoms, such as methyl, ethyl, n-propyl, isopropyl, n-butyl, isobutyl, t-butyl, pentyl, hexyl, heptyl, octyl, nonyl, decyl, dodecyl, tetradecyl, hexadecyl, eicosyl, tetracosyl, and the like. The alkyl group can also be substituted or unsubstituted. The alkyl group can be substituted with one or more groups including, but not limited to, alkyl, halogenated alkyl, alkoxy, alkenyl, alkynyl, aryl, heteroaryl, aldehyde, amino, carboxylic acid, ester, ether, halide, hydroxy, ketone, nitro, silyl, sulfo-oxo, sulfonyl, sulfone, sulfoxide, or thiol, as described below.

Throughout the specification “alkyl” is generally used to refer to both unsubstituted alkyl groups and substituted alkyl groups; however, substituted alkyl groups are also specifically referred to herein by identifying the specific substituent(s) on the alkyl group. For example, the term “halogenated alkyl” specifically refers to an alkyl group that is substituted with one or more halides, e.g., fluorine, chlorine, bromine, or iodine. The term “alkoxyalkyl” specifically refers to an alkyl group that is substituted with one or more alkoxy groups, as described below. The term “alkylamino” specifically refers to an alkyl group that is substituted with one or more amino groups, as described below, and the like. When “alkyl” is used in one instance and a specific term such as “alkylalcohol” is used in another, it is not meant to imply that the term “alkyl” does not also refer to specific terms such as “alkylalcohol” and the like.

This practice is also used for other groups described herein. That is, while a term such as “cycloalkyl” refers to both unsubstituted and substituted cycloalkyl moieties, the substituted moieties can, in addition, be specifically identified herein; for example, a particular substituted cycloalkyl can be referred to as, e.g., an “alkylcycloalkyl.” Similarly, a substituted alkoxy can be specifically referred to as, e.g., a “halogenated alkoxy,” a particular substituted alkenyl can be, e.g., an “alkenylalcohol,” and the like. Again, the practice of using a general term, such as “cycloalkyl,” and a specific term, such as “alkylcycloalkyl,” is not meant to imply that the general term does not also include the specific term.

The term “alkoxy” as used herein is an alkyl group bound through a single, terminal ether linkage; that is, an “alkoxy” group can be defined as —OZ¹ where Z¹ is alkyl as defined above.

The term “alkenyl” as used herein is a hydrocarbon group of from 2 to 24 carbon atoms with a structural formula containing at least one carbon-carbon double bond. Asymmetric structures such as (Z¹Z²)C═C(Z³Z⁴) are intended to include both the E and Z isomers. This can be presumed in structural formulae herein wherein an asymmetric alkene is present, or it can be explicitly indicated by the bond symbol C═C. The alkenyl group can be substituted with one or more groups including, but not limited to, alkyl, halogenated alkyl, alkoxy, alkenyl, alkynyl, aryl, heteroaryl, aldehyde, amino, carboxylic acid, ester, ether, halide, hydroxy, ketone, nitro, silyl, sulfo-oxo, sulfonyl, sulfone, sulfoxide, or thiol, as described below.

The term “alkynyl” as used herein is a hydrocarbon group of 2 to 24 carbon atoms with a structural formula containing at least one carbon-carbon triple bond. The alkynyl group can be substituted with one or more groups including, but not limited to, alkyl, halogenated alkyl, alkoxy, alkenyl, alkynyl, aryl, heteroaryl, aldehyde, amino, carboxylic acid, ester, ether, halide, hydroxy, ketone, nitro, silyl, sulfo-oxo, sulfonyl, sulfone, sulfoxide, or thiol, as described below.

The term “aryl” as used herein is a group that contains any carbon-based aromatic group including, but not limited to, benzene, naphthalene, phenyl, biphenyl, phenoxybenzene, and the like. The term “heteroaryl” is defined as a group that contains an aromatic group that has at least one heteroatom incorporated within the ring of the aromatic group. Examples of heteroatoms include, but are not limited to, nitrogen, oxygen, sulfur, and phosphorus. The term “non-heteroaryl,” which is included in the term “aryl,” defines a group that contains an aromatic group that does not contain a heteroatom. The aryl or heteroaryl group can be substituted or unsubstituted. The aryl or heteroaryl group can be substituted with one or more groups including, but not limited to, alkyl, halogenated alkyl, alkoxy, alkenyl, alkynyl, aryl, heteroaryl, aldehyde, amino, carboxylic acid, ester, ether, halide, hydroxy, ketone, nitro, silyl, sulfo-oxo, sulfonyl, sulfone, sulfoxide, or thiol as described herein. The term “biaryl” is a specific type of aryl group and is included in the definition of aryl. Biaryl refers to two aryl groups that are bound together via a fused ring structure, as in naphthalene, or are attached via one or more carbon-carbon bonds, as in biphenyl.

The term “cycloalkyl” as used herein is a non-aromatic carbon-based ring composed of at least three carbon atoms. Examples of cycloalkyl groups include, but are not limited to, cyclopropyl, cyclobutyl, cyclopentyl, cyclohexyl, etc. The term “heterocycloalkyl” is a cycloalkyl group as defined above where at least one of the carbon atoms of the ring is substituted with a heteroatom such as, but not limited to, nitrogen, oxygen, sulfur, or phosphorus. The cycloalkyl group and heterocycloalkyl group can be substituted or unsubstituted. The cycloalkyl group and heterocycloalkyl group can be substituted with one or more groups including, but not limited to, alkyl, alkoxy, alkenyl, alkynyl, aryl, heteroaryl, aldehyde, amino, carboxylic acid, ester, ether, halide, hydroxy, ketone, nitro, silyl, sulfo-oxo, sulfonyl, sulfone, sulfoxide, or thiol as described herein.

The term “cycloalkenyl” as used herein is a non-aromatic carbon-based ring composed of at least three carbon atoms and containing at least one double bound, i.e., C═C. Examples of cycloalkenyl groups include, but are not limited to, cyclopropenyl, cyclobutenyl, cyclopentenyl, cyclopentadienyl, cyclohexenyl, cyclohexadienyl, and the like. The term “heterocycloalkenyl” is a type of cycloalkenyl group as defined above and is included within the meaning of the term “cycloalkenyl,” where at least one of the carbon atoms of the ring is substituted with a heteroatom such as, but not limited to, nitrogen, oxygen, sulfur, or phosphorus. The cycloalkenyl group and heterocycloalkenyl group can be substituted or unsubstituted. The cycloalkenyl group and heterocycloalkenyl group can be substituted with one or more groups including, but not limited to, alkyl, alkoxy, alkenyl, alkynyl, aryl, heteroaryl, aldehyde, amino, carboxylic acid, ester, ether, halide, hydroxy, ketone, nitro, silyl, sulfo-oxo, sulfonyl, sulfone, sulfoxide, or thiol as described herein.

The term “cyclic group” is used herein to refer to either aryl groups, non-aryl groups (i.e., cycloalkyl, heterocycloalkyl, cycloalkenyl, and heterocycloalkenyl groups), or both. Cyclic groups have one or more ring systems that can be substituted or unsubstituted. A cyclic group can contain one or more aryl groups, one or more non-aryl groups, or one or more aryl groups and one or more non-aryl groups.

The term “aldehyde” as used herein is represented by the formula —C(O)H. Throughout this specification “C(O)” or “CO” is a shorthand notation for C═O, which is also referred to herein as a “carbonyl.”

The terms “amine” or “amino” as used herein are represented by the formula —NZ¹Z², where Z¹ and Z² can each be substitution group as described herein, such as hydrogen, an alkyl, halogenated alkyl, alkenyl, alkynyl, aryl, heteroaryl, cycloalkyl, cycloalkenyl, heterocycloalkyl, or heterocycloalkenyl group described above. “Amido” is —C(O)NZ¹Z².

The term “carboxylic acid” as used herein is represented by the formula —C(O)OH. A “carboxylate” or “carboxyl” group as used herein is represented by the formula —C(O)O—.

The term “carbamide” means compounds having the group —N(Z¹)—(CO)N(Z¹)₂ where each Z¹ can be, independently, an alkyl, alkenyl, alkynyl, aryl, arylalkyl, cycloalkyl, carbonyl, ether, haloalkyl, heteroaryl and heterocyclyl.

The term “carbamate” means a group of the form —Z¹OC(O)N(Z¹)—, —Z¹OC(O)N(Z¹)Z¹—, or —OC(O)N(Z¹)₂, where each Z¹ can be, independently, an alkoxy, aryloxy, alkyl, alkenyl, alkynyl, aryl, arylalkyl, cycloalkyl, ether, formyl, haloalkyl, heteroaryl, and heterocyclyl. Carbamates include, e.g., arylcarbamates and heteroaryl carbamates.

The term “ester” as used herein is represented by the formula —OC(O)Z¹ or —C(O)OZ¹, where Z¹ can be an alkyl, halogenated alkyl, alkenyl, alkynyl, aryl, heteroaryl, cycloalkyl, cycloalkenyl, heterocycloalkyl, or heterocycloalkenyl group described above.

The term “ether” as used herein is represented by the formula Z¹OZ², where Z¹ and Z² can be, independently, an alkyl, halogenated alkyl, alkenyl, alkynyl, aryl, heteroaryl, cycloalkyl, cycloalkenyl, heterocycloalkyl, or heterocycloalkenyl group described above.

The term “formamide” refers to compounds comprising the —NC(O)H formamide group. Formamides include compounds having the formula HC(O)NZ¹Z² wherein Z¹ and Z² can be, independently, hydrogen or an alkyl, alkenyl, alkynyl, aryl, arylalkyl, cycloalkyl, carbonyl, ether, haloalkyl, heteroaryl and heterocyclyl.

The term “ketone” as used herein is represented by the formula Z¹C(O)Z², where Z¹ and Z² can be, independently, an alkyl, halogenated alkyl, alkenyl, alkynyl, aryl, heteroaryl, cycloalkyl, cycloalkenyl, heterocycloalkyl, or heterocycloalkenyl group described above.

The term “halide” or “halogen” as used herein refers to the fluorine, chlorine, bromine, and iodine.

The term “hydroxyl” as used herein is represented by the formula —OH.

The term “nitro” as used herein is represented by the formula —NO₂.

The term “silyl” as used herein is represented by the formula —SiZ¹Z²Z³, where Z¹, Z², and Z³ can be, independently, hydrogen, alkyl, halogenated alkyl, alkoxy, alkenyl, alkynyl, aryl, heteroaryl, cycloalkyl, cycloalkenyl, heterocycloalkyl, or heterocycloalkenyl group described above.

The term “sulfonyl” is used herein to refer to the sulfo-oxo group represented by the formula —S(O)₂Z¹, where Z¹ can be hydrogen, an alkyl, halogenated alkyl, alkenyl, alkynyl, aryl, heteroaryl, cycloalkyl, cycloalkenyl, heterocycloalkyl, or heterocycloalkenyl group described above.

The term “sulfonylamino” or “sulfonamide” as used herein is represented by the formula —S(O)₂NH—.

The term “thiol” as used herein is represented by the formula —SH.

The term “thio” as used herein is represented by the formula —S—.

Unless stated to the contrary, a formula with chemical bonds shown only as solid lines and not as wedges or dashed lines contemplates each possible isomer, e.g., each enantiomer, diastereomer, and meso compound, and a mixture of isomers, such as a racemic or scalemic mixture.

Reference will now be made in detail to specific aspects of the disclosed materials, compounds, compositions, articles, and methods, examples of which are illustrated in the accompanying Examples and Figures.

### Poly(Pyridyl)Borate Ligands

Disclosed herein are compounds, compositions, methods for making and using such compounds and compositions.

In some examples, the poly(pyridyl)borate ligand is defined by Formula I:

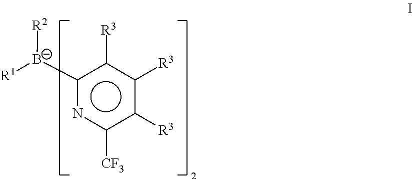

wherein
R¹ and R² are independently selected from hydrogen, a substituted or unsubstituted C₁-C₄ alkyl, a substituted or unsubstituted C₁-C₆ aryl or heteroaryl, or a halogen; and each R³ is independently, hydrogen, a halogen, a substituted or unsubstituted C₁-C₄ alkyl, or a substituted or unsubstituted C₁-C₄ alkoxy.

In some examples of Formula I, R¹ is:

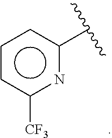

In some examples of Formula I, R¹ is an unsubstituted C₁-C₄ alkyl. In some examples of Formula I, R¹ is —CH₃. In some examples of Formula I, R¹ is H.

In some examples of Formula I, R² is selected from hydrogen, a substituted or unsubstituted alkyl, a substituted or unsubstituted aryl, or a halogen. In some examples of Formula I, R² is a substituted or unsubstituted aryl group. In some examples of Formula I, R² is 4-tert-butylphenyl. In some examples of Formula I, R² is phenyl. In some examples of Formula I, R² is —CH₃.

In some examples of Formula I, each R³ is independently hydrogen, OH, a halogen, a substituted or unsubstituted C₁-C₄ alkyl, or a substituted or unsubstituted C₁-C₄ alkoxy. In some examples of Formula I, R³ is hydrogen. In some examples of Formula I, R³ is OH. In some examples of Formula I, R³ is a halogen. In some examples of Formula I, R³ is a substituted or unsubstituted C₁-C₄ alkyl. In some examples of Formula I, R³ is a substituted or unsubstituted C₁-C₄ alkoxy. In some examples of Formula I, each R³ is the same. In some examples of Formula I, at least one R³ is different.

In some examples, the poly(pyridyl)borate ligand is defined by Formula II:

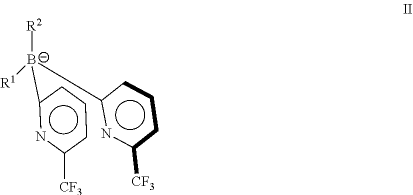

wherein
R¹ and R² are independently selected from hydrogen, a substituted or unsubstituted C₁-C₄ alkyl, a substituted or unsubstituted C₆-C₁₀ aryl or C₄-C₁₀ heteroaryl, or a halogen.

In some examples of Formula II, R¹ is:

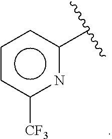

In some examples of Formula II, R¹ is an unsubstituted C₁-C₄ alkyl. In some examples of Formula II, R¹ is —CH₃. In some examples of Formula II, R¹ is H.

In some examples of Formula II, R² is selected from hydrogen, a substituted or unsubstituted alkyl, a substituted or unsubstituted aryl, or a halogen. In some examples of Formula II, R² is a substituted or unsubstituted aryl group. In some examples of Formula II, R² is 4-tert-butylphenyl. In some examples of Formula II, R² is phenyl. In some examples of Formula II, R² is —CH₃.

In some examples, the poly(pyridyl)borate ligand is further defined by Formula III:

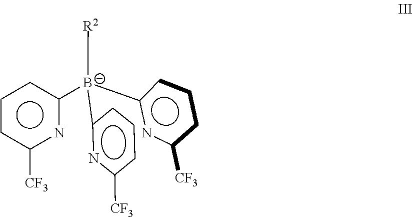

wherein
R² is selected from hydrogen, a substituted or unsubstituted C₁-C₄ alkyl, a substituted or unsubstituted C₆-C₁₀ aryl or C₄-C₁₀ heteroaryl, or a halogen.

In some examples of Formula III, R² is selected from hydrogen, a substituted or unsubstituted alkyl, a substituted or unsubstituted aryl, or a halogen. In some examples of Formula III, R² is a substituted or unsubstituted aryl group. In some examples of Formula III, R² is 4-tert-butylphenyl. In some examples of Formula III, R² is phenyl. In some examples of Formula III, R² is —CH₃.

### Metal Complexes

The present disclosure additionally relates to metal complexes comprising the poly(pyridyl)borate ligand described herein. In some examples, the metal complex is defined by Formula IV:

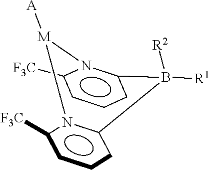

wherein
R¹ and R² are independently selected from hydrogen, a substituted or unsubstituted C₁-C₄ alkyl, a substituted or unsubstituted C₆-C₁₀ aryl or C₄-C₁₀ heteroaryl, or a halogen;
M is a transition metal; and
A is selected from an olefin, isocyanide, or CO.

In some examples of Formula IV, R¹ is:

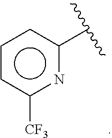

In some examples of Formula IV, R¹ is an unsubstituted C₁-C₄ alkyl. In some examples of Formula IV, R¹ is —CH₃. In some examples of Formula IV, R¹ is H.

In some examples of Formula IV, R² is selected from hydrogen, a substituted or unsubstituted alkyl, a substituted or unsubstituted aryl, or a halogen. In some examples of Formula IV, R² is a substituted or unsubstituted aryl group. In some examples of Formula IV, R² is 4-tert-butylphenyl. In some examples of Formula IV, R² is phenyl. In some examples of Formula IV, R² is —CH₃.

In some examples of Formula IV, A is a substituted or unsubstituted olefin. In some examples of Formula IV, A is an unsubstituted olefin. In some examples of Formula IV, A is ethylene.

In some examples of Formula IV, A is isocyanide or carbon monoxide. In further examples of Formula V, A is an electron donor, including but not limited to isolated phosphine complexes.

In some examples of Formula IV, M is a transition metal. In some examples of Formula IV, M is a noble metal. In some examples of Formula IV, M is selected from Au, Ag, and Cu. In some examples of Formula IV, M is Au. In some examples of Formula IV, M is Ag. In some examples of Formula IV, M is Cu.

In some examples, the metal complex is defined by Formula V:

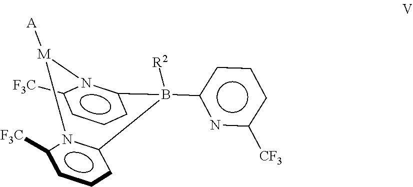

wherein
R² is selected from hydrogen, a substituted or unsubstituted C₁-C₄ alkyl, a substituted or unsubstituted C₆-C₁₀ aryl or C₄-C₁₀ heteroaryl, or a halogen;
M is a metal; and
A is selected from an olefin, isocyanide, or CO.

In some examples of Formula V, A is a substituted or unsubstituted olefin. In some examples of Formula V, A is an unsubstituted olefin. In some examples of Formula V, A is ethylene.

In some examples of Formula V, A is isocyanide or carbon monoxide. In further examples of Formula V, A is an electron donor, including but not limited to isolated phosphine complexes.

In some examples of Formula V, M is a transition metal. In some examples of Formula V, M is a noble metal. In some examples of Formula V, M is selected from Au, Ag, and Cu.

In some examples of Formula V, M is Au. In some examples of Formula V, M is Ag. In some examples of Formula V, M is Cu.

In some examples of Formulas I, II, III, IV, or V, R¹ and/or R² are substituted or unsubstituted C₁-C₁₀ alkyl. In further examples of Formulas I, II, III, IV, or V, R¹ and/or R² are substituted or unsubstituted C₁-C₆ alkyl. In certain examples of Formulas I, II, III, IV, or V, R¹ and/or R² are substituted or unsubstituted C₆-C₁₀ alkyl.

### Methods and Compositions

Also disclosed herein are methods of preparing a poly(pyridyl)borate ligand comprising: contacting a boron precursor comprising a trifluoroborate with a pyridine reagent to form the poly(pyridyl)borate ligand. The boron precursor comprising the trifluoroborate can include, for example, a trifluoroborate salt. In some examples, the trifluoroborate salt comprises methyl trifluoroborate.

The term pyridine reagent includes substituted and unsubstituted pyridine compounds which can react with the boron precursor to form a poly(pyridyl)borate ligand. In some examples, the pyridine reagent comprises a substituted or unsubstituted pyridyl magnesium chloride. In some examples, the pyridine reagent comprises a substituted or unsubstituted pyridyl magnesium bromide. In some examples, the pyridine reagent is substituted (e.g., substituted with a trifluoromethyl). In some examples, the pyridine reagent is unsubstituted.

### EXAMPLES

To further illustrate the principles of the present disclosure, the following examples are put forth so as to provide those of ordinary skill in the art with a complete disclosure and description of how the compositions, articles, and methods claimed herein are made and evaluated. They are intended to be purely exemplary of the invention and are not intended to limit the scope of what the inventors regard as their disclosure. Efforts have been made to ensure accuracy with respect to numbers (e.g., amounts, temperatures, etc.); however, some errors and deviations should be accounted for. Unless indicated otherwise, temperature is ° C. or is at ambient temperature, and pressure is at or near atmospheric. There are numerous variations and combinations of process conditions that can be used to optimize product quality and performance. Only reasonable and routine experimentation will be required to optimize such process conditions.

### Example 1: Fluorinated Tris(Pyridyl)Borate Ligand Support on Coinage Metals

Poly(pyrazolyl)borates (which belong to a family known as scorpionates) (S. Trofimenko, Chem. Rev., 1993, 93, 943-980; (b) C. Pettinari and C. Santini, Compr. Coord. Chem. II, 2004, 1, 159-210) are very popular supporting ligands in metal coordination chemistry. The fluorinated versions of these pyrazole based donors (H. V. R. Dias, W. Jin, H.-J. Kim and H.-L. Lu, Inorg. Chem., 1996, 35, 2317-2328; H. V. R. Dias and H.-J. Kim, Organometallics, 1996, 15, 5374-5379; H. V. R. Dias and C. J. Lovely, Chem. Rev., 2008, 108, 3223-3238; A. Noonikara-Poyil, A. Munoz-Castro, A. Boretskyi, P. K. Mykhailiuk and H. V. R. Dias, Chem. Sci., 2021, 12, 14618-14623) such as [HB(3,5-(CF₃)₂Pz)₃]⁻ (where Pz=pyrazolyl) are particularly interesting and have enabled the isolation and detailed studies of rare molecules such as gold(I)-carbonyl, silver(I)-acetylene, gold(I)-ethylene complexes. (H. V. R. Dias and W. Jin, Inorg. Chem., 1996, 35, 3687-3694; H. V. R. Dias, Z. Wang and W. Jin, Inorg. Chem., 1997, 36, 6205-6215; H. V. R. Dias and J. Wu, Angew. Chem., Int. Ed., 2007, 46, 7814-7816.) They are also uniquely desirable for many other important applications ranging from catalysis to the isolation of reaction intermediates. For example, [HB(3,5-(CF₃)₂Pz)₃]Cu, due to its high affinity for ethylene and the stability of the ethylene-bound product, has been useful in the development of an ethylene sensor. (H. V. R. Dias, H.-L. Lu, H.-J. Kim, S. A. Polach, T. K. H. H. Goh, R. G. Browning and C. J. Lovely, Organometallics, 2002, 21, 1466-1473; B. Esser, J. M. Schnorr and T. M. Swager, Angew. Chem., Int. Ed., 2012, 51, 5752-5756.) The bis(pyrazolyl)borate [H₂B(3,5-(CF₃)₂Pz)₂]Cu, however, forms a labile ethylene complex and is an excellent material for the separation of ethylene from an ethylene/ethane mixture. (A. Noonikara-Poyil, H. Cui, A. A. Yakovenko, P. W. Stephens, R.-B. Lin, B. Wang, B. Chen and H. V. R. Dias, Angew. Chem., Int. Ed., 2021, DOI: 10.1002/anie.202109338, Ahead of Print.) The silver complexes such as [HB(3,5-(CF₃)₂Pz)₃]Ag have enabled the functionalization of inert C—Cl and C—H bonds of halocarbons and hydrocarbons via catalytic carbene insertion chemistry. (H. V. R. Dias and C. J. Lovely, Chem. Rev., 2008, 108, 3223-3238; H. V. R. Dias, R. G. Browning, S. A. Polach, H. V. K. Diyabalanage and C. J. Lovely, J. Am. Chem. Soc., 2003, 125, 9270-9271; H. V. R. Dias, R. G. Browning, S. A. Richey and C. J. Lovely, Organometallics, 2004, 23, 1200-1202; J. M. Munoz-Molina, T. R. Belderrain and P. J. Perez, Coord. Chem. Rev., 2019, 390, 171-189.) Copper complexes supported by fluorinated tris(pyrazolyl)borates have been utilized in the functionalization of CH₄ and to generate peroxy-copper complexes, without the ligand itself getting destroyed. (R. Gava, A. Olmos, B. Noverges, T. Varea, E. Alvarez, T. R. Belderrain, A. Caballero, G. Asensio and P. J. Pdrez, ACS Catal., 2015, 5, 3726-3730; (b) Z. Hu, R. D. Williams, D. Tran, T. G. Spiro and S. M. Gorun, J. Am. Chem. Soc., 2000, 122, 3556-3557.) Isolable metal organo-azide and diazo complexes supported by fluorinated tris(pyrazolyl)borates are also known. (H. V. R. Dias and S. A. Polach, Inorg. Chem., 2000, 39, 4676-4677; H. V. R. Dias, S. A. Polach, S.-K. Goh, E. F. Archibong and D. S. Marynick, Inorg. Chem., 2000, 39, 3894-3901).

Tris(pyridyl)borates are better s-donating ligands than tris(pyrazolyl)borate ligands. (G. M. Pawar, J. B. Sheridan and F. Jäkle, Eur. J. Inorg. Chem., 2016, 2227-2235.) They also present a different steric profile to the coordinated metal site (due to the involvement of six-membered pyridyl donor arms instead of the five-membered pyrazolyl moieties) and have somewhat more robust ligand backbone (attributable to less polar B—C linkages vs. B—N). In view of the popularity of tris(pyrazolyl)borates, the pyridyl versions are also bound to find growing utility in coordination chemistry. T. G. Hodgkins and D. R. Powell, Inorg. Chem., 1996, 35, 2140-2148; C. Cui, R. A. Lalancette and F. Jäkle, Chem. Commun., 2012, 48, 6930-6932; G. M. Pawar, J. B. Sheridan and F. Jäkle, Eur. J. Inorg. Chem., 2016, 2227-2235; (a) E. Khaskin, P. Y. Zavalij and A. N. Vedernikov, J. Am. Chem. Soc., 2006, 128, 13054-13055; (b) E. Khaskin, P. Y. Zavalij and A. N. Vedernikov, Angew. Chem., Int. Ed., 2007, 46, 6309-6312; (c) C. Cui, P. R. Shipman, R. A. Lalancette and F. Jäkle, Inorg. Chem., 2013, 52, 9440-9448; (d) S. Bhunya, L. Roy and A. Paul, ACS Catal., 2016, 6, 4068-4080; (e) S. Y. Jeong, R. A. Lalancette, H. Lin, P. Lupinska, P. O. Shipman, A. John, J. B. Sheridan and F. Jäkle, Inorg. Chem., 2016, 55, 3605-3615; (f) J. Qian and R. J. Comito, Organometallics, 2021, 40, 1817-1821.)

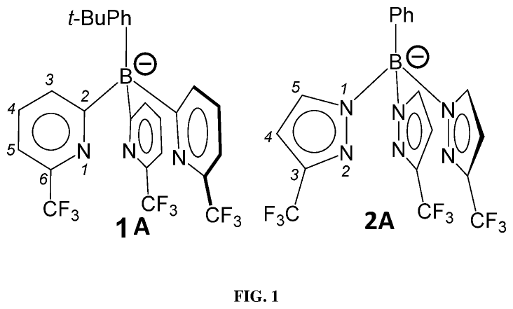

Considering the use of fluorinated ligands in many fields (some noted above), the present experiments aimed to develop the fluorinated versions of poly(2-pyridyl)borates. Described herein is an exemplary synthesis and isolation of the first fluorinated tris(2-pyridyl)borate, [t-BuPhB(6-(CF₃)Py)₃]⁻ (1A, FIG. 1), and its coinage metal ethylene chemistry. No previous reports are known of bis- or tris(2-pyridyl)borato metal complexes bearing substituents at the pyridyl ring 6-position as in 1A (see FIG. 1 for atom numbering scheme), which, without wishing to be bound by theory, provide the greatest protection to a metal site.

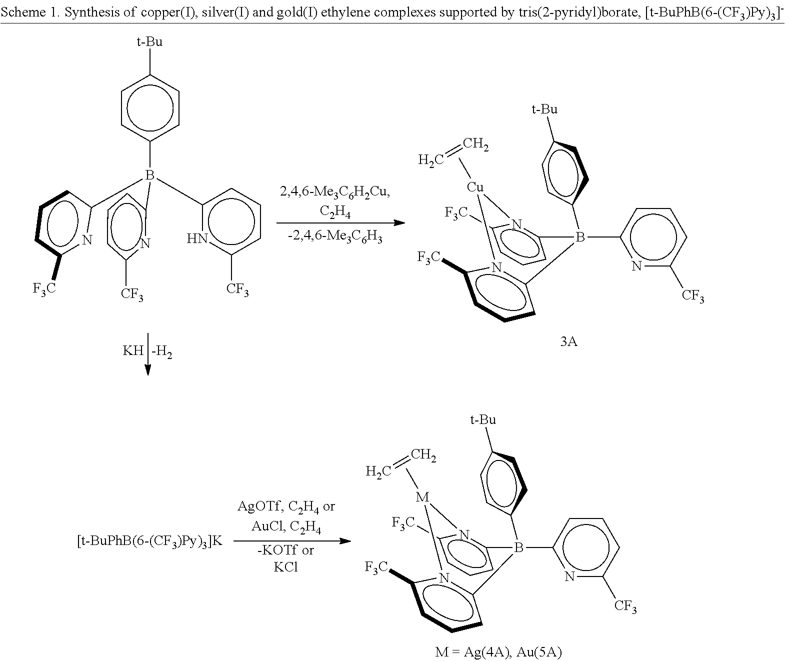

The [t-BuPhB(6-(CF₃)Py)₃]⁻ ligand was synthesized using 2-bromo-6-(trifluoromethyl)pyridine and i-PrMgCl precursors followed by the treatment of resulting pyridyl Grignard reagent with t-BuPhBBr₂. It was isolated as a colorless solid in the mono-protonated form, [t-BuPhB(6-(CF₃)Py)₃]H. The compound [t-BuPhB(6-(CF₃)Py)₃]H was characterized by several methods including X-ray crystallography. The fluorinated ligand was initially explored for its use in coinage metal-ethylene chemistry not only because isolable ethylene complexes of coinage metals are of significant interest and fundamental value due to their importance in key industrial processes (e.g., epoxidation and oxychlorination of ethylene), olefin separation to biochemistry (e.g., ethylene effect in plants), (H. V. R. Dias and C. J. Lovely, Chem. Rev., 2008, 108, 3223-3238; H. V. R. Dias and J. Wu, Eur. J. Inorg. Chem., 2008, 509-522) but also a few analogs supported by fluorinated tris(pyrazolyl)borates, (H. V. R. Dias, Z. Wang and W. Jin, Inorg. Chem., 1997, 36, 6205-6215; H. V. R. Dias and J. Wu, Angew. Chem., Int. Ed., 2007, 46, 7814-7816; H. V. R. Dias, H.-L. Lu, H.-J. Kim, S. A. Polach, T. K. H. H. Goh, R. G. Browning and C. J. Lovely, Organometallics, 2002, 21, 1466-1473; H. V. R. Dias and J. Wu, Organometallics, 2012, 31, 1511-1517) including the species [PhB(3-(CF₃)Pz)₃]Ag(C₂H₄), are available for comparisons of spectroscopic features of the ethylene moiety and metrical parameters from the crystal structures. (H. V. R. Dias, J. Wu, X. Wang and K. Rangan, Inorg. Chem., 2007, 46, 1960-1962).

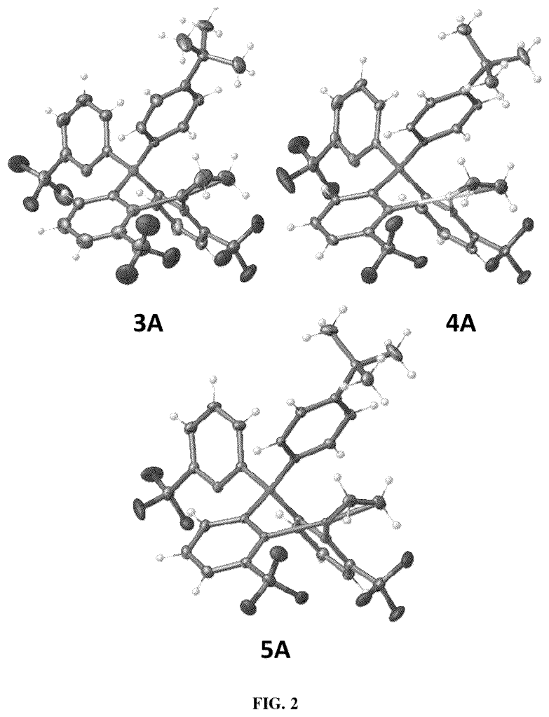

Treatment of [t-BuPhB(6-(CF₃)Py)₃]H with mesityl copper in the presence of ethylene yielded [t-BuPhB(6-(CF₃)Py)₃]Cu(C₂H₄) (3) in excellent yield (Scheme 1). The heavier analogs of the group 11, [t-BuPhB(6-(CF₃)Py)₃]M(C₂H₄) (M=Ag (4A), Au (5A)) were synthesized using [t-BuPhB(6-(CF₃)Py)₃]K (generated in-situ using [t-BuPhB(6-(CF₃)Py)₃]H and KH) and AgOTf or AuCl under an ethylene atmosphere. The [t-BuPhB(6-(CF₃)Py)₃]M(C₂H₄) complexes are colorless, crystalline solids and do not lose ethylene under reduced pressure. They all afforded crystalline material suitable for X-ray crystallographic analysis. X-ray structures of [t-BuPhB(6-(CF₃)Py)₃]M(C₂H₄) are illustrated in FIG. 2. Selected bond distances and angles are listed in Table 1. The metal centers have a trigonal planar geometry while tris(2-pyridyl)borate ligand coordinates to metal atom in k²-fashion using only two of the three pyridyl donor arms. The six-membered MN₂C₂B core adopts a boat conformation. Although there are no structural data on coinage metal complexes of tris(2-pyridyl)borates in the literature, the Fe, Ru, and Mn complexes are known and they all adopt κ³-mode of coordination, typical for a tripodal ligand. (C. Cui, R. A. Lalancette and F. Jäkle, Chem. Commun., 2012, 48, 6930-6932; C. Cui, P. R. Shipman, R. A. Lalancette and F. Jäkle, Inorg. Chem., 2013, 52, 9440-9448; S. Y. Jeong, R. A. Lalancette, H. Lin, P. Lupinska, P. O. Shipman, A. John, J. B. Sheridan and F. Jäkle, Inorg. Chem., 2016, 55, 3605-3615). In addition, copper complexes of a bidentate, bis(2-pyridyl)borate ligand [Me₂B(Py)₂]⁻ has been reported and they display the k²-mode of coordination. (V. A. Krylova, P. I. Djurovich, B. L. Conley, R. Haiges, M. T. Whited, T. J. Williams and M. E. Thompson, Chem. Commun., 2014, 50, 7176-7179). The Cu—N bond distances of 3A (Table 1) are at the upper end of the corresponding distances observed in these copper adducts (which range from 1.988 to 2.037 Å). The ethylene in 3A-5A coordinates to the metal ion in a typical η²-fashion. The C═C bond of the coordinated ethylene in gold complex 5A has the longest C═C distance which is significancy longer than that of the free ethylene (1.3305(10) Å) indicating substantial Au-ethylene s/p-interaction. The M-N and M-C bond distances follow the trend Cu<Au<Ag based on covalent radii of group 11 metals. (B. Cordero, V. Gómez, A. E. Platero-Prats, M. Revés, J. Echeverria, E. Cremades, F. Barragán and S. Alvarez, Dalton Trans., 2008, 2832-2838; M. A. Omary, M. A. Rawashdeh-Omary, M. W. A. Gonser, O. Elbjeirami, T. Grimes, T. R. Cundari, H. V. K. Diyabalanage, C. S. P. Gamage and H. V. R. Dias, Inorg. Chem., 2005, 44, 8200-8210).

Structural and spectroscopic data of [PhB(3-(CF₃)Pz)₃]Ag(C₂H₄), (H. V. R. Dias, J. Wu, X. Wang and K. Rangan, Inorg. Chem., 2007, 46, 1960-1962) and few other coinage metal ethylene complexes of tris(pyrazolyl)borates (H. V. R. Dias and C. J. Lovely, Chem. Rev., 2008, 108, 3223-3238) are available for comparisons. The [PhB(3-(CF₃)Pz)₃]Ag(C₂H₄) (containing ligand 2, FIG. 1) also uses only two of the three nitrogen-donor arms of the scorpionate to coordination to silver. However, when B—H and B-Me groups are present in the backbone instead of B-Ph, tris(pyrazolyl)boratosilver-ethylene complexes usually adopt tetrahedral geometry at silver. (H. V. R. Dias and C. J. Lovely, Chem. Rev., 2008, 108, 3223-3238; H. V. R. Dias and J. Wu, Organometallics, 2012, 31, 1511-1517). The tetrahedral copper sites are the norm in copper-ethylene complexes supported by tris(pyrazolyl)borates except in chloride bridged [(C₂H₄)Cu(Pz)₂BH(Pz)CuCl]₂ and somewhat bulkier [PhB(3-(C₂F₅)Pz)₃]Cu(C₂H₄) while the reported gold-ethylene complexes of tris(pyrazolyl)borates prefer trigonal planar coordination, even when a H-atom is present on boron. (H. V. R. Dias and J. Wu, Angew. Chem., Int. Ed., 2007, 46, 7814-7816; H. V. R. Dias and J. Wu, Organometallics, 2012, 31, 1511-1517; J. S. Thompson, R. L. Harlow and J. F. Whitney, J. Am. Chem. Soc., 1983, 105, 3522-3527; J. Wu, A. Noonikara-Poyil, A. Munoz-Castro and H. V. R. Dias, Chem. Commun., 2021, 57, 978-981.)

TABLE 1
Selected bond distances (Å), angles (°), and NMR spectroscopic
data (ppm) of TpybM(C₂H₄) (Tpyb^{CF3} = [t-BuPhB(6-(CF₃)Py)₃];
M = Cu, Ag, Au). The M•••C(B) ipso-carbon separation between the M and
flanking C₆H₄BU^{t} group and M••B separation in italics. Σ
at M represents the sum of angles at M involving two nitrogen atoms
bonded to M and the centroid of the C═C

| Molecule | Tpyb^{CF3}Cu(C₂H₄) | Tpyb^{CF3}Ag(C₂H₄) | Tpyb^{CF3}Au(C₂H₄) |
|---|---|---|---|
| C═C | 1.346(6) | 1.338(4) | 1.399(4) |
| M—C | 2.046(3), 2.036(3) | 2.294(2), 2.292(2) | 2.108(2), 2.104(2) |
| M—N | 2.032(2), 2.037(2) | 2.2930(18), 2.3184(17) | 2.2280(19), 2.2185(19) |
| M••C(B) | 2.601(3) | 2.5740(18) | 2.760(2) |
| M••B | 2.866(3) | 3.047(2) | 3.092(2) |
| C—M—C | 38.49(17) | 33.93(10) | 38.80(11) |
| N—M—N | 92.33(9) | 85.91(6) | 83.07(7) |
| Σ at M | 359.9 | 359.1 | 360.0 |
| ¹H H₂C═ | 3.57 | 4.66 | 2.66 |
| ¹³C H₂C═ | 85.13 | 103.15 | 58.67 |

The bond distance and angles are largely similar between the two analogues [t-BuPhB(6-(CF₃)Py)₃]Ag(C₂H₄) and [PhB(3-(CF₃)Pz)₃]Ag(C₂H₄), but the former shows marginally longer Ag—C(ethylene) and Ag—N distances, perhaps as a result of having relatively closer M•••C(B) ipso-carbon separation to the flanking aryl group (this distance of 2.5740(18) Å however is, much longer than the Ag—C covalent contact separation of 2.18 Å). (B. Cordero, V. Gómez, A. E. Platero-Prats, M. Revés, J. Echeverría, E. Cremades, F. Barragán and S. Alvarez, Dalton Trans., 2008, 2832-2838).

The ethylene C═C distance change in Ag(I) complexes of the two ligand systems is not particularly useful for comparisons. It is usually small and often overshadowed by the high esd values, libration effects, and the anisotropy of the electron density. (H. V. R. Dias and J. Wu, Eur. J. Inorg. Chem., 2008, 509-522; A. Reisinger, N. Trapp, C. Knapp, D. Himmel, F. Breher, H. RUegger and I. Krossing, Chem. Eur. J., 2009, 15, 9505-9520).

The metal bound ethylene resonance of 3A-5A in ¹H NMR at room temperature appears at d 3.57, 4.66 and 2.66 ppm, respectively (Table 1). They are all shifted significantly upfield from that of the free ethylene signal (d 5.40 ppm) but likely affected by the ring current of the flanking aryl group, as in related [PhB(3-(CF₃)Pz)₃]Ag(C₂H₄) (d 4.74 ppm). The ethylene ¹³C resonance, which is less effected by such shielding effects, is a better gauge for comparing the ligand effects. It is observed at d 85.13, 103.15 and 58.67 ppm for 3A-5A, respectively (cf. with free ethylene at d 123.0 ppm). The gold complex shows a substantial ¹³C coordination shift relative to the lighter members indicating significant p-backbonding interaction between Au and the ethylene group, which is in agreement with the findings from the tris(pyrazolyl)borate analogs. (J. Wu, A. Noonikara-Poyil, A. Munoz-Castro and H. V. R. Dias, Chem. Commun., 2021, 57, 978-981). A comparison of d 103.15 ppm value of 4A to the corresponding ethylene carbon shift in the related tris(pyrazolyl)borates [PhB(3-(CF₃)Pz)₃]Ag(C₂H₄) (d 101.7 ppm) does not point to a large difference in ligand effects on silver by the two scorpionate families. Complexes supported by the somewhat bulker tris(pyrazolyl)borate [PhB(3-(C₂F₃)Pz)₃]⁻ also exhibit comparable NMR shifts to those of the corresponding 3A-5A indicating, room temperature ethylene carbon shifts are not sensitive enough to detect differences in donor features, if any, between the two ligand classes.

One difference, however, is the behavior of the copper-ethylene complexes supported by the two types of ligands in solution as evident from the room temperature ¹H and ¹⁹F NMR spectra. The pyrazolyl moieties of the k²-bound, B-phenylated, tris(pyrazolyl)borato Cu, Ag and Au ethylene complexes show an averaged set of signals in solution at room temperature for the coordinated and free N-donor arms. The [t-BuPhB(6-(CF₃)Py)₃]Ag(C₂H₄) behaves in a similar manner with some broadening of the pyridyl proton signals. This is perhaps due to a fast k²- to k³-interconversion on the NMR time scale. The [t-BuPhB(6-(CF₃)Py)₃]Au(C₂H₄) also shows broadening of some pyridyl proton resonances but the ¹⁹F spectrum shows partially resolved peaks for CF₃-groups of the two different pyridyl arms. The [t-BuPhB(6-(CF₃)Py)₃]Cu(C₂H₄) in contrast, displays two different sets of signals for bound and free pyridyl arms in its ¹H, ¹³C and ¹⁹F NMR spectra, at room temperature.

These ligands and ethylene complexes were also examined using Density Functional Theory (DFT). Computed proton affinity data of the ligands [PhB(6-(CF₃)Py)₃]⁻ and [PhB(3-(CF₃)Pz)₃]⁻ indicate much higher value for the tris(pyridyl)borate (1121.0 kJ·mol⁻¹) in comparison to the latter (1069.2 kJ·mol⁻¹). The t-Bu substituent on the phenyl ring has only a very minor impact on the donor features at the nitrogen sites as evident from a comparison of computed proton affinities of [PhB(6-(CF₃)Py)₃]⁻ and [t-BuPhB(6-(CF₃)Py)₃]⁻ (1121.0 and 1122.9 kJ·mol⁻¹, respectively).

A detailed investigation of the κ²-[t-BuPhB(6-(CF₃)Py)₃]M(C₂H₄) (M=Cu (3A), Ag (4A), Au (5A) complexes using Energy Decomposition Analysis together with Natural orbitals for Chemical Valence (NOCV) methods (see Table 2) show that the M-ethylene bonding is mainly of an electrostatic nature (av. 60.7 w % av.), followed by the orbital stabilization (covalency, av. 34.2%) with the rest attributable to London type interactions (av. 5.1%). In these molecules, the stabilizing M-C₂H₄ interaction follows the trend of Au (−62.7 kcal·mol⁻¹)>Cu (−44.1 kcal·mol⁻¹)>Ag (−28.7 kcal·mol⁻¹), with a greater π-backbonding component in comparison to the σ-donation (e.g., for 5A, 49.6% and 36.2% of the covalent bonding interaction involves p-backbonding and s-donor components, respectively). The replacement of t-Bu group by hydrogen on flanking phenyls leads only to a slight decrease in the M-C₂H₄ interaction (e.g., DEᵢₙₜ of [PhB(6-(CF₃)Py)₃]M(C₂H₄) are −61.0, −43.5, and −27.9 kcal·mol for M=Au, Cu and Ag, respectively), consistent with proton affinity data of the two systems, noted above. Furthermore, the DE, values of hypothetical π³-[t-BuPhB(6-(CF₃)Py)₃]M(C₂H₄) species point to a less favourable M-C₂₁H₄ interaction, and suggest the preference for observed 7c²-[t-BuPhB(6-(CF₃)Py)₃]M(C₂H₄)^{□} structures by 12.3 (Au)>9.0 (Cu)>7.6 kcal·mol⁻¹ (Ag), respectively.

Table 2. Energy Decomposition Analyses for the C₂H₄-M Interaction, for [t-BuPhB(6-(CF₃)Py)₃]⁻, [PhB(6-(CF₃)Py)₃]⁻, [PhB(6-(CF₃)Pz)₃]⁻, and [t-BuPhB(6-(CF₃)Pz)₃]⁻ Ligand Complexes, in Two Coordination Modes, Namely, κ²- and κ³-. Values in Kcal·Mol⁻¹. In Addition the Contribution from Both π₂*-Backbonding and σ-Donation is Given Accounting for π₂*-C₂H₄←M and π₁-C₂H₄→M Bonding Schemes, Respectively.

| | κ²- | | κ²- | | κ²- | | κ³- | | κ³- | | κ³- | |
|---|---|---|---|---|---|---|---|---|---|---|---|---|
| | Cu | | Ag | | Au | | Cu | | Ag | | Au | |
| [t-BuPhB(6- | | | | | | | | | | | | |
| (CF₃)Py)₃]⁻ | | | | | | | | | | | | |
| ΔE_{Pauli} | 115.7 | | 93.9 | | 211.7 | | 114.0 | | 71.2 | | 201.5 | |
| ΔE_{Elstat} | −92.1 | 57.6% | −75.7 | 61.8% | −165.8 | 60.4% | −87.8 | 58.9% | −56.5 | 61.2% | −153.7 | 61.0% |
| ΔE_{Orb} | −54.6 | 34.2% | −37.7 | 30.8% | −98.6 | 36.0% | −49.4 | 33.1% | −27.9 | 30.2% | −89.3 | 35.4% |
| ΔE_{Disp} | −13.1 | 8.2% | −9.2 | 7.5% | −9.9 | 3.6% | −11.8 | 7.9% | −7.9 | 8.6% | −9.0 | 3.6% |
| ΔEᵢₙₜ | −44.1 | | −28.7 | | −62.7 | | −35.0 | | −21.1 | | −50.4 | |
| π₂*- | −28.9 | 52.9% | −17.5 | 46.3% | −49.0 | 49.6% | −23.3 | 47.1% | −10.2 | 36.5% | −40.1 | 44.9% |
| C₂H₄← M | | | | | | | | | | | | |
| π₁- | −17.0 | 31.1% | −12.9 | 34.2% | −35.7 | 36.2% | −16.9 | 34.2% | −11.6 | 41.6% | −35.6 | 39.9% |
| C₂H₄→ M | | | | | | | | | | | | |
| [PhB(6- | | | | | | | | | | | | |
| (CF₃)Py)₃]⁻ | | | | | | | | | | | | |
| ΔE_{Pauli} | 114.5 | | 110.5 | | 207.0 | | 115.4 | | 69.2 | | 108.4 | |
| ΔE_{Elstat} | −91.6 | 58.0% | −89.0 | 64.3% | −162.7 | 60.7% | −85.3 | 58.8% | −54.1 | 60.8% | −79.0 | 58.5% |
| ΔE_{Orb} | −54.5 | 34.5% | −42.3 | 30.6% | −97.0 | 36.2% | −47.9 | 33.1% | −26.4 | 29.7% | −44.3 | 32.8% |
| ΔE_{Disp} | −11.9 | 7.5% | −7.1 | 5.1% | −8.2 | 3.1% | −11.8 | 8.2% | −8.4 | 9.4% | −11.7 | 8.6% |
| ΔEᵢₙₜ | −43.5 | | −27.9 | | −61.0 | | −29.6 | | −19.6 | | −26.6 | |
| π₂*- | −28.9 | 53.0% | −22.9 | 54.1% | −47.8 | 49.3% | −22.6 | 47.2% | −9.5 | 36.1% | −19.8 | 44.6% |
| C₂H₄← M | | | | | | | | | | | | |
| π₁- | −17.0 | 31.1% | −13.9 | 32.8% | −35.9 | 37.0% | −16.5 | 34.3% | −11.1 | 41.8% | −15.8 | 35.6% |
| C₂H₄→ M | | | | | | | | | | | | |
| [PhB(3- | | | | | | | | | | | | |
| (CF₃)Pz)₃]⁻ | | | | | | | | | | | | |
| ΔE_{Pauli} | 113.5 | | 101.3 | | 199.4 | | 110.7 | | 86.6 | | 194.3 | |
| ΔE_{Elstat} | −94.0 | 58.7% | −84.1 | 64.2% | −161.5 | 61.1% | −89.9 | 59.0% | −72.3 | 63.7% | −156.4 | 61.4% |
| ΔE_{Orb} | −56.4 | 35.2% | −41.9 | 32.0% | −97.2 | 36.8% | −52.0 | 34.1% | −35.6 | 31.4% | −91.8 | 36.0% |
| ΔE_{Disp} | −9.6 | 6.0% | −4.9 | 3.7% | −5.8 | 2.2% | −10.5 | 6.9% | −5.7 | 5.0% | −6.7 | 2.6% |
| ΔEᵢₙₜ | −46.6 | | −29.6 | | −65.0 | | −41.6 | | −26.9 | | −60.5 | |
| π₂*- | −31.8 | 56.4% | −21.0 | 50.1% | −49.7 | 51.1% | −28.1 | 54.0% | −16.4 | 46.2% | −45.1 | 49.1% |
| C₂H₄← M | | | | | | | | | | | | |
| π₁- | −16.6 | 29.4% | −13.7 | 32.6% | −35.1 | 36.1% | −16.0 | 30.7% | −12.7 | 35.8% | −34.3 | 37.4% |
| C₂H₄→ M | | | | | | | | | | | | |
| [t-BuPhB(3- | | | | | | | | | | | | |
| (CF₃)Pz)₃]⁻ | | | | | | | | | | | | |
| ΔE_{Pauli} | 114.2 | | 100.8 | | 199.5 | | 111.7 | | 94.1 | | 110.8 | |
| ΔE_{Elstat} | −94.1 | 58.4% | −83.3 | 63.2% | −161.5 | 60.6% | −90.4 | 59.1% | −77.8 | 63.9% | −89.8 | 59.0% |
| ΔE_{Orb} | −56.3 | 34.9% | −41.7 | 31.7% | −97.8 | 36.7% | −52.2 | 34.1% | −38.1 | 31.3% | −51.8 | 34.1% |
| ΔE_{Disp} | −10.9 | 6.8% | −6.7 | 5.1% | −7.1 | 2.7% | −10.5 | 6.9% | −5.8 | 4.7% | −10.5 | 6.9% |
| ΔEᵢₙₜ | −47.1 | | −30.9 | | −66.9 | | −41.4 | | −27.6 | | −41.3 | |
| π₂*- | −31.5 | 56.0% | −20.6 | 49.4% | −50.4 | 51.6% | −28.3 | 54.2% | −18.9 | 49.7% | −28.0 | 54.0% |
| C₂H₄← M | | | | | | | | | | | | |
| π₁- | −16.4 | 29.1% | −13.5 | 32.3% | −34.7 | 35.4% | −15.9 | 30.5% | −12.6 | 33.1% | −15.8 | 30.6% |
| C₂H₄→ M | | | | | | | | | | | | |

A comparison to the related tris(pyrazolyl)borate complexes, π²-[t-BuPhB(3-(CF₃)Pz)₃]M(C₂H₄) reveals a slightly enhanced M-C₂H₄ interactions relative to the related tris(pyridyl)borate analogs, amounting to about 4.2 kcal·mol⁻¹ for Au, 3.0 for Cu and 2.2 for Ag species. However, it is difficult to attribute these differences solely to pyrazolyl vs pyridyl change as flanking t-BuPh-groups closer to the metal sites in these molecules could also have an effect on M-ethylene bonds.

In addition, π²-bound [t-BuPhB(6-(CF₃)Py)₃]M(C₂H₄) conformations are more stable than the corresponding π³-versions by 21.6 (Au), 13.7 (Cu), and 13.6 (Ag) kcal·mol⁻¹. Interestingly, these differences are significantly larger than those computed for the two bonding modes of [t-BuPhB(3-(CF₃)Pz)₃]M(C₂H₄) system, which also favours the R²-mode by 8.2 (Au), 5.6 (Cu), and 5.6 (Ag) kcal·mol⁻¹, respectively.

Overall, this study describes the synthesis of a new, chemically robust, tris(2-pyridyl)borate with a fluorine-lined coordination pocket. This pyridyl donor arm based scorpionate, [t-BuPhB(6-(CF₃)Py)₃]⁻ is an excellent ligand support for coinage metal ions as demonstrated by the isolation and study of all three ethylene complexes of the group 11 triad. This is also the first tris(pyridyl)borate ligand with substituents at the pyridyl ring 6-positions. Such ligands that can provide added steric protection to a coordinated metal site are particularly desirable for various applications, which is evident from popularity of the second-generation, 3-substituted tris(pyrazolyl)borates over the parent [HB(Pz)₃]⁻. (C. Pettinari and C. Santini, Compr. Coord. Chem. II, 2004, 1, 159-210; H. V. R. Dias and C. J. Lovely, Chem. Rev., 2008, 108, 3223-3238; J. M. Munoz-Molina, T. R. Belderrain and P. J. Perez, Coord. Chem. Rev., 2019, 390, 171-189; G. Parkin, Adv. Inorg. Chem., 1995, 42, 291-393). Metal centers of [t-BuPhB(6-(CF₃)Py)₃]M(C₂H₄) (M=Cu, Ag, Au) adopt a trigonal planar geometry. Interestingly, the tripodal tris(pyridyl)borate uses only two of the three pyridyl donor arms to bind the metal ion in these molecules. Computational analysis suggest that it is the preferred option. The metal-C₂H₄ bonding interaction is primarily electrostatic in nature. However, s-donor and p-backbonding contributions between the two fragments are also significant, with the latter playing the relatively larger role. A comparison of key metrical and spectroscopic features of [t-BuPhB(6-(CF₃)Py)₃]M(C₂H₄) to the available tris(pyrazolayl)borate analogs does not show large differences.

### General Procedures

All preparations and manipulations were carried out under an atmosphere of purified nitrogen using standard Schlenk techniques or in a MBraun drybox equipped with a −25° C. refrigerator. Commercially available solvents were purified and dried by standard methods. Glassware was oven dried overnight at 150° C. NMR spectra were acquired at 25° C., on a JEOL Eclipse 500 spectrometer (¹H, 500 MHz; ¹³C, 126 MHz; ¹⁹F, 471 MHz), and a JEOL Eclipse 300 spectrometer (¹¹B, 96 MHz). ¹⁹F NMR values were referenced to external CFCl₃. ¹H and ¹³C{¹H} NMR spectra were referenced internally to solvent signals (CDCl₃: 7.26 ppm for ¹H NMR, 77.16 ppm for ¹³C NMR; DMSO-d₆: 2.50 ppm for ¹H NMR, 39.52 ppm for ¹³C NMR), all other NMR spectra externally to SiMe₄ (0 ppm). ¹H NMR chemical shifts are reported in ppm and coupling constants (J) are reported in Hertz (Hz). Abbreviations used for signal assignments: Ph=phenyl, Py=pyridyl, Pyⁿ=non-coordinated pyridine, s=singlet, d=doublet, t=triplet, q=quartet, dd=doublet of doublets, m=multiplet, br=broad. NMR solvents were purchased from Cambridge Isotopes Laboratories and used as received. Ethylene gas was purchased from Matheson. Elemental analyses were performed using a Perkin-Elmer Model 2400 CHN analyzer. 4-t-Butylphenyl dibromoborane and mesityl copper were prepared according to literature procedures. (Y. Qin, I. Kiburu, S. Shah and F. Jäkle, Org. Lett., 2006, 8, 5227-5230; M. Ohashi, T. Adachi, N. Ishida, K. Kikushima and S. Ogoshi, Angew. Chem., Int. Ed., 2017, 56, 11911-11915) All other reagents were obtained from commercial sources and used as received. Silver and gold complexes were prepared in reaction vessels protected from light using aluminum foil.

Synthesis of [t-BuPhB{2-(6-(CF₃)Py)}3]H

To a solution of i-PrMgCl in THE (60.84 mL, 121.68 mmol, 2M), a solution of 2-bromo-6-(trifluoromethyl)pyridine in 55 mL THE (25.0 g, 110.62 mmol) was slowly added through a syringe at 0° C. The resulting dark brown reaction mixture was warmed to room temperature and kept stirring for 5 h. The solvent was reduced under vacuum to obtain the dark slurry, which was then carefully transferred under nitrogen protection to a fritted addition funnel and anhydrous THE (ca. 50 mL) was used to help complete the transfer of the solids. Anhydrous THE was continuously passed through the filter cake until it was white and the filtrate colorless. The solid was dried under high vacuum at room temperature for 6 h and then further dried under high vacuum at 65° C. for 6 h. It was assumed that the resulted Grignard was formed as {(6-(CF₃)-2-Py)MgCl}₂·(THF)₃. Yield, 15 g (38%).

t-Butylphenyl dibromoborane (3.00 g, 9.87 mmol) in CH₂Cl₂ (20 mL) was added dropwise to a solution of {(6-(CF₃)-2-Py)MgCl}₂·(THF)₃ (9.3 g, 14.81 mmol) in CH₂Cl₂ (20 mL) at 0° C. The resulting dark red mixture was slowly warmed to room temperature and kept stirring for 48 h. The reaction mixture was then poured into an aqueous Na₂CO₃ solution (18.0 g in 150 mL H₂O) and stirred for 1 h, and then extracted with CH₂Cl₂ (3×30 mL). The organic extracts were combined, washed with brine, dried over Na₂SO₄ and evaporated to dryness. The residue dissolved in CH₂Cl₂ (50 mL), activated charcoal was added and then filtered through small pad of Celite and evaporated to dryness. The resulting residue was recrystallized from acetone to obtain the desired [t-BuPhB{2-(6-(CF₃)Py)}₃]H as white crystalline solid. Yield: 4.96 g (86%). Anal. Calc. C₂₈H₂₃B₁F₉N₃: C, 57.66%; H, 3.97%; N, 7.20%. Found: C, 57.73%; H, 4.05%; N, 7.15%. ¹H NMR (500 MHz, CDCl₃): δ=19.11 (br, 1H, NH), 7.74-7.69 (m, 6H, Py), 7.50 (d, J=6.9 Hz, 3H, Py), 7.21 (d, J=7.8 Hz, 2H, Ph), 7.04 (d, J=7.0 Hz, 2H, Ph), (s, 9H, CH₃) ppm. ¹¹B NMR (96 MHz, CDCl₃): δ=−11.56 ppm. ¹³C NMR (126 MHz, CDCl₃): δ=184.79 (q, ¹J_{C-B}=55.2 Hz, Py), 150.15 (q, ¹J_{C-B}=54.0 Hz, Ph), 147.86 (Ph), 142.60 (q, ²J_{C-F}=36.0 Hz, Py), 136.55 (Py), 134.60 (Py), 134.44 (Ph), 124.53 (Ph), 121.5 (q, ¹J_{C-F}=274.7 Hz, CF₃), 117.16 (Py), 34.38 (C—CH₃), 31.59 (CH₃). ¹⁹F NMR (471 MHz, CDCl₃): δ=−67.40 ppm. ¹¹B NMR, CDCl₃): δ=−11.56 ppm. This product was further characterized by X-ray crystallography.

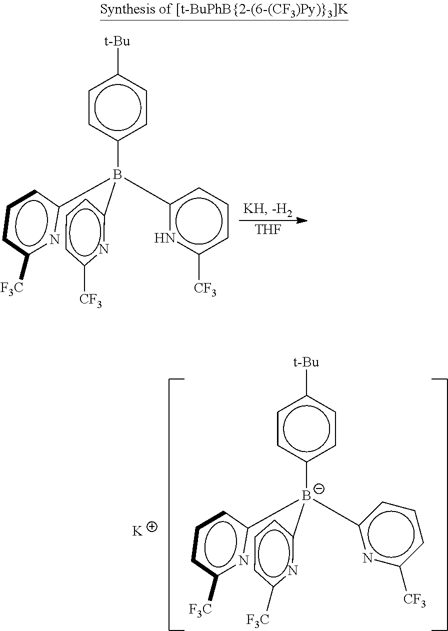

To a suspension of KH (0.23 g, 5.71 mmol) in anhydrous THE (25 mL) at 0° C. was slowly added a solution of [t-BuPhB{2-(6-(CF₃)Py)}₃]H (2.56 g, 4.39 mmol) in THE (25 mL). After complete ceasing of hydrogen gas evolution, the reaction mixture was allowed to warm to room temperature and then kept stirring for 12 h. The solution was filtered through a celite packed frit to remove unreacted KH. The solvent in the filtrate collected was removed under reduced pressure to obtain [t-BuPhB{2-(6-(CF₃)Py)}₃]K as a white solid. The compound was further dried at 90° C. for 6 h under reduced pressure to remove all trace solvent. Yield: 2.57 (94%). This was used directly in the next steps. ¹H NMR (500 MHz, DMSO-d₆): δ=7.62 (d, J=7.9 Hz, 3H, Py), 7.49 (t, J=7.8 Hz, 3H, Py), 7.28 (dd, J=7.6, 1.0 Hz, 3H, Py), 7.14 (d, J=5.4 Hz, 2H, Ph), 6.99 (d, J=8.3 Hz, 2H, Ph), 1.23 (s, 9H, CH₃) ppm. ¹³C NMR (126 MHz, MHz, DMSO-d₆): δ=188.25 (q, ¹J_{C-B}=55.2 Hz, Py), 155.82 (q, ¹J_{C-B}=50.4 Hz, Ph), 144.39 (q, ²J_{C-F}=31.2 Hz, Py), 144.16 (Ph), 134.65 (Ph), 132.88 (Py), 132.48 (Py), 122.82 (q, ¹J_{C-F}=274.7 Hz, CF₃), 122.56 (Ph), 114.05 (Py), 33.74 (C—CH₃), 31.54 (CH₃). ¹⁹F NMR (471 MHz, DMSO-d₆): δ=−66.18 ppm. ¹¹B NMR (96 MHz, DMSO-d₆): δ=−8.35 ppm.

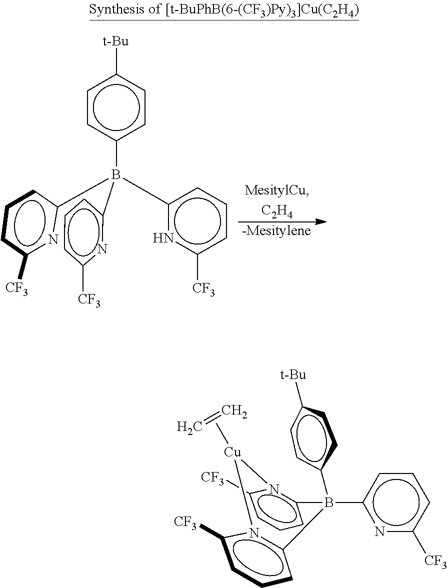

Ethylene saturated anhydrous toluene (15 mL) was transferred using a cannular to a 50 mL Schlenk flask containing a mixture of [t-BuPhB{2-(6-(CF₃)Py)}₃]H (150 mg, 257 μmol) and mesityl copper (52 mg, 282 μmol) at room temperature under ethylene atmosphere. The reaction mixture was kept stirring for 3 h, during this period ethylene was bubbled every one hour for 30 seconds each time. The solvent was then removed reduced pressure, and the compound was recrystallized from ethylene saturated hexane at −20° C. to obtain colorless X-ray quality single crystals of [t-BuPhB{2-(6-(CF₃)Py)}3]Cu(C₂H₄). Yield: 156 mg (90%). Anal. Calc. C₃₀H₂₆B₁Cu₁F₉N₃: C, 53.47%; H, 3.89%; N, 6.24%. Found: C, 52.62%; H, 3.82%; N, 6.05%. ¹H NMR (500 MHz, CDCl₃): δ=7.86 (d, J=7.9 Hz, 2H, Py), 7.67 (t, J=7.9 Hz, 2H, Py), 7.57 (t, J=7.8 Hz, 1H, Pyⁿ), 7.48 (two overlapped doublets, 1H, Pyⁿ; 2H, Py), 7.21 (d, J=8.2 Hz, 2H, Ph), 6.95 (d, J=7.7 Hz, 1H, Pyⁿ), 6.76 (d, J=6.0 Hz, 2H, Ph), 3.57 (s, 4H, C₂H₄), 1.30 (s, 9H, CH₃) ppm. ¹³C NMR (126 MHz, CDCl₃): δ=185.98 (q, ¹J_{C-B}=52.8 Hz, Py), 182.14 (q, ¹J_{C-B}=57.6 Hz, Pyⁿ), 150.28 (q, ¹J_{C-B}=50.4 Hz, Ph), 149.39 (Ph), 146.77 (q, ²J_{C-F}=33.6 Hz, Pyⁿ), 145.77 (q, ²J_{C-F}=33.6 Hz, Py), 137.35 (Ph), 136.00 (Py), 135.23 (Pyⁿ), 133.95 (Py), 133.59 (Pyⁿ), 124.66 (Ph), 122.68 (q, ¹J_{C-F}=274.7 Hz, CF₃-Py), 121.96 (q, ¹J_{C-F}=274.7 Hz, CF₃-Pyⁿ), 117.97 (Py), 115.95 (Pyⁿ), 85.13 (C₂H₄), 34.56 (C—CH₃), 31.53 (CH₃) ppm. ¹⁹F NMR (471 MHz, CDCl₃): δ=−65.57 (s, 6F, CF₃—Py), −67.85 (s, 3F, CF₃-Pyⁿ) ppm. ¹¹B NMR (96 MHz, CDCl₃): δ=−8.47 ppm.

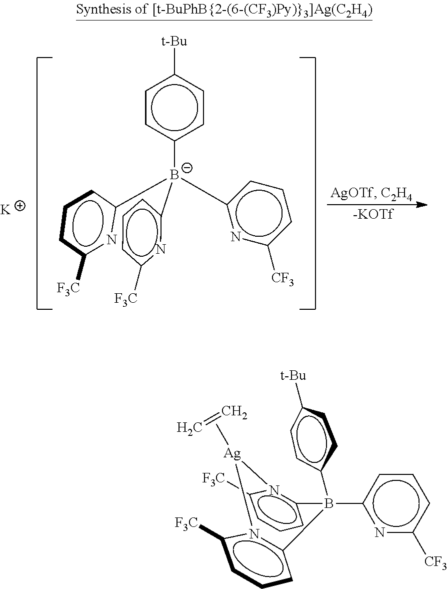

Ethylene saturated anhydrous dichloromethane (15 mL) was transferred using a cannular to a 50 mL Schlenk flask containing a mixture of [t-BuPhB{2-(6-(CF₃)Py)}₃]K (150 mg, 241 μmol) and AgOTf (65 mg, 253 μmol) at room temperature under ethylene atmosphere. The reaction mixture was kept stirring for 3 h, during this period ethylene was bubbled every one hour for 30 seconds each time. The reaction mixture was then cannula filtered through a celite packed frit to remove KOTf. The filtrate was concentrated to c.a. 3 mL under reduced pressure and then dried with a flow of ethylene gas to obtain the white colored solid, which was then recrystallized from ethylene saturated hexane at −20° C. to obtain colorless X-ray quality single crystals of [t-BuPhB{2-(6-(CF₃)Py)}₃]Ag(C₂H₄). Yield: 130 mg (78%). Anal. Calc. C₃₀H₂₆Ag₁B₁F₉N₃: C, 50.17%; H, 3.65%; N, 5.85%. Found: C, 49.90%; H, 3.58%; N, 5.65%. ¹H NMR (500 MHz, CDCl₃): δ=8.25 (brs, Py), 7.57 (brs, 3H, Py), 7.41 (d, J=7.8 Hz, 3H, Py), 7.28 (d, J=8.2 Hz, 2H, Ph), 6.89 (brs, 2H, Ph), 4.66 (s, 4H, C₂H₄), 1.34 (s, 9H, CH₃) ppm. ¹³C NMR (126 MHz, CDCl₃): δ=185.43 (brs, Py_{C-B}), 148.94 (Ph), 148.29 (q, ¹J_{C-B}=51.6 Hz, Ph), 145.85 (q, ²J_{C-F}=30.0 Hz, Py), 136.86 (Ph), 135.35 (Py), 133.38 (Py), 124.63 (Ph), 122.3 (q, ¹J_{C-F}=267.5 Hz, CF₃), 116.33 (Py), 103.15 (C₂H₄), 34.55 (C—CH₃), 31.66 (CH₃) ppm. ¹⁹F NMR (471 MHz, CDCl₃): δ=−67.85 ppm. ¹¹B NMR (96 MHz, CDCl₃): δ=−7.90 ppm.

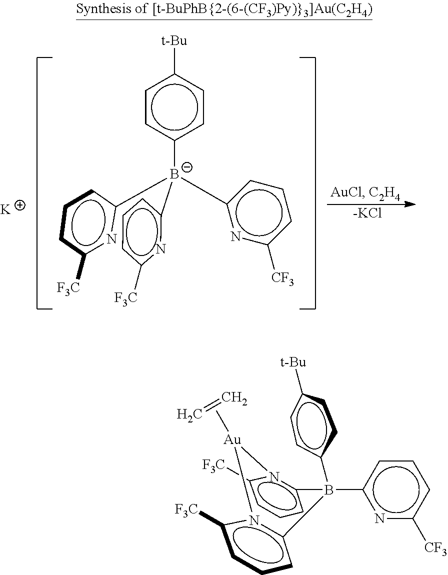

Ethylene saturated anhydrous dichloromethane (15 mL) at −78° C. was transferred using a cannular to a 50 mL Schlenk flask containing a mixture of [t-BuPhB{2-(6-(CF₃)Py)}₃]K (100 mg, 161 μmol) and AuCl (39 mg, 169 μmol) at −78° C. under ethylene atmosphere. After stirring 10 min at −78° C., the reaction mixture then warmed to room temperature and stirred for another 10 min, then filtered through a celite-covered fritted funnel once the solution was colorless. The solvent was then removed under reduced pressure to obtain the white solid, which was then recrystallized from ethylene saturated hexane at −20° C. to obtain colorless X-ray quality single crystals of [t-BuPhB{2-(6-(CF₃)Py)}₃]Au(C₂H₄). Yield: 81 mg (62%). Anal. Calc. C₃₀H₂₆Au₁B₁F₉N₃: C, 44.63%; H, 3.25%; N, 5.20%. Found: C, 44.82%; H, 3.20%; N, 5.07%. ¹H NMR (500 MHz, CDCl₃): δ=7.83 (brs, Py), 7.65 (t, J=7.6 Hz, 3H, Py), 7.54 (d, J=7.9 Hz, 3H, Py), 7.16 (d, J=8.2 Hz, 2H, Ph), 6.65 (t, J=11.8 Hz, 2H, Ph), 2.66 (s, 4H, C₂H₄), 1.29 (s, 9H, CH₃). ¹³C NMR (126 MHz, CDCl₃): δ=186.42 (brs, Py), 151.31 (q, ¹J_{C-B}=50.4 Hz, Ph), 148.46 (Ph), 146.34 (q, ²J_{C-F}=33.6 Hz, Py), 136.10 (Ph), 135.84 (Py), 134.71 (Py), 124.08 (Ph), 121.5 (q, ¹J_{C-F}=274.7 Hz, CF₃), 117.73 (Py), 58.67 (C₂H₄), 34.42 (C—CH₃), 31.64 (CH₃) ppm. ¹⁹F NMR (471 MHz, CDCl₃): δ=−66.31, −67.53 ppm. ¹¹B NMR (96 MHz, CDCl₃): δ=−8.18 ppm.

X-ray Structure Determinations. A suitable crystal covered with a layer of hydrocarbon/Paratone-N oil was selected and mounted on a Cryo-loop, and immediately placed in the low temperature nitrogen stream. The X-ray intensity data were collected on a Bruker D8 Quest equipped with a PHOTON II 7 CPAD detector and an Oxford Cryosystems 700 series cooler, a Triumph graphite monochromator, and a Mo Ku fine-focus sealed tube (λ=0.71073 Å). The data of the [t-BuPhB(6-(CF₃)Py)₃]Cu(C₂H₄) were collected at a higher temperature of 190(2) K (because crystals tend to crack at 100 K) while those of the related Ag and Au complexes and [t-BuPhB(6-(CF₃)Py)₃]H were measured at 100(2) K. Intensity data were processed using the Bruker Apex4 program suite. Absorption corrections were applied by using SADABS. (L. Krause, R. Herbst-Irmer, G. M. Sheldrick and D. Stalke, J. Appl. Crystallogr., 2015, 48, 3-10.) Initial atomic positions were located by SHELXT, and the structures of the compounds were refined by the least-squares method using SHELXL within Olex2 GUI. (G. Sheldrick, Acta Crystallogr. Sect. A: Found. Adv., 2015, 71, 3-8; G. Sheldrick, Acta Crystallogr. Sect. C: Struct. Chem., 2015, 71, 3-8; O. V. Dolomanov, L. J. Bourhis, R. J. Gildea, J. A. K. Howard and H. Puschmann, J. Appl. Crystallogr., 2009, 42, 339-341.) All the non-hydrogen atoms were refined anisotropically. All the hydrogen atoms (except those on ethylene of the Ag and Au complexes, and on nitrogen of the free ligand) were included at calculated positions and refined using appropriate riding models. The hydrogen atoms on ethylene carbons of the Ag and Au complexes and on nitrogen of [t-BuPhB(6-(CF₃)Py)₃]H were located in the difference map and refined freely.

CheckCif indicated C-level, ADDSYM alerts for [t-BuPhB(6-(CF₃)Py)₃]Cu(C₂H₄) and [t-BuPhB(6-(CF₃)Py)₃]Au(C₂H₄) complexes. However, more detailed analysis using Platon ADDSYM run did not reveal an alternative option apart from P2₁/n. As an additional test, the study solved and refined the structure of [t-BuPhB(6-(CF₃)Py)₃]Au(C₂H₄) also in P21/m in a smaller unit cell (a=11.6597 Å, b=10.3872 Å, c=12.7188 Å, β=109.706°, V=1450.18 Å³). However, except for the Au—C₂H₄ fragment, refinement in this space group required the use of significant whole molecule disorder model over a mirror plane. The room temperature data of the same sample was also collected and found to be a clear fit for P2₁/m (a=11.6718(10) Å, b=10.5613(9) Å, c=12.8825(10) Å, β=107.638(4°), V=1513.4(2) Å³, Z=2), and refined well with minor (acceptable) disorder. Overall, P21/n is the better, correct option at 100K for [t-BuPhB(6-(CF₃)Py)₃]Au(C₂H₄). X-ray structural figures were generated using Olex2.

CCDC files with numbers 2126166-2126168 contain the supplementary crystallographic data for [t-BuPhB(6-(CF₃)Py)₃]M(C₂H₄) (M=Cu, Ag, Au), while 2126169 and 2126170 represent 100K data on [t-BuPhB(6-(CF₃)Py)₃]H and room temperature data on [t-BuPhB(6-(CF₃)Py)₃]Au(C₂H₄). This data can be obtained free of charge via www.ccdc.cam.ac.uk/conts/retrieving.html or from the Cambridge Crystallographic Data Centre (CCDC), 12 Union Road, Cambridge, CB2 1EZ, UK).

TABLE 3
Crystal data and structure refinement for [t-BuPhB(6-(CF₃)Py)₃]H, [t-BuPhB(6-
(CF₃)Py)₃]Cu(C₂H₄), [t-BuPhB(6-(CF₃)Py)₃]Ag(C₂H₄), and [t-BuPhB(6-(CF₃)Py)₃]Au(C₂H₄).

| | [t-BuPhB(6- | [t-BuPhB(6- | [t-BuPhB(6- | [t-BuPhB(6- |
|---|---|---|---|---|
| | (CF₃)Py)₃]H | (CF₃)Py)₃]Cu(C₂H₄) | (CF₃)Py)₃]Ag(C₂H₄) | (CF₃)Py)₃]Au(C₂H₄) |
| Empirical formula | C₂₈H₂₃BF₉N₃ | C₃₀H₂₆BCuF₉N₃ | C₃₀H₂₆AgBF₉N₃ | C₃₀H₂₆AuBF₉N₃ |
| Formula weight | 583.30 | 673.89 | 718.22 | 807.31 |
| Temperature/K | 100.00 | 190.00 | 100.00 | 100.00 |
| Crystal system | monoclinic | monoclinic | triclinic | monoclinic |
| Space group | P2₁/n | P2₁/n | P-1 | P2₁/n |
| a/Å | 10.4400(6) | 11.6525(6) | 10.2339(4) | 11.6594(4) |
| b/Å | 20.0684(12) | 10.4312(6) | 12.0369(4) | 10.3878(4) |
| c/Å | 13.0151(8) | 24.2415(12) | 12.9756(4) | 24.1447(8) |
| α/° | 90 | 90 | 72.0740(10) | 90 |
| β/° | 101.246(2) | 98.454(3) | 89.2980(10) | 97.334(2) |
| γ/° | 90 | 90 | 73.7390(10) | 90 |
| Volume/Å³ | 2674.5(3) | 2914.5(3) | 1455.17(9) | 2900.37(18) |
| Z | 4 | 4 | 2 | 4 |
| ρ_{calc}g/cm³ | 1.449 | 1.536 | 1.639 | 1.849 |
| μ/mm⁻¹ | 0.129 | 0.833 | 0.777 | 5.157 |
| F(000) | 1192.0 | 1368.0 | 720.0 | 1568.0 |
| Crystal size/mm³ | 0.22 × | 0.28 × | 0.25 × | 0.18 × |
| | 0.2 × 0.08 | 0.2 × 0.18 | 0.2 × 0.18 | 0.16 × 0.06 |
| Radiation | Mo Kα | Mo Kα | Mo Kα | Mo Kα |
| | (λ = 0.71073) | (λ = 0.71073) | (λ = 0.71073) | (λ = 0.71073) |
| 2Θ range for data | 5.018 to 55.75 | 5.268 to 58.336 | 5.102 to 66.282 | 5.676 to 66.28 |
| collection/° | | | | |
| Index ranges | −13 ≤ h ≤ 13, | −15 ≤ h ≤ 15, | −15 ≤ h ≤ 15, | −17 ≤ h ≤ 17, |
| | −26 ≤ k ≤ 26, | −14 ≤ k ≤ 14, | −18 ≤ k ≤ 18, | −15 ≤ k ≤ 15, |
| | −17 ≤ l ≤ 17 | −33 ≤ l ≤ 33 | −19 ≤ l ≤ 19 | −36 ≤ l ≤ 37 |
| Reflections collected | 69590 | 39559 | 27189 | 53841 |
| Independent | 6376 [Rᵢₙₜ = | 7851 [Rᵢₙₜ = | 10786 [Rᵢₙₜ = | 11004 [Rᵢₙₜ = |
| reflections | 0.0457, | 0.0357, | 0.0214, | 0.0248, |
| | R_{sigma} = 0.0288] | R_{sigma} = 0.0271] | R_{sigma} = 0.0287] | R_{sigma} = 0.0189] |
| Data/restraints/ | 6376/0/378 | 7851/48/428 | 10786/55/484 | 11004/0/417 |
| parameters | | | | |
| Goodness-of-fit on | 1.167 | 1.072 | 1.026 | 1.012 |
| F² | | | | |
| Final R indexes | R₁ = 0.0707, | R₁ = 0.0586, | R₁ = 0.0398, | R₁ = 0.0226, |
| [I >= 2σ (I)] | wR₂ = 0.1817 | wR₂ = 0.1268 | wR₂ = 0.0820 | wR₂ = 0.0414 |
| Final R indexes | R₁ = 0.1169, | R₁ = 0.0764, | R₁ = 0.0462, | R₁ = 0.0382, |
| [all data] | wR₂ = 0.2480 | wR₂ = 0.1345 | wR₂ = 0.0859 | wR₂ = 0.0485 |
| Largest diff. | 0.48/−0.51 | 0.48/−0.33 | 1.28/−1.01 | 1.81/−1.63 |
| peak/hole/e Å⁻³ | | | | |

Computational Details. Density Functional Theory calculations were carried out by using relativistic methods employing the ADF code with the all-electron triple-ζ Slater basis set plus the double-polarization (STO-TZ2P) basis set in conjunction with the Becke-Perdew (BP86) functional via the generalized gradient approximation (GGA). (S. ADF 2019, Theoretical Chemistry, Vrije Universiteit, Amsterdam, The Netherlands); A. D. Becke, Physical Review A, 1988, 38, 3098-3100). London dispersion corrections were taken into account via the pairwise Grimme (BP86-D3) approach. (S. Grimme, WIREs Computational Molecular Science, 2011, 1, 211-228.) Geometry optimizations were performed via the analytical energy gradient method implemented by Versluis and Ziegler, with energy convergence criteria set at 10⁻⁴ Hartree, gradient convergence criteria at 10⁻⁴ Hartree/Å, and radial convergence of 10⁻³ Å, without any symmetry restrain. Scalar relativistic effects were considered through the ZORA Hamiltonian. (E. v. Lenthe, E. J. Baerends and J. G. Snijders, The Journal of Chemical Physics, 1994, 101, 9783-9792.)

The interaction energy is further dissected into several chemically meaningful terms according to the Energy Decomposition Analysis (EDA) of Ziegler and Rauk, (M. v. Hopffg arten and G. Frenking, WIREs Computational Molecular Science, 2012, 2, 43-62; T. Ziegler and A. Rauk, Theoretica chimica acta, 1977, 46, 1-10):

$$Δ {E}_{i n t} = Δ {E}_{Pauli} + Δ {E}_{elstat} + Δ {E}_{orb} + Δ {E}_{disp}$$

where ΔE_{Pauli} term involves the electron repulsion between occupied orbitals from the different fragments. ΔEₑₗₛₜₐₜ and ΔE_{orb} are related to the stabilizing electrostatic and covalent character of the interaction, respectively. The contribution from dispersion interaction (ΔE_{disp}) is evaluated using the pairwise correction of Grimme (D3). Bonding analysis is given in terms of bonding contributions to ΔE_{orb} by using the Natural Orbitals for Chemical Valence extension of the EDA method (EDA-NOCV) (M. P. Mitoraj, A. Michalak and T. Ziegler, Journal of Chemical Theory and Computation, 2009, 5, 962-975), resulting in deformation densities accounting for the individual in- and out-flow of charges related to the bonding pattern. A comparison between the energy differences between different coordination modes is shown below in Table 4.

TABLE 4
Energy difference between the molecules of two different coordination
modes, namely, κ²- and κ³- for [t-BuPhB(6-(CF₃)Py)₃]M(C₂H₄),
[PhB(6-(CF₃)Py)₃]M(C₂H₄), [PhB(6-(CF₃)Pz)₃]M(C₂H₄),
and [t-BuPhB(6-(CF₃)Pz)₃]M(C₂H₄) complexes (M = Cu, Ag, Au).
Values in kcal · mol⁻¹. In all cases the κ²-coordination
mode is favoured.

| M= | Cu | Ag | Au |
|---|---|---|---|
| [t-BuPhB(6-(CF₃)Py)₃]M(C₂H₄) | 13.7 | 13.6 | 21.5 |
| [PhB(6-(CF₃)Py)₃]M(C₂H₄) | 19.7 | 12.6 | 24.9 |
| [PhB(3-(CF₃)Pz)₃]M(C₂H₄) | 5.6 | 5.6 | 8.2 |
| [t-BuPhB(3-(CF₃)Pz)₃]M(C₂H₄) | 5.5 | 5.2 | 10.9 |

### Example 2: Carbonyl and Isocyanide Complexes of Copper and Silver Supported by Fluorinated Poly(Pyridyl)Borates

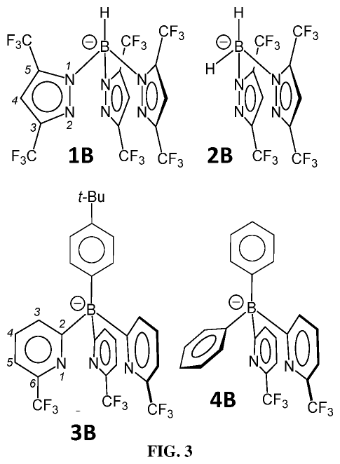

Fluorine is the most electronegative element in the periodic table, and in association with carbon, forms some of the most robust, chemically inert single bonds (e.g., BDE of C—F and C—H bonds of CF₄ and CH₄ are 546.8 and 439.3 kJ/mol, respectively). (Eisenstein, O.; Milani, J.; Perutz, R. N., Selectivity of C—H Activation and Competition between C—H and C—F Bond Activation at Fluorocarbons. Chem. Rev. 2017, 117 (13), 8710-8753). As a result, metal complexes of fluorinated ligands in comparison to their non-fluorinated, hydrocarbon counterparts, usually display different properties such as relatively high thermal and oxidative stability, volatility, and unique reactivity profiles. Mishra, S.; Daniele, S., Metal-Organic Derivatives with Fluorinated Ligands as Precursors for Inorganic Nanomaterials. Chem. Rev. 2015, 115 (16), 8379-8448; Chen, T.-H.; Popov, I.; Zenasni, O.; Daugulis, O.; Miljanic, O. S., Superhydrophobic perfluorinated metal-organic frameworks. Chem. Commun. 2013, 49 (61), 6846-6848; Grushin, V. V.; Herron, N.; LeCloux, D. D.; Marshall, W. J.; Petrov, V. A.; Wang, Y., New, efficient electroluminescent materials based on organometallic Ir complexes. Chem. Commun. 2001, (16), 1494-1495; Ritter, T.; Day, M. W.; Grubbs, R. H., Rate Acceleration in Olefin Metathesis through a Fluorine-Ruthenium Interaction. J. Am. Chem. Soc. 2006, 128 (36), 11768-11769; Dehnen, S.; Schafer, L. L.; Lectka, T.; Togni, A., Fluorine: A Very Special Element and Its Very Special Impacts on Chemistry. Inorg. Chem. 2021, 86 (23), 16213-16219 They are also ideal for applications in fluorous-biphase media and supercritical CO₂. (Horvith, I. T., Fluorous Biphase Chemistry. Acc. Chem. Res. 1998, 31 (10), 641-650; Carter, C. A. G.; Baker, R. T.; Tumas, W.; Nolan, S. P., Enhanced regioselectivity of rhodium-catalyzed alkene hydroboration in supercritical carbon dioxide. Chem. Commun. 2000, (5), 347-348; Palo, D. R.; Erkey, C., Homogeneous catalytic hydroformylation of 1-octene in supercritical carbon dioxide using a novel rhodium catalyst with fluorinated arylphosphine ligands. Ind. Eng. Chem. Res. 1998, 37 (10), 4203-4206.) Fluorinated poly(pyrazolyl)borates (which belong to a family known as scorpionates) (Trofimenko, S., Recent advances in poly(pyrazolyl)borate (scorpionate) chemistry. Chem. Rev. 1993, 93 (3), 943-80; Pettinari, C.; Santini, C., Polypyrazolylborate and scorpionate ligands. Compr. Coord. Chem. 112004, 1, 159-210) such as [HB(3,5-(CF₃)₂Pz)₃]⁻ (1B, FIG. 3) and [H₂B(3,5-(CF₃)₂Pz)₂]⁻ (2B) are a particularly useful group of ligands as they have facilitated the stabilization of rare species such silver(I)-acetylene, (Dias, H. V. R.; Wang, Z.; Jin, W., Synthesis and Chemistry of [Hydrotris(3,5-bis(trifluoromethyl)pyrazolyl)borato]silver(I) Complexes. Inorg. Chem. 1997, 36 (27), 6205-6215) copper(I) and silver(I)-organo azide, (Dias, H. V. R.; Polach, S. A.; Goh, S.-K.; Archibong, E. F.; Marynick, D. S., Copper and Silver Complexes Containing Organic Azide Ligands: Syntheses, Structures, and Theoretical Investigation of [HB(3,5-(CF₃)₂Pz)₃]CuNNN(1-Ad) and [HB(3,5-(CF₃)₂Pz)₃]AgN(1-Ad)NN (Where Pz=Pyrazolyl and 1-Ad=1-Adamantyl). Inorg. Chem. 2000, 39 (17), 3894-3901) and silver(I)-dimethyl diazomalonate (Dias, H. V. R.; Polach, S. A., An Isolable, Oxygen-Coordinated Silver(I) Complex of Dimethyl Diazomalonate: Synthesis and Characterization of [HB(3,5-(CF₃)₂Pz)₃]Ag[OC(OCH₃)]₂CN₂ (Where Pz=Pyrazolyl). Inorg. Chem. 2000, 39 (21), 4676-4677) complexes and to probe their chemistry under readily accessible conditions. They are also valuable in applications involving catalysis including those in super-critical CO₂, ethylene sensing, to olefin-paraffin separations. (Gava, R.; Olmos, A.; Noverges, B.; Varea, T.; Alvarez, E.; Belderrain, T. R.; Caballero, A.; Asensio, G.; Pérez, P. J., Discovering Copper for Methane C—H Bond Functionalization. ACS Catal. 2015, 5 (6), 3726-3730; Munoz-Molina, J. M.; Belderrain, T. R.; Perez, P. J., Trispyrazolylborate coinage metals complexes: Structural features and catalytic transformations. Coord. Chem. Rev. 2019, 390, 171-189; Olmos, A.; Asensio, G.; Perez, P. J., Homogeneous Metal-Based Catalysis in Supercritical Carbon Dioxide as Reaction Medium. ACS Catal. 2016, 6 (7), 4265-4280; Noonikara-Poyil, A.; Munoz-Castro, A.; Boretskyi, A.; Mykhailiuk, P. K.; Dias, H. V. R., When SF₅ outplays CF₃: effects of pentafluorosulfanyl decorated scorpionates on copper. Chem. Sci. 2021, 12 (43), 14618-14623; Dias, H. V. R.; Lovely, C. J., Carbonyl and Olefin Adducts of Coinage Metals Supported by Poly(pyrazolyl)borate and Poly(pyrazolyl)alkane Ligands and Silver Mediated Atom Transfer Reactions. Chem. Rev. 2008, 108 (8), 3223-3238; Ponduru, T. T.; Sun, Z.; Cundari, T. R.; Dias, H. V. R., Nitrene Insertion into Aromatic and Benzylic C—H Bonds Catalyzed by Copper Complexes of Fluorinated Bis- and Tris(pyrazolyl)borates. ChemCatChem 2019, 11 (19), 4966-4973; Noonikara-Poyil, A.; Ridlen, S. G.; Dias, H. V. R., Isolable Copper(I) η²-Cyclopropene Complexes. Inorg. Chem. 2020, 59 (24), 17860-17865; Esser, B.; Schnorr, J. M.; Swager, T. M., Selective detection of ethylene gas using carbon nanotube-based devices: Utility in determination of fruit ripeness. Angew. Chem., Int. Ed. 2012, 51 (23), 5752-5756; Noonikara-Poyil, A.; Cui, H.; Yakovenko, A. A.; Stephens, P. W.; Lin, R.-B.; Wang, B.; Chen, B.; Dias, H. V. R., A Molecular Compound for Highly Selective Purification of Ethylene. Angew. Chem., Int. Ed. 2021, 60, 27184-27188.) For example, fluorinated tris(pyrazolyl)borates have been useful in supporting catalytically active and fairly reactive copper complexes, without the ligand itself getting destroyed. (Gava, R.; Olmos, A.; Noverges, B.; Varea, T.; Alvarez, E.; Belderrain, T. R.; Caballero, A.; Asensio, G.; Pdrez, P. J., Discovering Copper for Methane C—H Bond Functionalization. ACS Catal. 2015, 5 (6), 3726-3730; Hu, Z.; Williams, R. D.; Tran, D.; Spiro, T. G.; Gorun, S. M., Re-engineering Enzyme-Model Active Sites: Reversible Binding of Dioxygen at Ambient Conditions by a Bioinspired Copper Complex. J. Am. Chem. Soc. 2000, 122 (14), 3556-3557.) The silver complex [HB(3,5-(CF₃)₂Pz)₃]Ag is an effective mediator for the functionalization of inert C—Cl bonds of halocarbons as well as C—H bonds of saturated hydrocarbons via catalytic carbene insertion chemistry. (Munoz-Molina, J. M.; Belderrain, T. R.; Perez, P. J., Trispyrazolylborate coinage metals complexes: Structural features and catalytic transformations. Coord. Chem. Rev. 2019, 390, 171-189; Dias, H. V. R.; Lovely, C. J., Carbonyl and Olefin Adducts of Coinage Metals Supported by Poly(pyrazolyl)borate and Poly(pyrazolyl)alkane Ligands and Silver Mediated Atom Transfer Reactions. Chem. Rev. 2008, 108 (8), 3223-3238; Dias, H. V. R.; Browning, R. G.; Polach, S. A.; Diyabalanage, H. V. K.; Lovely, C. J., Activation of Alkyl Halides via a Silver-Catalyzed Carbene Insertion Process. J. Am. Chem. Soc. 2003, 125 (31), 9270-9271; Dias, H. V. R.; Browning, R. G.; Richey, S. A.; Lovely, C. J., Silver(I) Scorpionate Mediated Insertion of Carbenes into Aliphatic C—H Bonds. Organometallics 2004, 23 (6), 1200-1202.) The bis(pyrazolyl)borate [H₂B(3,5-(CF₃)₂Pz)₂]Cu serves as an excellent non-porous material for the separation of ethylene from an ethylene/ethane mixture. (Noonikara-Poyil, A.; Cui, H.; Yakovenko, A. A.; Stephens, P. W.; Lin, R.-B.; Wang, B.; Chen, B.; Dias, H. V. R., A Molecular Compound for Highly Selective Purification of Ethylene. Angew. Chem., Int. Ed. 2021, 60, 27184-27188.)

Example 1 describes the assembly of a fluorinated tris(2-pyridyl)borate [t-BuC₆H₄B(6-(CF₃)Py)₃]⁻ (3B, FIG. 3), (Dias, H. V. R.; Lovely, C. J., Carbonyl and Olefin Adducts of Coinage Metals Supported by Poly(pyrazolyl)borate and Poly(pyrazolyl)alkane Ligands and Silver Mediated Atom Transfer Reactions. Chem. Rev. 2008, 108 (8), 3223-3238; Dias, H. V. R.; Kim, H.-J., Novel Tris(pyrazolyl)borates Bearing Perfluoroalkyl Pigtails. Syntheses and Characterization of the Sodium and Copper(I) Complexes of [HB(3-(R)Pz)₃]⁻ (R═C₂F₅, C₃F₇; Pz=Pyrazolyl). Organometallics 1996, 15 (25), 5374-5379; Dias, H. V. R.; Gorden, J. D., Synthesis and Characterization of Copper(II), Zinc(II), and Potassium Complexes of a Highly Fluorinated Bis(pyrazolyl)borate Ligand. Inorg. Chem. 1996, 35 (2), 318-324) and demonstrated its utility in coinage metal ethylene chemistry. (Vanga, M.; Munoz-Castro, A.; Dias, H. V. R., Fluorinated tris(pyridyl)borate ligand support on coinage metals. Dalton Trans. 2022, 51 (4), 1308-1312.) In contrast to the pyrazole based poly(pyrazolyl)borates, (Trofimenko, S., Recent advances in poly(pyrazolyl)borate (scorpionate) chemistry. Chem. Rev. 1993, 93 (3), 943-80; Pettinari, C.; Santini, C., Polypyrazolylborate and scorpionate ligands. Compr. Coord. Chem. 112004, 1, 159-210) the pyridine based poly(pyridyl)borates are a recent addition to the scorpionate family. (Hodgkins, T. G.; Powell, D. R., Derivatives of the Dimethylbis(2-pyridyl)borate(1-) Ion: Synthesis and Structure. Inorg. Chem. 1996, 35 (7), 2140-2148; Cui, C.; Lalancette, R. A.; Jäkle, F., The elusive tripodal tris(2-pyridyl)borate ligand: a strongly coordinating tetraarylborate. Chem. Commun. 2012, 48 (55), 6930-6932.) The paucity of ligand variations apart from those based on the parent 2-pyridylborate is also noteworthy. Nevertheless, poly(2-pyridyl)borates are finding increasing utility as metal ion chelators, as they bring different donor properties (pyridyl vs. pyrazolyl), backbone stabilities (attributable to less polar B—C linkages vs. B—N), and steric profiles (due to the involvement of six-membered pyridyl donor arms instead of the five-membered pyrazolyl moieties) relative to the pyrazolyl counterparts. (Pawar, G. M.; Sheridan, J. B.; Jäkle, F., Pyridylborates as a New Type of Robust Scorpionate Ligand: From Metal Complexes to Polymeric Materials. Eur. J. Inorg. Chem. 2016, 2016 (15-16), 2227-2235.) This example describes the synthesis of a fluorinated bis(2-pyridyl)borate, [Ph₂B(6-(CF₃)Py)₂]⁻ (4B) and its effectiveness in copper and silver carbonyl and isocyanide chemistry.

The related molecules supported by the tris(2-pyridyl)borate 3B as well as a copper(I) carbonyl complex of a fluorinated tris(1-pyrazolyl)borate are also presented. The carbonyl and isocyanide complexes have CO and CN stretch that can serve as a gauge of ligand electronic effects on the metal sites. (Elschenbroich, C., Organometallics, 3rd, Completely Revised and Extended Edition. 3rd ed.; Wiley: Weinheim, 2006; p 817 pp.) Isolable silver carbonyl complexes are also quite rare.

### Results and Discussion

The fluorinated bis(2-pyridyl)borate ligand [Ph₂B(6-(CF₃)Py)₂]⁻ (4B) was synthesized by treating Ph₂BBr with the corresponding 2-pyridylmagnesium chloride (which was obtained from i-PrMgCl and 2-bromo-6-(trifluoromethyl)pyridine) in THF. (Vanga, M.; Munoz-Castro, A.; Dias, H. V. R., Fluorinated tris(pyridyl)borate ligand support on coinage metals. Dalton Trans. 2022, 51 (4), 1308-1312.) The protonated form of 4B, [Ph₂B(6-(CF₃)Py)₂]H (5B) was isolated as a white solid and characterized completely using NMR spectroscopy and elemental analysis. There are few bis(2-pyridyl)borate ligands such as [Me₂B(Py)₂]⁻, [Ph₂B(Py)₂]⁻, and [cyclooctane-1,5-diylB(Py)₂]⁻, (Hodgkins, T. G.; Powell, D. R., Derivatives of the Dimethylbis(2-pyridyl)borate(1-) Ion: Synthesis and Structure. Inorg. Chem. 1996, 35 (7), 2140-2148; Khaskin, E.; Zavalij, P. Y.; Vedernikov, A. N., Bidirectional Transfer of Phenyl and Methyl Groups between PtIV and Boron in Platinum Dipyridylborato Complexes. J. Am. Chem. Soc. 2008, 130 (31), 10088-10089; Pal, S.; Zavalij, P. Y.; Vedernikov, A. N., Oxidative C(sp³)-H bond cleavage, C—C and C:C coupling at a boron center with O₂ as the oxidant mediated by platinum(II). Chem. Commun. 2014, 50 (40), 5376-5378) known, but they all feature the parent 2-pyridyl donor arms. There are also no reports of bis(2-pyridyl)borate ligands such as 4B bearing substituents at the pyridyl ring 6-position, which due to their proximity to the coordinated metal atom, can provide better protection to a metal site, relative to 6-unsubstituted bis(2-pyridyl)borate chelators such as [Ph₂B(Py)₂]⁻. ( )

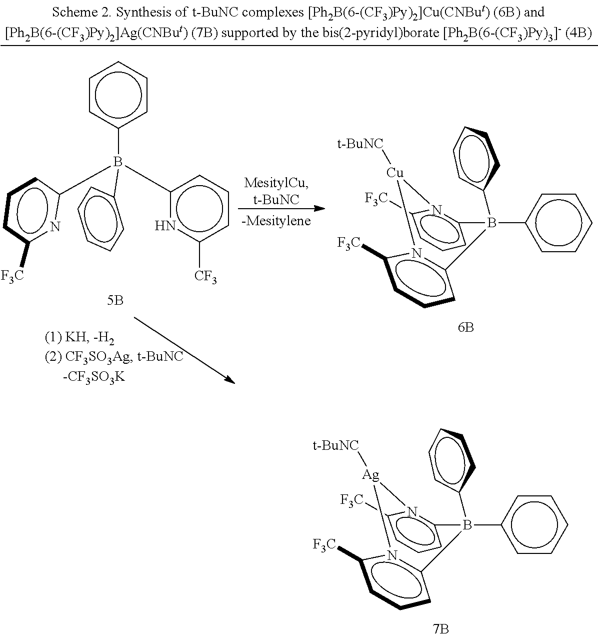

In order to evaluate the coordination prowess and features of [Ph₂B(6-(CF₃)Py)₂]⁻ (4B), this example prepared copper(I) and silver(I) complexes of t-BuNC. The copper(I) complex [Ph₂B(6-(CF₃)Py)₂]Cu(CNBu^{t}) (6B) was obtained by an arene elimination reaction between [Ph₂B(6-(CF₃)Py)₂]H (5B) and mesityl copper in the presence of t-BuNC (Scheme 2). The silver(I) analog [Ph₂B(6-(CF₃)Py)₂]Ag(CNBu^{t}) (7B) was synthesized using K[Ph₂B(6-(CF₃)Py)₂] (prepared from KH and [Ph₂B(6-(CF₃)Py)₂]H), CF₃SO₃Ag and t-BuNC. Compounds 6B and 7B are obtained as colorless, air stable crystals from their hexane solutions at −20° C. Spectroscopic data suggest the formation of the desired products. For example, the CN stretch of the metal bound t-BuNC group of these molecules was observed at 2180 and 2200 cm⁻¹, respectively, in their IR spectra which is different from, and appears at a much higher value relative to, the υ̅(CN) of free t-BuNC at 2138 cm⁻¹. Chemical shifts and peak integration values of ¹H NMR data indicated the formation of mono t-BuNC complexes. The isocyanide carbon resonance of 6B and 7B was observed at d 136.33 and 138.90 ppm, respectively in their ¹³C NMR spectra, and shows an upfield shift from the free t-BuNC (which is observed at d 153.6 ppm in CDCl₃). (Knol, D.; Koole, N. J.; de Bie, M. J. A., A ¹³C NMR investigation of some tetrakisisocyanocopper(I) tetrafluoroborate complexes: Chemical shift of, and coupling to, the isocyano carbon. Org. Magn. Reson. 1976, 8 (4), 213-218.)

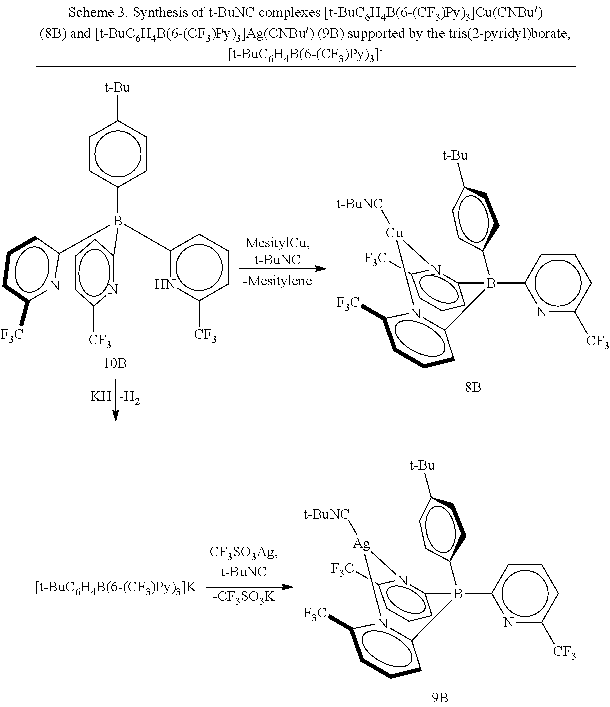

This experiment also synthesized the related metal complexes supported by the tripodal ligand relative [t-BuC₆H₄B(6-(CF₃)Py)₃]⁻ (3B) for comparisons. The copper(I) and silver(I) complexes, [t-BuC₆H₄B(6-(CF₃)Py)₃]Cu(CNBu^{t}) (8B) and [t-BuC₆H₄B(6-(CF₃)Py)₃]Ag(CNBu^{t}) (9B) were prepared following analogous methods used for 6B and 7B, but using the tris(pyridyl)borate precursor [t-BuC₆H₄B(6-(CF₃)Py)₃]H (10B) (Vanga, M.; Munoz-Castro, A.; Dias, H. V. R., Fluorinated tris(pyridyl)borate ligand support on coinage metals. Dalton Trans. 2022, 51 (4), 1308-1312) instead of [Ph₂B(6-(CF₃)Py)₂]H (5B) (Scheme 3). Compounds 8B and 9B are colorless solids and display strong bands at 2168 and 2198 cm⁻¹ in their IR spectra for the CN stretch of t-BuNC group.

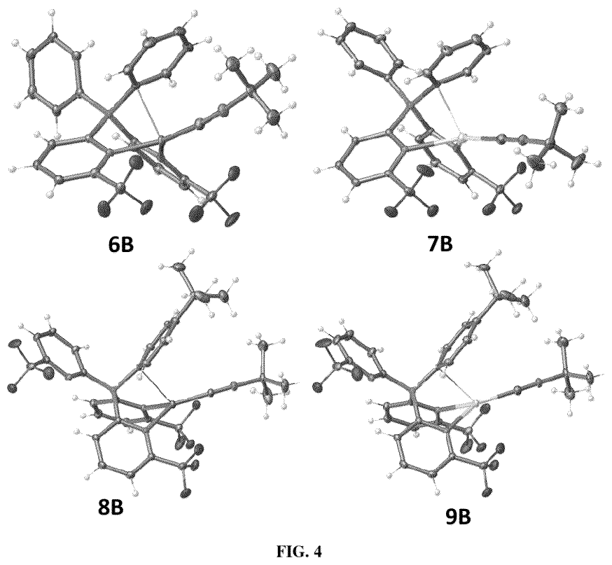

X-ray crystal structures of 6B-9B are illustrated in FIG. 4. Selected bond distances and angles are given in Table 5. The bis(pyridyl)borate ligand in [Ph₂B(6-(CF₃)Py)₂]Cu(CNBu^{t}) (6) and [Ph₂B(6-(CF₃)Py)₂]Ag(CNBu^{t}) (7B) uses both pyridyl donor-arms to chelate the metal site. In addition, one of the phenyl groups on boron sits above the metal site with somewhat close M•••C(B) separation (M=Cu and Ag) between the M and flanking phenyl group at 2.5314(12) and 2.560(2) Å. Although these distances are within Bondi's van der Waals contact separation of the Cu•••C and Ag•••C pairs (3.10 and 3.42 Å, respectively), they are much longer than the typical Cu—C(sp²) and Ag—C(sp²) covalent distances (2.05 and 2.18 Å). Cordero, B.; Gómez, V.; Platero-Prats, A. E.; Revés, M.; Echeverría, J.; Cremades, E.; Barragán, F.; Alvarez, S., Covalent radii revisited. Dalton Trans. 2008, (21), 2832-2838. The metal sites are trigonal planar or nearly planar as evident from the sum of angles at copper (359.9°) and silver (355.1°) in 6B and 7B (Table 5).

TABLE 5
Selected bond distances (Å), angles (°) of [Ph₂B(6-(CF₃)Py)₂]M(CNBu^{t}) and
[t-BuC₆H₄B(6-(CF₃)Py)₃]M(CNBu^{t}) (M = Cu, Ag). The M•••C(B) is the ipso-carbon separation between
the M and flanking phenyl group (value given in italics). Σ at M represents the sum of angles at M
involving two nitrogen atoms bonded to M and the carbon of t-BuNC.

| | Molecule | | | |
|---|---|---|---|---|
| | [Ph₂B(6- | [Ph₂B(6- | [t-BuC₆H₄B(6- | [t-BuC₆H₄B(6- |
| Parameter | (CF₃)Py)₂]Cu(CNBu^{t})(6) | (CF₃)Py)₂]Ag(CNBu^{t})(7) | (CF₃)Py)₃]Cu(CNBu^{t})(8B) | (CF₃)Py)₃]Ag(CNBu^{t})(9B) |
| C—NBu^{t} | 1.1537(17) | 1.145(4) | 1.1610(12) | 1.147(2) |
| M—CNBu^{t} | 1.8471(13) | 2.085(3) | 1.8598(9) | 2.0781(15) |
| M—N | 2.0243(10), 2.0482(10) | 2.3741(16), 2.3741(16) | 2.0495(7), 2.1175(7) | 2.4083(12), 2.3033(12) |
| M•••C(B) | 2.5314(12) | 2.560(2) | 2.4174(8) | 2.5661(13) |
| M—C—NBu^{t} | 172.81(12) | 179.6(3) | 172.30(9) | 171.32(14) |
| N—M—N | 93.34(4) | 82.11(7) | 89.63(3) | 81.41(4) |
| Σ at M | 359.9 | 355.1 | 354.8 | 354.9 |

Interestingly, the tris(pyridyl)borate complexes 8B and 9B also feature essentially trigonal planar metal sites, with the scorpionate binding to the metal centers using only two pyridyl arms. The B-aryl group, instead of the third pyridyl moiety sits above the metal sites. The same k²-mode of coordination was observed in [t-BuC₆H₄B(6-(CF₃)Py)₃]Cu(C₂H₄) and [t-BuC₆H₄B(6-(CF₃)Py)₃]Ag(C₂H₄), (Vanga, M.; Munoz-Castro, A.; Dias, H. V. R., Fluorinated tris(pyridyl)borate ligand support on coinage metals. Dalton Trans. 2022, 51 (4), 1308-1312) but they have side-on bonded ethylene ligands, unlike the end-on bonded t-BuNC. The M-N and M-CNBu^{t} bond distances are relatively longer in the silver complexes than the related distances of the copper. (Cordero, B.; Gómez, V.; Platero-Prats, A. E.; Revés, M.; Echeverría, J.; Cremades, E.; Barragán, F.; Alvarez, S., Covalent radii revisited. Dalton Trans. 2008, (21), 2832-2838)

TABLE 6
Selected, structurally characterized Cu(I)—CNBu^{t} and Ag(I)—CNBu^{t}
complexes of poly(pyridyl)borates and poly(pyrazolyl)borates and
some of their structural and spectroscopic parameters.
The υ̅(CN) of free t-BuNC = 2138 cm⁻¹.

| Complex | υ̅(CN)/cm⁻¹ | M—C/Å |
|---|---|---|
| [Ph₂B(6-(CF₃)Py)₂]Cu(CNBu^{t}) (6B) | 2180 | 1.8471(13) |
| [t-BuC₆H₄B(6-(CF₃)Py)₃]Cu(CNBu^{t}) (8B) | 2168 | 1.8598(9) |
| [HB(3,5-(CF₃)₂Pz)₃]Cu(CNBu^{t}) | 2196 | 1.827(6) |
| [H₂B(3-(NO₂)Pz)₂]Cu(CNBu^{t})₂ | 2166, 2190sh | 1.926(2) |
| | | 1.903(2) |
| [H₂B(3-(CF₃)Pz)₂]Cu(CNBu^{t})₂ | 2161, 2182sh | 1.914(2) |
| | | 1.9308(19) |
| {[H₂B(3,5-(CF₃)₂Pz)₂]Cu(CNBu^{t})}₂ | 2196 | 1.855(3) |
| [Ph₂B(6-(CF₃)Py)₂]Ag(CNBu^{t}) (7) | 2200 | 2.085(3) |
| [t-BuC₆H₄B(6-(CF₃)Py)₃]Ag(CNBu^{t}) (9B) | 2198 | 2.0781(15) |
| [HB(3,5-(CF₃)₂Pz)₃]Ag(CNBu^{t}) | 2214 | 2.059(4) |
| [HB(3,5-(CH₃)₂Pz)₃]Ag(CNBu^{t}) | 2178 | 2.05(1) |
| [HB(3,5-(Ph)₂Pz)₃]Ag(CNBu^{t}) | 2185 | 2.08(1) |

The ¹H NMR of [t-BuC₆H₄B(6-(CF₃)Py)₃]M(CNBu^{t}) (M=Cu, Ag) complexes show an averaged set of signals in solution at room temperature for the coordinated and free N-donor arms with some broadening of the pyridyl proton signals, which could be due to fast κ²- to κ³-interconversion on the NMR time scale. Interestingly, the ¹⁹F NMR spectrum of [t-BuC₆H₄B(6-(CF₃)Py)₃]Cu(CNBu^{t}) shows partially resolved peaks for CF₃-groups of the two different pyridyl arms, whereas a single ¹⁹F peak is observed for [t-BuC₆H₄B(6-(CF₃)Py)₃]Ag(CNBu^{t}) suggesting this fluxional process is relatively slower in the former adduct.

There are however, several structurally characterized bis- and tris(pyrazolyl)borato copper and silver complexes of t-BuNC available for comparisons. (Dias, H. V. R.; Wang, Z.; Jin, W., Synthesis and Chemistry of [Hydrotris(3,5-bis(trifluoromethyl)pyrazolyl)borato]silver(I) Complexes. Inorg. Chem. 1997, 36 (27), 6205-6215; Dias, H. V. R.; Jin, W., Chemistry of Trifluoromethylated Tris(pyrazolyl)borate: Synthesis and Characterization of Carbonyl and Isonitrile Adducts of Silver(I). J. Am. Chem. Soc. 1995,117 (45), 11381-11382; Dias, H. V. R.; Lu, H.-L.; Gorden, J. D.; Jin, W., Copper(I) Isocyanide Complexes of Highly Fluorinated Poly(pyrazolyl)borates. Inorg. Chem. 1996, 35 (7), 2149-51; Pellei, M.; Papini, G.; Lobbia, G. G.; Ricci, S.; Yousufuddin, M.; Dias, H. V. R.; Santini, C., Scorpionates bearing nitro substituents: mono-, bis- and tris-(3-nitro-pyrazol-1-yl)borate ligands and their copper(I) complexes. Dalton Trans. 2010, 39 (38), 8937-8944; Dias, H. V. R.; Gioia Lobbia, G.; Papini, G.; Pellei, M.; Santini, C., Copper(I) Isocyanide and Phosphane Complexes of Fluorinated Mono- and Bis(pyrazolyl)borates. Eur. J. Inorg. Chem. 2009, (26), 3935-3941; Gioia Lobbia, G.; Pettinari, C.; Santini, C.; Skelton, B. W.; White, A. H., Synthesis, structural and spectroscopic characterization of new silver(I) poly(pyrazolyl)borate complexes containing isonitrile ligands. Inorg. Chim. Acta 2000, 298 (2), 146-153.) They are all 4-coordinate metal complexes (in contrast, 6B-9B are basically three coordinate metal species). (Groom, C. R.; Bruno, I. J.; Lightfoot, M. P.; Ward, S. C., The Cambridge Structural Database. Acta Crystallogr., Sect. B Struct. Sci., Cryst. Eng. Mater. 2016, 72 (2), 171-179.) As evident from the data presented in Table 6, M-CNBu^{t} distances of the poly(pyridyl)borate and poly(pyrazolyl)borate mono-isocyanide complexes do not vary much for a given metal (Cu or Ag) despite the differences in coordination number. Furthermore, at least based on the limited data available, the scorpionate ligand donor properties have no significant effect on the Ag-CNBu^{t} distance. The CN stretching frequency however is somewhat higher for the molecules supported by weakly donating fluorinated scorpionates, which is a result of the increased Lewis acidity at the metal (e.g., 2178 and 2198 cm⁻¹ for [HB(3,5-(CH₃)₂Pz)₃]Ag(CNBu^{t}) and [t-BuC₆H₄B(6-(CF₃)Py)₃]Ag(CNBu^{t}), respectively). Also an analysis of υ̅(CN) data of 6B-9B indicates that the copper analogs 6B and 8B have relatively lower CN stretching frequencies compared to the related silver adducts 7B and 9B. This could be a result of better backbonding prowess of the copper ion in comparison to the larger relative silver(I). Elschenbroich, C., Organometallics, 3rd, Completely Revised and Extended Edition. 3rd ed.; Wiley: Weinheim, 2006; p 817 pp.) Nevertheless, they all display CN stretching frequencies clearly higher than that of the free t-BuNC (2138 cm⁻¹).

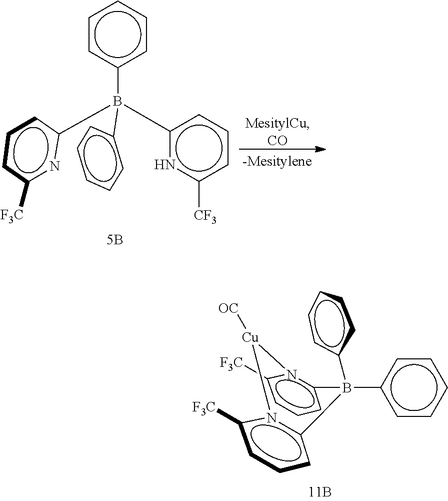

Scheme 4. Synthesis of copper(I) carbonyl complex [Ph₂B(6-(CF₃)Py)₂]Cu(CO) (11B) supported by the bis(2-pyridyl)borate [Ph₂B(6-(CF₃)Py)₃]⁻

Copper and silver carbonyl chemistry supported by the newly constructed [Ph₂B(6-(CF₃)Py)₂]⁻ and the related tripodal analog, [t-BuC₆H₄B(6-(CF₃)Py)₃]⁻ were also investigated in this work. Scorpionates are particularly useful for the stabilization of molecules with Ag(I)—CO moiety. (Dias, H. V. R.; Wang, Z.; Jin, W., Synthesis and Chemistry of [Hydrotris(3,5-bis(trifluoromethyl)pyrazolyl)borato]silver(I) Complexes. Inorg. Chem. 1997, 36 (27), 6205-6215; Gava, R.; Olmos, A.; Noverges, B.; Varea, T.; Alvarez, E.; Belderrain, T. R.; Caballero, A.; Asensio, G.; Pérez, P. J., Discovering Copper for Methane C—H Bond Functionalization. ACS Catal. 2015, 5 (6), 3726-3730; Dias, H. V. R.; Jin, W., Chemistry of Trifluoromethylated Tris(pyrazolyl)borate: Synthesis and Characterization of Carbonyl and Isonitrile Adducts of Silver(I). J. Am. Chem. Soc. 1995, 117 (45), 11381-11382; Dias, H. V. R.; Wang, X., Silver(I) carbonyl and silver(I) ethylene complexes of a B-protected fluorinated tris(pyrazolyl)borate ligand. Dalton Trans. 2005, (18), 2985-2987; Dias, H. V. R.; Fianchini, M., A classical silver carbonyl complex [{MeB[3-(Mes)pz]₃}Ag(CO)] and the related silver ethylene adduct [{MeB[3-(Mes)pz]₃}Ag(C₂H₄)]. Angew. Chem., Int. Ed. 2007, 46 (13), 2188-2191; Despagnet-Ayoub, E.; Jacob, K.; Vendier, L.; Etienne, M.; Alvarez, E.; Caballero, A.; Diaz-Requejo, M. M.; Perez, P. J., A New Perfluorinated F₂₁-Tp Scorpionate Ligand: Enhanced Alkane Functionalization by Carbene Insertion with (F₂₁-Tp)M Catalysts (M=Cu, Ag). Organometallics 2008, 27 (18), 4779-4787; Rangan, K.; Fianchini, M.; Singh, S.; Dias, H. V. R., Silver(I) complexes of fluorinated scorpionates: Ligand effects in silver catalyzed carbene insertion into C—H bonds in alkanes. Inorg. Chim. Acta 2009, 362 (12), 4347-4352; Fuentes, M. A.; Munoz, B. K.; Jacob, K.; Vendier, L.; Caballero, A.; Etienne, M.; Perez, P. J., Functionalization of Non-Activated C—H Bonds of Alkanes: An Effective and Recyclable Catalytic System Based on Fluorinated Silver Catalysts and Solvents. Chem.—Eur. J. 2013, 19 (4), 1327-1334; Jayaratna, N. B.; Gerus, I. I.; Mironets, R. V.; Mykhailiuk, P. K.; Yousufuddin, M.; Dias, H. V. R., Silver(I) and Copper(I) Adducts of a Tris(pyrazolyl)borate Decorated with Nine Trifluoromethyl Groups. Inorg. Chem. 2013, 52 (4), 1691-1693; Ridlen, S. G.; Kulkarni, N. V.; Dias, H. V. R., Partially fluorinated Scorpionate [HB(3-(CF₃),5-(Ph)Pz)₃]⁻ as a supporting ligand for silver(I)-benzene, -carbonyl, and —PPh₃ complexes. Polyhedron 2017, 125, 68-73; Kou, X.; Dias, H. V. R., Carbon monoxide and ethylene complexes of copper and silver supported by a highly fluorinated tris(triazolyl)borate. Dalton Trans. 2009, (36), 7529-7536.)

The copper(I) carbonyl complex [Ph₂B(6-(CF₃)Py)₂]Cu(CO) (11B) was synthesized by treating [Ph₂B(6-(CF₃)Py)₂]H (5B) with mesityl copper in the presence of carbon monoxide (Scheme 4). The synthesis of the silver(I) analog [Ph₂B(6-(CF₃)Py)₂]Ag(CO) (12B) was attempted using K[Ph₂B(6-(CF₃)Py)₂], CF₃SO₃Ag and CO, but the resulting product (which shows a strong IR band at 2164 cm⁻¹) could not be characterized satisfactorily thus far due to facile CO loss. The copper complex 11B is a colorless solid and does not lose bound CO easily under reduced pressure. The IR spectrum of the crystalline material shows strong bands corresponding to the CO stretch at 2110 and 2100 cm⁻¹ for 11B. The same two bands were observed in Nujol but at a different intensity ratio. The presence of two bands could be a result of having two slightly different environments for Cu—CO (as noted below, there are three crystallographically different molecules of 11B in the asymmetric unit). ¹H and ¹³C NMR of [Ph₂B(6-(CF₃)Py)₂]Cu(CO) at room temperature show one set of well resolved pyridyl proton signals and carbons and a singlet in ¹⁹F NMR peaks indicating the presence of equivalent pyridyl donor arms.

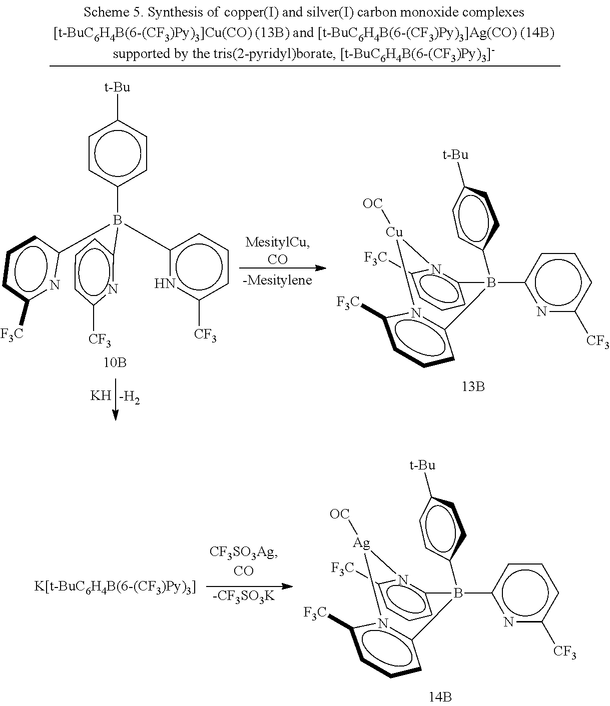

The tris(pyridyl)borate versions of copper(I) and silver(I) complexes, [t-BuC₆H₄B(6-(CF₃)Py)₃]Cu(CO) (13B) and [t-BuC₆H₄B(6-(CF₃)Py)₃]Ag(CO) (14B) were prepared following analogous methods utilized for the 8B and 9B but using CO (˜1 atm) instead of t-BuNC (Scheme 5). These compounds are obtained as colorless crystalline solids from their hexane solutions saturated with carbon monoxide at −20° C. The Cu—CO interaction in [t-BuC₆H₄B(6-(CF₃)Py)₃]Cu(CO) (13B) appears to be fairly strong, which is evidenced from the stability towards CO loss under reduced pressure, whereas [t-BuC₆H₄B(6-CF₃)Py)₃]Ag(CO) (14B) loses its CO under reduced pressure quite easily. They display typically strong bands in their IR spectra at 2103 and 2144 cm⁻¹ for the CO stretch. Note that the υ̅(CO) of 14B is essentially the same as that of the free CO, which is quite rare as the vast majority of silver-CO complexes have much higher CO frequencies.

The copper(I) complex [t-BuC₆H₄B(6-(CF₃)Py)₃]Cu(CO) (13B) shows two different sets of signals for bound and free pyridyl arms in its ¹H, ¹³C and ¹⁹F NMR spectra, at room temperature, indicating the 2-mode of coordination of the scorpionate. The NMR data [t-BuC₆H₄B(6-(CF₃)Py)₃]Ag(CO) (14B) were collected in the presence of excess CO in CDCl₃ to minimize the by-product formation due to CO loss. The ¹H NMR spectrum shows averaged and broadened signals for the pyridyl arms at room temperature. The silver bounds carbon monoxide ¹³C resonance was observed at d 176.4 ppm.

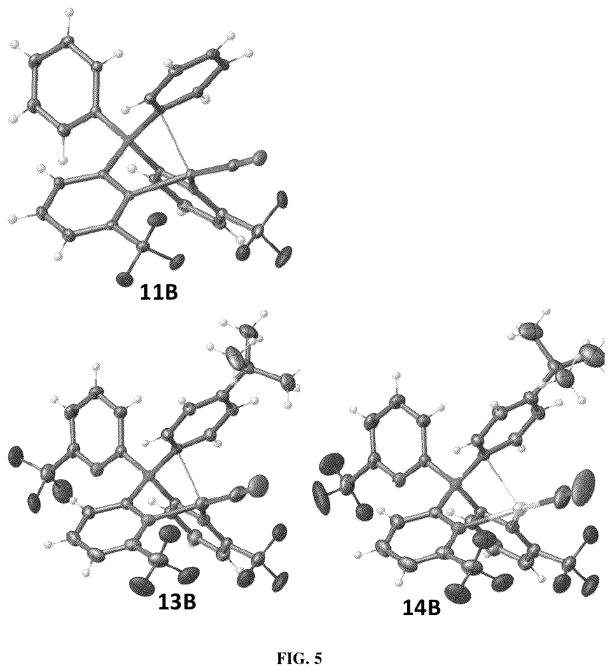

Compounds 11B, 13B and 14B produced quality crystals suitable for X-ray crystallography. The [Ph₂B(6-(CF₃)Py)₂]Cu(CO) (11B) crystallizes with three chemically similar but crystallographically different molecules in the asymmetric unit. The molecular structures of 11B, 13B and 14B are illustrated in FIG. 5. Selected bond distances and angles are given in Table 7. All three complexes feature essentially trigonal planar metal sites (e.g., sum of the angles at M involving two nitrogen atoms and carbonyl carbon deviate only very little from the ideal 360°), and 2-bound poly(pyrazolyl)borates. They have flanking B-aryl groups in close proximity to metal sites, but the closest M•••C(aryl) distances are much longer than the typical Cu—C(sp²) and Ag—C(sp²) covalent distances (2.05 and 2.18 Å). The Cu•••C(B) separation in 11B and 13B is much shorter than those found in the related isocyanide complexes. This could be a result of having a smaller ligand CO (instead of t-BuNC) on copper in 11B and 13B and reduced steric interactions with the flanking aryl groups. The difference in Ag•••C(B) distance in 14B and 9B is much smaller. Most other features, however, are similar between the analogous metal fragments with CO and t-BuNC donors (see Tables 5 and 7).

TABLE 7
Selected bond distances (Å), angles (°), and IR spectroscopic data
(carbonyl stretch in cm⁻¹) of [Ph₂B(6-(CF₃)Py)₂]M(CO) and
[t-BuC₆H₄B(6-(CF₃)Py)₃]M(CO) (M = Cu, Ag). The M•••C(B) is the
ipso-carbon separation between the M and flanking phenyl group (value
given in italics). Σ at M represents the sum of angles at M involving
two nitrogen atoms bonded to M and the carbon of CO.

| | Molecule | | |
|---|---|---|---|
| | [Ph₂B(6- | [t-BuC₆H₄B(6- | [t-BuC₆H₄B(6- |
| | (CF₃)Py)₂]Cu(CO)^{a} | (CF₃)Py)₃]Cu(CO) | (CF₃)Py)₃]Ag(CO) |
| Parameter | (11B) | (13B) | (14B) |
| C—O | 1.115(3) | 1.115(5) | 1.099(4) |
| M—C | 1.822(3) | 1.807(4) | 2.038(3) |
| M—N | 2.038(2), 2.036(2) | 2.046(3) | 2.3085(17), 2.2977(16) |
| | | 2.043(3) | |
| M•••C(B) | 2.374(2) | 2.354(3) | 2.5251(17) |
| M—C—O | 176.9(3) | 175.5(4) | 173.4(3) |
| N—M—N | 93.14(8) | 92.50(10) | 84.69(6) |
| Σ at M | 356.8 | 357.0 | 357.6 |
| υ̅(CO) | 2110, 2100 | 2103 | 2144 |

^{a}Data from only one of the three chemically similar molecules in the asymmetric unit are listed here.

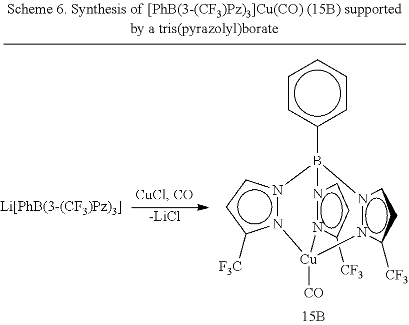

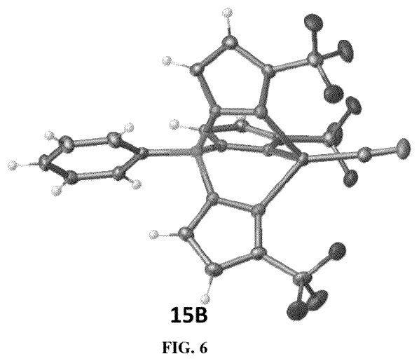

The tris(1-pyrazolyl)borate [PhB(3-(CF₃)Pz)₃]⁻ may be considered as a close relative of the “fluoroalkyl-lined” tris(2-pyridyl)borate ligand [t-BuC₆H₄B(6-(CF₃)Py)₃]⁻ (3B). (Dias, H. V. R.; Wu, J.; Wang, X.; Rangan, K., Structural Variations of Silver Ethylene Complexes Supported by Boron-Protected Fluorinated Scorpionates and the Isolation of a Ligand-Directed Silver Helix. Inorg. Chem. 2007, 46 (6), 1960-1962; Wu, J., “Coinage Metal Complexes of Alkenes and Alkynes”, Ph.D. dissertation, The University of Texas at Arlington, 2010.) Thus, to further compare those two ligand families, the study prepared the copper(I) carbonyl complex of the former. The [PhB(3-(CF₃)Pz)₃]Cu(CO) (15B) was obtained from a reaction between Li[PhB(3-(CF₃)Pz)₃] and CuCl and CO (1 atm) (Scheme 6). This molecule displays its CO stretch in the IR spectrum at 2112 cm⁻¹. The crystal structure of 15B is illustrated in FIG. 6. It is a tetrahedral copper complex. Interestingly, the tris(pyrazolyl)borate in 15B acts as a typical tripodal κ³-ligand which uses all three pyrazolyl donor arms (in contrast to 13B, which uses only two N-donors).

TABLE 8
Selected, structurally characterized Cu(I)—CO and Ag(I)—CO
complexes of poly(pyridyl)borates and poly(pyrazolyl)borates and
some of their structural and spectroscopic parameters. The υ̅(CO)
of free CO = 2143 cm⁻¹. Data for the second and
third molecule in the asymmetric unit in italics.

| Complex | υ̅(CO)/cm⁻¹ | M—C/Å |
|---|---|---|
| [Ph₂B(6-(CF₃)Py)₂]Cu(CO) (11B) | 2110, 2101 | 1.822(3) |
| | | 1.813(3) |
| | | 1.816(3) |
| [t-BuC₆H₄B(6-(CF₃)Py)₃]Cu(CO) (13B) | 2103 | 1.808(5) |
| [Ph₂B(3-(CF₃)Pz)₂]Cu(CO) | 2117 | 1.8028(16) |
| [Ph₂B(3-(SF₅)Pz)₂]Cu(CO) | 2121 | 1.803(2) |
| | | 1.807(2) |
| [PhB(3-(CF₃)Pz)₃]Cu(CO) (15B) | 2112 | 1.804(2) |
| [HB(3-(CF₃)Pz)₃]Cu(CO) | 2100 | 1.790(4) |
| [HB(3,5-(CF₃)₂Pz)₃]Cu(CO) | 2137 | 1.808(4) |
| [HB(3,5-(CH₃)₂Pz)₃]Cu(CO) | 2060 | 1.785(4) |
| [HB(3,5-(i-Pr)₂Pz)₃]Cu(CO) | 2056 | 1.769(8) |
| [t-BuC₆H₄B(6-(CF₃)Py)₃]Ag(CO) (14B) | 2144 | 2.038(3) |
| [HB(3,5-(CF₃)₂Pz)₃]Ag(CO) | 2178 | 2.037(5) |
| [MeB(3-(C₂F₅)Pz)₃]Ag(CO) | 2153 | 2.030(4) |
| [MeB(3-(Mes)Pz)₃]Ag(CO) | 2125 | 1.994(3) |

Table 8 provides a list of related scorpionate ligand supported copper and silver carbonyl complexes and some key parameters. Note that one of the reasons for investigating these Cu—CO and Ag—CO complexes 11B, 13B-15B is to probe the scorpionate ligand effects on the metal site using the CO stretch, and to compare the new poly(pyridyl)borate and better-known poly(pyrazolyl)borate systems. Computational analysis (Vanga, M.; Munoz-Castro, A.; Dias, H. V. R., Fluorinated tris(pyridyl)borate ligand support on coinage metals. Dalton Trans. 2022, 51 (4), 1308-1312; Fernández, I.; Noonikara-Poyil, A.; Dias, H. V. R., Bonding situation in isolable silver(I) carbonyl complexes of the Scorpionates. J. Comput. Chem. 2022, 43 (11), 796-803) of molecules such as [Ph₂B(3-(CF₃)Pz)₂]Cu(CO), [Ph₂B(3-(CH₃)Pz)₂]Cu(CO), [HB(3,5-(CF₃)₂Pz)₃]Ag(CO), and [MeB(3-(Mes)Pz)₃]Ag(CO) indicate that the LM and CO (L=scorpionate) is mainly electrostatic. Traditional σ-donor/π-acceptor interactions usually explained by the Dewar-Chatt-Duncanson model are also significant. Overall, the strength of the electrostatic attraction and the degree of π-backbonding between LM and CO fragments correlate well with the observed υ̅(CO), which gets higher with more weakly donating ligand support on a metal. Computational work on the above systems also shows that the copper complexes display stronger LCu→CO π-backdonation relative to their silver counterparts.

The υ̅(CO) of [Ph₂B(6-(CF₃)Py)₂]Cu(CO) (11B) and [Ph₂B(3-(CF₃)Pz)₂]Cu(CO) suggest that the former has a slightly more electron-rich metal site. Compounds 13B and 15B also provide υ̅(CO) data to support the contention that the poly(pyridyl)borates are slightly better donors relative to the related poly(pyrazolyl)borates. Keep in mind however that the coordination modes are very different in 13B and 15B making this latter comparison less reliable. The computed proton affinities of [PhB(6-(CF₃)Py)₃]⁻ and [PhB(3-(CF₃)Pz)₃]⁻ are 1120.0 and 1069.2 kJ/mol, respectively, indicate that the pyridyl-borate analog is a better donor. Among the reported silver-carbonyl complexes, the [MeB(3-(C₂F₅)Pz)₃]Ag(CO) is perhaps the closest relative of [t-BuC₆H₄B(6-(CF₃)Py)₃]Ag(CO) (14B). Compound 14B has a slightly lower CO stretch value, suggesting that its metal site is less Lewis acidic, perhaps due to slightly better donor feature of [t-BuC₆H₄B(6-(CF₃)Py)₃]⁻ ligand. Unfortunately, these silver(I) complexes also feature different coordination modes (i.e., κ³ and κ²) of the scorpionate. Overall, more closely related systems from two scorpionate ligand families are needed for a better comparison of, and to reach a solid conclusion on, ligand donor features.

The data presented in Table 8 show that molecules with weakly donating supporting ligands have slightly longer M-CO distances, but esds associated with the measurement overshadows the differences when ligand donor properties are similar. The Cu—CO distances are clearly longer than the Ag—CO bond distances, because the latter involves a metal ion with a larger covalent radius. The longer distances in Ag—CO bonds could also contribute to the lower Ag→CO back bonding, resulting in higher υ̅(CO) values.

### Conclusions

A new, chemically robust, bis(2-pyridyl)borate [Ph₂B(6-(CF₃)Py)₂]⁻ with fluoro-alkyl groups adjacent to the metal coordination pocket has been synthesized and utilized as a ligand support for copper(I) and silver(I) ions containing t-BuNC and carbon monoxide donors. Related molecules involving a tris(2-pyridyl)borate were also investigated. These poly(pyridyl)borate metal complexes, including those with three pyridyl donor arms, use only two pyridyl moieties for metal ion coordination, and feature trigonal planar geometry at the metal. The tris(pyrazolyl)borate [PhB(3-(CF₃)Pz)₃]Cu(CO) in contrast acts as a κ³-donor, generating a tetrahedral copper site. Flanking B-aryl groups close to metal sites are also a common feature in copper and silver complexes supported by [Ph₂B(6-(CF₃)Py)₂]⁻ and [t-BuC₆H₄B(6-(CF₃)Py)₃]⁻. Isolable carbonyl complexes of silver(I) such as [t-BuC₆H₄B(6-(CF₃)Py)₃]Ag(CO) stabilized here are rare among metal carbonyls. The CN stretching frequencies of fluorinated poly(2-pyridyl)borate supported t-BuNC complexes of Cu(I) and Ag(I) are notably higher than that of the free t-BuNC. The CO stretch of the analogous metal carbonyls lies closer to that of the free CO, indicating the presence of fairly Lewis acidic metal sites. The CO stretching frequencies suggest that poly(pyridyl)borates are slightly better donors relative to the related poly(pyrazolyl)borates.

### Experimental Methods

All preparations and manipulations were carried out under an atmosphere of purified nitrogen using standard Schlenk techniques or in a MBraun drybox equipped with a −25° C. refrigerator. Commercially available solvents were purified and dried by standard methods. Glassware was oven dried overnight at 150° C. NMR spectra were acquired at 25° C., on a JEOL Eclipse 500 spectrometer (¹H, 500 MHz; ¹³C, 126 MHz; ¹⁹F, 471 MHz). ¹⁹F NMR values were referenced to external CFCl₃. ¹H and ¹³C{¹H} NMR spectra were referenced internally to solvent signals (CDCl₃: 7.26 ppm for ¹H NMR, 77.16 ppm for ¹³C NMR; DMSO-d₆: 2.50 ppm for ¹H NMR, 39.52 ppm for ¹³C NMR), or externally to SiMe₄ (0 ppm). ¹H NMR chemical shifts are reported in ppm and coupling constants (J) are reported in Hertz (Hz). Abbreviations used for signal assignments: Ph=phenyl, Py=pyridyl, Pyⁿ=non-coordinated pyridine, s=singlet, d=doublet, t=triplet, q=quartet, dd=doublet of doublets, m=multiplet, brs=broad singlet. NMR solvents were purchased from Cambridge Isotopes Laboratories and used as received. Carbon monoxide (UHP grade) gas was purchased from Airgas. Elemental analyses were performed using a Perkin-Elmer Model 2400 CHN analyzer. Bromodiphenylborane, mesityl copper, [t-BuC₆H₄B(6-(CF₃)Py)₃]H (10B), K[t-BuC₆H₄B(6-(CF₃)Py)₃], {(6-(CF₃)-2-Py)MgCl}₂(THF)₃, Li[PhB(3-(CF₃)Pz)₃] were prepared according to literature procedures. (Ohashi, M.; Adachi, T.; Ishida, N.; Kikushima, K.; Ogoshi, S., Synthesis and Reactivity of Fluoroalkyl Copper Complexes by the Oxycupration of Tetrafluoroethylene. Angew. Chem., Int. Ed. 2017, 56 (39), 11911-11915; Meyer, E. M.; Gambarotta, S.; Floriani, C.; Chiesi-Villa, A.; Guastini, C., Polynuclear aryl derivatives of Group 11 metals. Synthesis, solid state-solution structural relationship, and reactivity with phosphines. Organometallics 1989, 8 (4), 1067-1079; Dias, H. V. R.; Wu, J.; Wang, X.; Rangan, K., Structural Variations of Silver Ethylene Complexes Supported by Boron-Protected Fluorinated Scorpionates and the Isolation of a Ligand-Directed Silver Helix. Inorg. Chem. 2007, 46 (6), 1960-1962.) All other reagents were obtained from commercial sources and used as received. Silver complexes were prepared in reaction vessels protected from light using aluminum foil.

Synthesis of [Ph₂B(6-(CF₃)Py)₂]H (5B)

Bromodiphenylborane (2.50 g, 10.21 mmol) in CH₂Cl₂ (25 mL) was added dropwise to a solution of {(6-(CF₃)-2-Py)MgCl}₂·(THF)₃ (7.05 g, 14.23 mmol) in CH₂Cl₂ (40 mL) at 0° C. The resulting dark red mixture was slowly warmed to room temperature and kept stirring for 48 h. The reaction mixture was then poured into an aqueous Na₂CO₃ solution (14.0 g in 120 mL H₂O) and stirred for 1 h, and then extracted with CH₂Cl₂ (3×30 mL). The organic extracts were combined, washed with brine, dried over Na₂SO₄ and evaporated to dryness. The residue dissolved in CH₂Cl₂ (50 mL), activated charcoal was added and then filtered through small pad of celite and evaporated to dryness. The resulting residue was recrystallized from acetone to obtain the desired [Ph₂B(6-(CF₃)Py)₂]H as white crystalline solid. Yield: 4.20 g (90%). Anal. Calc. C₂₄H₁₇B₁F₆N₂: C, 62.91; H, 3.74; N, 6.11%. Found: C, 62.04; H, 3.65; N, 5.75. ¹H NMR (500 MHz, CDCl₃): δ=19.91 (s, 1H, NH), 7.87 (d, J=8.0 Hz, 2H, Py), 7.81 (t, J=7.8 Hz, 2H, Py), 7.60 (dd, J=7.5, 1.0 Hz, 2H, Py), 7.27-7.15 (m, 10H, Ph). ¹³C NMR (126 MHz, CDCl₃): δ=188.79 (q, ¹J_{C-B}=51.6 Hz, Py), 154.82 (q, ¹J_{C-B}=52.8 Hz, Ph), 140.27 (q, ²J_{C-F}=37.2 Hz, Py), 137.89 (Py), 135.94 (Py), 134.89 (Ph), 127.53 (Ph), 125.07 (Ph), 121.02 (q, ¹J_{C-F}=274.7 Hz, CF₃), 117.63 (Py). ¹⁹F NMR (471 MHz, CDCl₃): δ=−66.83 (s).

Synthesis of [Ph₂B(6-(CF₃)Py)₂]Cu(CNBu^{t}) (6B)

To a mixture of [Ph₂B(6-(CF₃)Py)₂]H (130 mg, 284 μmol) and mesityl copper (57 mg, 312 μmol) in a 50 mL Schlenk flask were added anhydrous toluene (15 mL) and t-BuNC (0.34 mL, 1.1 M in toluene, 369 μmol) under inert atmosphere and kept stirring for 3 h. The solvent was then removed at reduced pressure, and the compound was recrystallized from hexane at −20° C. to obtain colorless X-ray quality single crystals of [Ph₂B(6-(CF₃)Py)₂]Cu(CNBu^{t}). Yield: 125 mg (77%). Anal. Calc. C₂₉H₂₅B₁Cu₁F₆N₃: C, 57.68; H, 4.17; N, 6.96%. Found: C, 57.43; H, 4.07; N, 6.69%. ¹H NMR (500 MHz, CDCl₃): δ=7.99 (d, J=7.8 Hz, 2H, Py), 7.61 (t, J=7.8 Hz, 2H, Py), 7.45 (dd, J=7.7, 1.1 Hz, 2H, Py), 7.24-7.18 (m, 6H, Ph), 6.97 (brs, 4H, Ph), 1.38 (s, 9H, CH₃). ¹³C NMR (126 MHz, CDCl₃): δ=187.19 (q, ¹J_{C-B}=51.6 Hz, Py), 153.78 (q, ¹J_{C-B}=49.2 Hz, Ph), 145.54 (q, ²J_{C-F}=33.6 Hz, Py), 137.13 (Ph), 136.33 (CN), 134.95 (Py), 133.02 (Py), 127.07 (Ph), 124.85 (Ph), 122.03 (q, ¹J_{C-F}=273.5 Hz, CF₃), 116.80 (Py), 55.48 (C—CH₃), 30.45 (CH₃). ¹⁹F NMR (471 MHz, CDCl₃): δ=−66.82. ATR-IR (single crystals, selected peaks, cm⁻¹): 2178 (CN stretch).

Synthesis of K[Ph₂B(6-(CF₃)Py)₂]

To a suspension of KH (0.26 g, 6.55 mmol) in anhydrous THE (25 mL) at 0° C. was slowly added a solution of [Ph₂B(6-(CF₃)Py)₂]H (2.00 g, 4.36 mmol) in THE (25 mL). After complete ceasing of hydrogen gas evolution, the reaction mixture was allowed to warm to room temperature and then kept stirring for 12 h. The solution was filtered through a celite packed frit to remove unreacted KH. The solvent in the filtrate collected was removed under reduced pressure to obtain K[Ph₂B(6-(CF₃)Py)₂] as a white solid. The compound was further dried at 90° C. for 6 h under reduced pressure to remove all trace solvent. Yield: 2.00 (92%). This was used directly in the next steps. ¹H NMR (500 MHz, DMSO-d₆): δ=7.46 (t, J=7.7 Hz, 2H, Py), 7.40 (d, J=7.8 Hz, 2H, Py), 7.28 (d, J=7.4 Hz, 2H, Py), 7.24 (brs, 4H, Ph), 6.96 (t, J=7.4 Hz, 4H, Ph), 6.86 (t, J=7.2 Hz, 2H, Ph). ¹³C NMR (126 MHz, MHz, DMSO-d₆): δ=189.52 (q, ¹J_{C-B}=53.9 Hz, Py), 161.10 (q, ¹J_{C-B}=50.4 Hz, Ph), 140.39 (q, ²J_{C-F}=28.8 Hz, Py), 135.43 (Py/Ph), 132.58 (Py/Ph), 125.56 (Py/Ph), 122.26 (Py/Ph), 122.85 (q, ¹J_{C-F}=274.7 Hz, CF₃), 113.84 (Py/Ph). ¹⁹F NMR (471 MHz, DMSO-d₆): δ=−66.12.

Synthesis of [Ph₂B(6-(CF₃)Py)₂]Ag(CNBu^{t}) (7B)

To a mixture of of K[Ph₂B(6-(CF₃)Py)₂] (130 mg, 209 μmol) and AgOTf (56 mg, 219 μmol) in a 50 mL Schlenk flask, covered with aluminum foil were added anhydrous dichloromethane (20 mL) and t-BuNC (0.38 mL, 1.0 M in toluene, 418 μmol) under inert atmosphere, kept stirring for 3 h. The reaction mixture was then cannula filtered through a celite packed frit to remove KOTf. The solvent was then removed reduced pressure and the compound was recrystallized from hexane at −20° C. to obtain colorless X-ray quality single crystals of [Ph₂B(6-(CF₃)Py)₂]Ag(CNBu^{t}). Yield: 140 mg (86%). Anal. Calc. C₂₉H₂₅Ag₁B₁F₆N3: C, 53.74; H, 3.89; N, 6.48%. Found: C, 53.18; H, 3.80; N, 6.29%. ¹H NMR (500 MHz, CDCl₃): δ=8.05 (d, J=7.9 Hz, 2H, Py), 7.56 (t, J=7.8 Hz, 2H, Py), 7.39 (dd, J=7.7, 1.1 Hz, 2H, Py), 7.25-7.22 (m, 4H, Ph), 7.18-7.04 (m, 6H, Ph), 1.47 (s, 9H, CH₃). ¹³C NMR (126 MHz, CDCl₃): δ=187.70 (q, ¹J_{C-B}=49.2 Hz, Py), 154.65 (q, ¹J_{C-B}=50.4 Hz, Ph), 146.17 (q, ²J_{C-F}=32.4 Hz, Py), 138.90 (CN), 136.28 (Ph), 134.84 (Py), 133.26 (Py), 127.18 (Ph), 124.45 (Ph), 122.15 (q, ¹J_{C-F}=274.7 Hz, CF₃), 116.06 (Py), 56.65 (C—CH₃), 30.28 (CH₃). ¹⁹F NMR (471 MHz, CDCl₃): δ=−67.65. ATR-IR (single crystals, selected peaks, cm⁻¹): 2200 (CN stretch).

Synthesis of [t-BuC₆H₄B(6-(CF₃)Py)₃]Cu(CNBu^{t}) (8B)

To a mixture of [t-BuC₆H₄B{2-(6-(CF₃)Py)}₃]H (0.13 g, 223 μmol) and mesityl copper (45 mg, 245 μmol) in a 50 ml Schlenk flask were added anhydrous toluene (15 mL) and t-BuNC (0.67 mL, 1.0 M in toluene, 670 μmol) under inert atmosphere and kept stirring for 3 h. The solvent was then removed reduced pressure, and the compound was recrystallized from hexane at −20° C. to obtain colorless X-ray quality single crystals of [t-BuC₆H₄B(6-(CF₃)Py)₃]Cu(CNBu^{t}). Yield: 125 mg (77%). Anal. Calc. C₃₃H₃₁B₁Cu₁F₉N₄: C, 54.37%; H, 4.29%; N, 7.69%. Found: C, 53.91%; H, 4.38%; N, 7.33%. ¹H NMR (500 MHz, CDCl₃): δ=8.00 (brs, 3H, Py), 7.57 (t, J=7.3 Hz, 3H, Py), 7.42 (dd, J=7.8, 1.0 Hz, 3H, Py), 7.24 (d, J=8.1 Hz, 2H, Ph), 6.80 (s, 2H, Ph), 1.40 (s, 9H, CH₃^{tBuNC}), 1.35 (s, 9H, CH₃^{tBuPh})¹³C NMR (126 MHz, CDCl₃): δ=185.30 (brs, Py_{C-B}), 148.72 (Ph), 145.78 (brs, CCF₃), 137.37 (Ph), 135.15 (Py), 132.71 (Py), 122.28 (q, ¹J_{C-F}=274.7 Hz, CF₃), 124.23 (Ph), 116.52 (Py), 55.65 (C—CH₃^{tBuNC}), 34.48 (C—CH₃^{tBuPh}), 31.78 (CH₃^{tBuPh}), 30.43 (CH₃^{tBuNC}), Ph_{C-B} not observed, Cu—CN not observed. ¹⁹F NMR NMR (471 MHz, CDCl₃): δ=−66.71 (br), −67.77 (br). ATR-IR (single crystals, selected peaks, cm⁻¹): 2168 (CN stretch).

Synthesis of [t-BuC₆H₄B(6-(CF₃)Py)₃]Ag(CNBu^{t}) (9B)

To a mixture of of K[t-BuC₆H₄B(6-(CF₃)Py)₃] (130 mg, 209 μmol) and AgOTf (56 mg, 219 μmol) in a 50 ml Schlenk flask, covered with aluminum foil were added anhydrous dichloromethane (20 mL) and t-BuNC (0.63 mL, 1.0 M in toluene, 630 μmol) under inert atmosphere, kept stirring for 3 h. The reaction mixture was then cannula filtered through a celite packed frit to remove KOTf. The solvent was then removed at reduced pressure and the compound was recrystallized from hexane at −20° C. to obtain colorless X-ray quality single crystals of [t-BuC₆H₄B(6-(CF₃)Py)₃]Ag(CNBu^{t}). Yield: 135 mg (83%). Anal. Calc. C₃₃H₃₁Ag₁B₁F₉N4: C, 51.26%; H, 4.04%; N, 7.25%. Found: C, 50.90%; H, 3.99%; N, 6.89%. ¹H NMR (500 MHz, CDCl₃): δ=7.76 (brs, 3H, Py), 7.52 (t, J=7.8 Hz, 3H, Py), 7.37 (dd, J=7.7, 1.1 Hz, 3H, Py), 7.28 (d, J=8.2 Hz, 2H, Ph), 6.91 (brs, 2H, Ph), 1.46 (s, 9H, CH₃^{tBuNC}) 1.33 (s, 9H, CH₃^{tBuPh})¹³C NMR (126 MHz, CDCl₃): δ=184.93 (q, ¹J_{C-B}=57.6 Hz, Py), 147.93 (Ph), 147.42 (q, ¹J_{C-B}=40.8 Hz, Ph), 145.94 (q, ²J_{C-F}=28.8 Hz, Py), 139.87 (CN), 136.30 (Ph), 134.93 (Py), 132.88 (Py), 124.52 (Ph), 122.40 (q, ¹J_{C-F}=273.5 Hz, CF₃), 115.90 (Py), 56.67 (C—CH₃^{tBuNC}), 34.45 (C—CH₃^{tBuPh}), 31.64 (CH₃^{tBuPh}), 30.30 (CH₃^{tBuNC}). ¹⁹F NMR (471 MHz, CDCl₃): δ=−67.29. ATR-IR (single crystals, selected peaks, cm⁻¹): 2198 (CN stretch).

Synthesis of [Ph₂B(6-(CF₃)Py)₂]Cu(CO) (11B)

To a mixture of [Ph₂B(6-(CF₃)Py)₂]H (130 mg, 284 μmol) and mesityl copper (57 mg, 312 μmol) was added anhydrous toluene and then bubbled with carbon monoxide. The reaction mixture was kept stirring for 3 h and then solvent was removed reduced pressure.

The resulted compound was dissolved in carbon monoxide saturated hexane and kept at −20° C. freezer overnight to get X-ray quality colorless crystals of [Ph₂B(6-(CF₃)Py)₂]Cu(CO). Yield: 105 mg (67%). Anal. Calc. C₂₅H₁₆B₁Cu₁F₆N₂O₁: C, 54.72; H, 2.94; N, 5.10%. Found: C, 54.13; H, 2.84; N, 4.79%. ¹H NMR (500 MHz, CDCl₃): δ=8.10 (d, J=7.8 Hz, 2H, Py), 7.69 (t, J=7.8 Hz, 2H, Py), 7.51 (dd, J=7.7, 1.3 Hz, 2H, Py), 7.27 (br, 8H, Ph), 6.80 (brs, 2H, Ph). ¹³C NMR (126 MHz, CDCl₃): δ=186.94 (q, ¹J_{C-B}=49.2 Hz, Py), 170.36 (CO), 152.54 (br, Ph_{C-B}), 145.58 (q, ²J_{C-F}=33.6 Hz, Py), 138.85 (Ph), 136.01 (Py), 133.15 (Py), 127.59 (Ph), 126.69 (Ph), 122.80 (q, ¹J_{C-F}=274.7 Hz, CF₃), 117.27 (Py). ¹⁹F NMR (471 MHz, CDCl₃): δ=−67.19 (s). ATR-IR (single crystals, selected peaks, cm⁻¹): 2110 (C—O stretch), 2100 (C—O stretch); samples in Nujol: 2111 (C—O stretch), 2101 (C—O stretch).

Synthesis of [t-BuC₆H₄B(6-(CF₃)Py)₃]Cu(CO) (13B)

To a mixture of [t-BuC₆H₄B{2-(6-(CF₃)Py)}₃]H (100 mg, 171 μmol) and mesityl copper (35 mg, 282 μmol) was added anhydrous toluene and then bubbled with carbon monoxide. The reaction mixture was kept stirring for 3 h and then solvent was removed reduced pressure. The resulted compound was dissolved in carbon monoxide saturated hexane and kept at −20° C. freezer overnight to get X-ray quality colorless crystals of [t-BuC₆H₄B{2-(6-(CF₃)Py)}₃]Cu(CO). Yield: 90 mg (78%). Anal. Calc. C₂₉H₂₂B₁Cu₁F₉N₃O₁: C, 51.69%; H, 3.29%; N, 6.24%. Found: C, 51.56%; H, 3.24%; N, 6.07%. ¹H NMR (500 MHz, CDCl₃): δ=8.15 (d, J=7.8 Hz, 2H, Py), 7.68 (t, J=7.8 Hz, 2H, Py), 7.55 (t, J=7.7 Hz, 1H, Pyⁿ), 7.47 (two overlapped doublets, 2H, Py; 1H, Pyⁿ), 7.34 (d, J=8.0 Hz, 2H, Py), 6.86 (brs, 3H, Py; 1H Pyⁿ), 1.34 (s, 9H, CH₃). ¹³C NMR (126 MHz, CDCl₃): δ=185.48 (q, ¹J_{C-B}=51.6 Hz, Py), 180.42 (q, ¹J_{C-B}=72.0 Hz, Pyⁿ), 170.46 (CO), 150.85 (Ph), 146.66 (q, ²J_{C-F}=35.6 Hz, Pyⁿ), 145.36 (q, ²J_{C-F}=34.8 Hz, Py), 144.40 (q, ¹J_{C-B}=49.2 Hz, Ph), 138.58 (Ph), 136.34 (Py), 135.22 (Pyⁿ), 133.05 (Py), 132.50 (Pyⁿ), 125.03 (Ph), 122.76 (q, ¹J_{C-F}=274.7 Hz, CF₃-Pyⁿ), 121.81 (q, ¹J_{C-F}=273.5 Hz, CF₃-Py), 117.28 (Py), 116.00 (Pyⁿ), 34.62 (C—CH₃), 31.59 (CH₃). ¹⁹F NMR NMR (471 MHz, CDCl₃): δ=−67.26 (s, 6F, CF₃—Py), −67.96 (s, 3F, CF₃—Pyⁿ). ATR-IR (single crystals, selected peaks, cm⁻¹): 2103 (C—O stretch).

Synthesis of [t-BuC₆H₄B(6-(CF₃)Py)₃]Ag(CO) (14B)

To a mixture of K[t-BuC₆H₄B{2-(6-(CF₃)Py)}₃] (100 mg, 161 μmol) and AgOTf (43 mg, 169 mmol) in a 50 mL Schlenk flask, covered with aluminum foil was added anhydrous dichloromethane and then bubbled with carbon monoxide. The reaction mixture was kept stirring for 3 h then cannula filtered through a celite packed frit to remove KOTf. The solvent was then removed reduced pressure and the compound was recrystallized from carbon monoxide saturated hexane at −20° C. to obtain colorless X-ray quality single crystals of [t-BuC₆H₄B{2-(6-(CF₃)Py)}₃]Ag(CO). Yield: 90 mg (78%). The CO loss is facile too facile to dry the sample for CHN analysis. ATR-IR (single crystals, selected peaks, cm⁻¹): 2144 (C—O stretch). ¹H NMR (500 MHz, CDCl₃): δ=8.27 (brs, 3H, Py), 7.58 (brs, 3H, Py), 7.42 (d, J=7.7 Hz, 3H, Py), 7.36 (d, J=8.1 Hz, 2H, Ph), 6.94 (br, 2H, Ph), 1.34 (s, 9H, CH₃). ¹⁹F NMR (471 MHz, CDCl₃): δ=−67.75 (s). ¹³C NMR (126 MHz, CDCl₃, selected peaks): δ=176.4 (CO).

Synthesis of [PhB(3-(CF₃)Pz)₃]Cu(CO) (15B)

Li[PhB(3-(CF₃)Pz₃)] (0.26 g, 0.520 mmol) and CuCl (0.06 g, 0.6 mmol) were mixed in a Schlenk tube filled with 20 mL of degassed CH₂Cl₂ at room temperature. This mixture stirred for about 1 h at CO atmosphere and was filtered. The solvent was removed from the filtrate under reduced pressure to obtain the product as a grayish-white powder with a yield of 90%. It was recrystallized from hexane/CH₂Cl₂ to obtain colorless crystal of [PhB(3-(CF₃)Pz)₃]CuCO. Anal. Calc. for C₁₉H₁₄BCuF₉N₆O: C, 38.83; H, 2.40; N, 14.30%. Found: C, 38.51; H, 2.10; N, 13.82. ¹H NMR (500 MHz, CDCl₃): δ 7.87 (br, 3H, Pz-H), 7.55 (br, 5H, Ph-H), 6.46 (s, 3H, Pz-H). ¹⁹F NMR (471 MHz, CDCl₃): δ −60.9 (s, CF₃). ATR-IR (selected peaks, cm⁻¹): 2112 (C—O stretch).

X-ray Data Collection and Structure Determinations. A suitable crystal covered with a layer of hydrocarbon/Paratone-N oil was selected and mounted on a Cryo-loop, and immediately placed in the low-temperature nitrogen stream. The X-ray intensity data of [Ph₂B(6-(CF₃)Py)₂]Cu(CNBu^{t}) (6B), [Ph₂B(6-(CF₃)Py)₂]Ag(CNBu^{t}) (7B), [t-BuC₆H₄B(6-(CF₃)Py)₃]Ag(CNBu^{t}) (9B), [Ph₂B(6-(CF₃)Py)₂]Cu(CO) (11B), [t-BuC₆H₄B(6-(CF₃)Py)₃]Ag(CO) (14B), and [PhB(3-(CF₃)Pz)₃]Cu(CO) (15B) were on a Bruker instrument with Smart ApexII detector, while the data of [t-BuC₆H₄B(6-(CF₃)Py)₃]Cu(CNBu^{t}) (8B) and [t-BuC₆H₄B(6-(CF₃)Py)₃]Cu(CO) (13B) were collected on a Bruker D8 Quest with a PHOTON II 7 CPAD detector. Both instruments were equipped with an Oxford Cryosystems 700 series cooler, a graphite monochromator, and a Mo Ku fine-focus sealed tube (λ=0.71073 Å). Intensity data were processed using the Bruker Apex program suite. Data were collected at 100(2) K (except the data of 13B and 14B at 200(2) K and 150(2) K, respectively, due to crystal cracking issues). Absorption corrections were applied by using SADABS for all except, for which TWINABS was used. (Bruker Apex3 software suite. Bruker AXS Inc.: Madison, WI, USA, 2020.) Compound 13B shows non-merohedral twinning (over two domains), which was resolved satisfactorily using Cell_Now. Initial atomic positions were located by SHELXT (Sheldrick, G., SHELXT—Integrated space-group and crystal-structure determination. Acta Crystallogr. Sect. A: Found. Adv. 2015, 71 (1), 3-8), and the structures of the compounds were refined by the least-squares method using SHELXL (Sheldrick, G., Crystal structure refinement with SHELXL. Acta Crystallogr. Sect. C: Struct. Chem. 2015, 71 (1), 3-8) within Olex2 GUI (Dolomanov, O. V.; Bourhis, L. J.; Gildea, R. J.; Howard, J. A. K.; Puschmann, H., OLEX2: a complete structure solution, refinement and analysis program. J. Appl. Crystallogr. 2009, 42 (2), 339-341). All the non-hydrogen atoms were refined anisotropically. The remaining hydrogen atoms were included in their calculated positions and refined as riding on the atoms to which they are joined. Compound 11B crystallizes in P −1 space group with three chemically identical molecules in the asymmetric unit. Molecules of 7 sit on a mirror plane containing Ag, B and t-BuNC moieties. X-ray structural figures were generated using Olex2. (Dolomanov, O. V.; Bourhis, L. J.; Gildea, R. J.; Howard, J. A. K.; Puschmann, H., OLEX2: a complete structure solution, refinement and analysis program. J. Appl. Crystallogr. 2009, 42 (2), 339-341.)

### Example 3: Copper(I), Silver(I), and Gold(I) Ethylene Complexes of Fluorinated and Boron-Methylated Bis- and Tris(Pyridyl)Borate Chelators

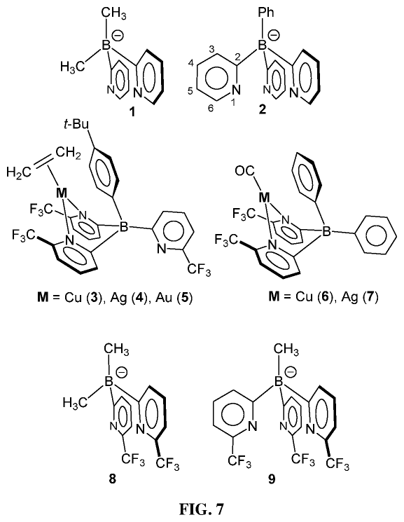

These poly(pyridyl)borates have several attractive features over the better-known poly(pyrazolyl)borates as they have more thermally stable B—C linkages (compared to the relatively polar B—N linkages of the latter), four-substitutable positions on pyridyl groups (vs three on pyrazolyl moieties), a closer proximity of the heterocyclic ring substituent to the metal site, and are believed to be better σ-donor ligands. (awar, G. M.; Sheridan, J. B.; Jäkle, F., Pyridylborates as a New Type of Robust Scorpionate Ligand: From Metal Complexes to Polymeric Materials. Eur. J. Inorg. Chem. 2016, 2016 (15-16), 2227-2235.) Despite several emerging applications, the reported poly(pyridyl)borates were limited to the parent systems based on unsubstituted pyridyl moieties (e.g., ([Me₂B(Py)₂]⁻ (1), ([PhB(Py)₃]⁻ (2)) until recently. Example 1 discusses the first tris(pyridyl)borate ligands with substituents at the 6-position of the pyridyl arms (see FIG. 7 for labeling scheme). The tert-butylphenyltris(6-trifluoromethyl-2-pyridyl)borate ([t-BuC₆H₄B(6-(CF₃)Py)₃]⁻) serves as an excellent ligand support for the stabilization of coinage metal ethylene complexes ([t-BuC₆H₄B(6-(CF₃)Py)₃]M(C₂H₄), M=Cu(I), Ag(I), and Au(I), (3-5)). (Vanga, M.; Munoz-Castro, A.; Dias, H. V. R., Fluorinated tris(pyridyl)borate ligand support on coinage metals. Dalton Trans. 2022, 51 (4), 1308-1312.) Diphenylbis(6-trifluoromethyl-2-pyridyl)borate ([Ph₂B(6-(CF₃)Py)₂]⁻) is described, and utilized to probe copper(I) and silver(I) carbon monoxide (e.g., 6-7) and tert-butyl isocyanide chemistry. (Vanga, M.; Noonikara-Poyil, A.; Wu, J.; Dias, H.

V. R., Carbonyl and Isocyanide Complexes of Copper and Silver Supported by Fluorinated Poly(pyridyl)borates. Organometallics 2022, 41 (10), 1249-1260.) Apart from these fluorinated poly(pyridyl)borates, there have been two recent studies on poly(pyridyl)borates bearing substituents on the pyridyl moieties. They include the work by Hikichi and co-workers on phenyltris(6-methyl-2-pyridyl)borate ([PhB(6-(CH₃)Py)₃]⁻) ligand and the use of its nickel(II) complexes in cyclohexane oxidation, as well as by Comito et al. on iso-propyl-, tert-butyl-, and mesityl-substituted phenyltris(pyridyl)borates ([PhB(6-(R)Py)₃]⁻, R=i-Pr, t-Bu, Mes), and their application in metal mediated ring-opening polymerization of lactones. Such poly(pyridyl)borate ligands with substituents at the 6-position of the pyridyl arms are quite useful as they feature larger cone-angles and are less likely to generate bis-poly(pyridyl)borate metal complexes.

The synthesis of the first B-methylated bis- and tris-(pyridyl)borate ligands bearing substituents on the pyridyl ring 6-positions ([Me₂B(6-(CF₃)Py)₂]⁻ (8) and [MeB(6-(CF₃)Py)₃]⁻ (9)), and their use in the stabilization of coinage metal-ethylene complexes. Isolable ethylene complexes are increasingly rare for heavier Ag and Au, and the number of isostructural copper(I), silver(I), and gold(I) complexes of ethylene available for the study of group 11 trends are also limited in number. (Wu, J.; Noonikara-Poyil, A.; Munoz-Castro, A.; Dias, H. V. R., Gold(I) ethylene complexes supported by electron-rich scorpionates. Chem. Commun. 2021, 57 (8), 978-981; Dias, H. V. R.; Lovely, C. J., Carbonyl and Olefin Adducts of Coinage Metals Supported by Poly(pyrazolyl)borate and Poly(pyrazolyl)alkane Ligands and Silver Mediated Atom Transfer Reactions. Chem. Rev. 2008, 108 (8), 3223-3238; Dias, H. V. R.; Wu, J., Thermally Stable Gold(I) Ethylene Adducts: [(HB{3,5-(CF₃)₂Pz}₃)Au(CH₂CH₂)] and [(HB{3-(CF₃),5-(Ph)Pz}₃)Au(CH₂CH₂)]. Angew. Chem. Int. Ed. 2007, 46 (41), 7814-7816; Dias, H. V. R.; Wu, J., Structurally Similar, Thermally Stable Copper(I), Silver(I), and Gold(I) Ethylene Complexes Supported by a Fluorinated Scorpionate. Organometallics 2012, 31 (4), 1511-1517; Mehara, J.; Watson, B. T.; Noonikara-Poyil, A.; Zacharias, A. O.; Roithová, J.; Rasika Dias, H. V., Binding Interactions in Copper, Silver and Gold π-Complexes. Chem. Eur. J. 2022, 28 (13), e202103984.) That is notable considering the important roles played by coinage metals in several key applications involving ethylene.

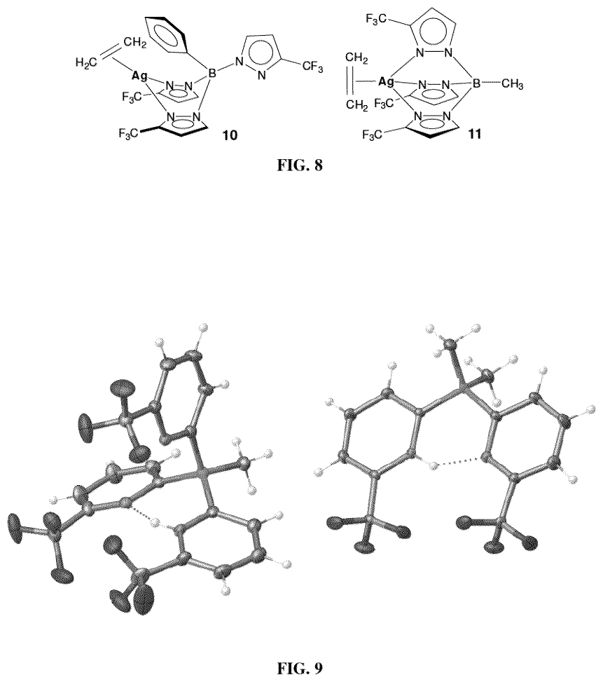

Coinage metal complexes 3-5 of the B-arylated tris(pyridyl)borate display the less common κ² coordinated mode in the solid-state with a flanking arenes above metal sites (rather than the metal bound third pyridyl arm), which essentially mimics the coordination mode of diphenylbis(pyridyl)borate analogs (6-7) as illustrated in FIG. 7. This contrasts with common κ³ coordination mode observed in d-block metal complexes (albeit not involving coinage metals) of B-phenylated tris(pyridyl)borate ligands based on both the pyridyl unsubstituted systems (e.g., [PhB(Py)₃]⁻) and those involving non-fluorinated substituents at the pyridyl 6-position (e.g., [PhB(6-(R)Py)₃]⁻ where R=Me, i-Pr). (Cui, C.; Lalancette, R. A.; Jäkle, F., The elusive tripodal tris(2-pyridyl)borate ligand: a strongly coordinating tetraarylborate. Chem. Commun. 2012, 48 (55), 6930-6932; Cui, C.; Shipman, P. R.; Lalancette, R. A.; Jäkle, F., Tris(2-pyridylborate) (Tpyb) Metal Complexes: Synthesis, Characterization, and Formation of Extrinsically Porous Materials with Large Cylindrical Channels. Inorg. Chem. 2013, 52 (16), 9440-9448; Shipman, P. O.; Cui, C.; Lupinska, P.; Lalancette, R. A.; Sheridan, J. B.; Jäkle, F., Nitroxide-Mediated Controlled Free Radical Polymerization of the Chelate Monomer 4-Styryl-tris(2-pyridyl)borate (StTpyb) and Supramolecular Assembly via Metal Complexation. ACS Macro Lett. 2013, 2 (12), 1056-1060; Jeong, S. Y.; Lalancette, R. A.; Lin, H.; Lupinska, P.; Shipman, P. O.; John, A.; Sheridan, J. B.; Jäkle, F., “Third-Generation”-Type Functional Tris(2-pyridyl)borate Ligands and Their Transition-Metal Complexes. Inorg. Chem. 2016, 55 (7), 3605-3615; Pawar, G. M.; Sheridan, J. B.; Jäkle, F., Pyridylborates as a New Type of Robust Scorpionate Ligand: From Metal Complexes to Polymeric Materials. Eur. J. Inorg. Chem. 2016, 2016 (15-16), 2227-2235; Qian, J.; Comito, R. J., A Robust Vanadium(V) Tris(2-pyridyl)borate Catalyst for Long-Lived High-Temperature Ethylene Polymerization. Organometallics 2021, 40 (12), 1817-1821; Goura, J.; McQuade, J.; Shimoyama, D.; Lalancette, R. A.; Sheridan, J. B.; Jäkle, F., Electrophilic and nucleophilic displacement reactions at the bridgehead borons of tris(pyridyl)borate scorpionate complexes. Chem. Commun. 2022, 58 (7), 977-980; Fujiwara, Y.; Takayama, T.; Nakazawa, J.; Okamura, M.; Hikichi, S., Development of a novel scorpionate ligand with 6-methylpyridine and comparison of the structural and electronic properties of nickel(II) complexes with related tris(azolyl)borates. Dalton Trans. 2022, 51 (27), 10338-10342; Qian, J.; Comito, R. J., Site-Isolated Main-Group Tris(2-pyridyl)borate Complexes by Pyridine Substitution and Their Ring-Opening Polymerization Catalysis. Inorg. Chem. 2022, 61 (28), 10852-10862.) Previous studies involving [PhB(3-(CF₃)Pz)₃]⁻ and [MeB(3-(CF₃)Pz)₃]⁻ with Cu(I) and Ag(I) ethylene show that the change of substituent on boron from phenyl methyl elicits a change in the tris(pyrazolyl)borate coordination from κ² to κ³ mode (e.g., FIGS. 8, 10 and 11). (Dias, H. V. R.; Wu, J.; Wang, X.; Rangan, K., Structural Variations of Silver Ethylene Complexes Supported by Boron-Protected Fluorinated Scorpionates and the Isolation of a Ligand-Directed Silver Helix. Inorg. Chem. 2007, 46 (6), 1960-1962; Dias, H. V. R.; Wang, X.; Diyabalanage, H. V. K., Fluorinated Tris(pyrazolyl)borate Ligands without the Problematic Hydride Moiety: Isolation of Copper(I) Ethylene and Copper(I)-Tin(II) Complexes Using [MeB(3-(CF₃)Pz)₃]. Inorg. Chem. 2005, 44 (21), 7322-7324.) Thus, the effects of B-Me vs B-aryl groups are observed in tris(pyridyl)borate coordination modes using ligands such as 9 and to compare the outcome to the better-known tris(pyrazolyl)borates.

### Results and Discussion

The bis(pyridyl)borate ligand [Me₂B(6-(CF₃)Py)₂]⁻ (8) was prepared from the reaction of bromodimethylborane (Me₂BBr, which was freshly prepared from tetramethyltin and boron tribromide) and 2-pyridylmagnesium chloride in dichloromethane, and isolated as a white powder (8-H) in 90% yield. It was fully characterized by several methods including multinuclear NMR spectroscopy. The two methyl groups are magnetically equivalent in the ¹H and ¹³C NMR indicating the presence of a C₂ symmetric structure in solution.

The usual route to tris(pyridyl)borates with an aryl group on the boron center involves the treatment of the pyridyl Grignard or pyridyl lithium reagents with dihalo(aryl)boranes (ArBX₂, X═Cl or Br). (Hodgkins, T. G., The synthesis and separation of the isomeric compounds dimeric dimethyl(2-pyridyl)borane and dimethylboronium bis(2-pyridyl)dimethylborate. Inorg. Chem. 1993, 32 (26), 6115-6116; Cui, C.; Shipman, P. R.; Lalancette, R. A.; Jäkle, F., Tris(2-pyridylborate) (Tpyb) Metal Complexes: Synthesis, Characterization, and Formation of Extrinsically Porous Materials with Large Cylindrical Channels. Inorg. Chem. 2013, 52 (16), 9440-9448; Pawar, G. M.; Sheridan, J. B.; Jäkle, F., Pyridylborates as a New Type of Robust Scorpionate Ligand: From Metal Complexes to Polymeric Materials. Eur. J. Inorg. Chem. 2016, 2016 (15-16), 2227-2235; Vanga, M.; Munoz-Castro, A.; Dias, H. V. R., Fluorinated tris(pyridyl)borate ligand support on coinage metals. Dalton Trans. 2022, 51 (4), 1308-1312; Fujiwara, Y.; Takayama, T.; Nakazawa, J.; Okamura, M.; Hikichi, S., Development of a novel scorpionate ligand with 6-methylpyridine and comparison of the structural and electronic properties of nickel(II) complexes with related tris(azolyl)borates. Dalton Trans. 2022, 51 (27), 10338-10342; Qian, J.; Comito, R. J., Site-Isolated Main-Group Tris(2-pyridyl)borate Complexes by Pyridine Substitution and Their Ring-Opening Polymerization Catalysis. Inorg. Chem. 2022, 61 (28), 10852-10862.) Due to the difficult nature in preparing the boron precursor dibromo(methyl)borane (including the separation from its disproportionation byproducts, Me₂BBr, Me₃B) (Jaroslaw Lewkowski; Michel Vaultier, The Reaction of Tetramethylsilane with Boron Tribromide. Main Group Met. Chem. 2001, 24 (1), 13-14) required for the B-methylated tris(pyridyl)borate [MeB(6-(CF₃)Py)₃]⁻ (9), an alternative route involving a more user friendly boron-source was analyzed. The proven utilization of air-stable RBF₃K salts (R=aryl, alkenyl) in the synthesis of triorganyl boranes (RB(R′)₂) and tetraorganyl borates (RB(R′)₃) from R′Li or R′MgBr (R′=aryl) promoted the selection of MeBF₃K as the boron reagent of choice. (Music, A.; Baumann, A. N.; Boser, F.; Müller, N.; Matz, F.; Jagau, T. C.; Didier, D., Photocatalyzed Transition-Metal-Free Oxidative Cross-Coupling Reactions of Tetraorganoborates**. Chem. Eur. J. 2021, 27 (13), 4322-4326.) Initially the fluorinated methyltris(pyridyl)borate ligand [MeB(6-(CF₃)Py)₃]⁻ (9) was synthesized by treating potassium methyltrifluoroborate (MeBF₃K) with 2-pyridylmagnesium chloride (which was obtained from iso-propylmagnesium chloride and 2-bromo-6-(trifluoromethyl)pyridine in THF). Although the desired ligand was obtained as the protonated form (9-H) after work-up, the yields were not reproducible upon scale-up, possibly due to the instability of the 2-pyridylmagnesium chloride in THF at room temperature and low solubility of MeBF₃K at lower temperatures. Thus, to improve the solubility of the boron reagent at lower temperatures and in inert hydrocarbon solvents, the salt metathesis was performed with tetrabutylammonium bromide to prepare tetrabutylammonium methyl trifluoroborate ([NBu₄][MeBF₃]). Utilizing this salt, the experiment prepared the protonated ligand [MeB(6-(CF₃)Py)₃]H (9-H) in gram scale in reproducible yields. The 9-H was isolated as a white solid (51% yield) and fully characterized by multinuclear NMR spectroscopy and elemental analysis.

The protonated ligands [MeB(6-(CF₃)Py)₃]H (9-H) and [Me₂B(6-(CF₃)Py)₂]H (8-H) was also characterized using X-ray crystallography (FIG. 9). The structures of 9-H and 8-H are largely dictated by intramolecular hydrogen bonding between pyridyl rings. Examination of [MeB(6-(CF₃)Py)₃]H (9-H) reveals that two of the three pyridyl rings are nearly coplanar, with the interplanar angles between the three pyridyl rings being 103.2, 104.8, and 151.9° (where the interplanar angle is the angle between the plane of each pyridyl ring, which would all be 120° in an ideal C₃ᵥ structure). Despite this asymmetry in the crystal structure, all three rings are magnetically equivalent in the ¹H, ¹³C, and ¹⁹F NMR, likely due to a fast intramolecular proton exchange in solution at room temperature. Additionally, the acidic NH peak was not observed for 9-H, whereas in the previously reported protonated ligands ([t-BuC₆H₄B(6-(CF₃)Py)₃]H and [(6-(CF₃)Py)₂]H)) as well as 8-H, the peak was observed between 19 and 20 ppm as a very broad singlet. Interestingly, [Me₂B(6-(CF₃)Py)₂]H (8-H) sits on a crystallographic mirror plane containing two-pyridyl arms, and features completely coplanar pyridyl rings and equivalent B-Me sites.

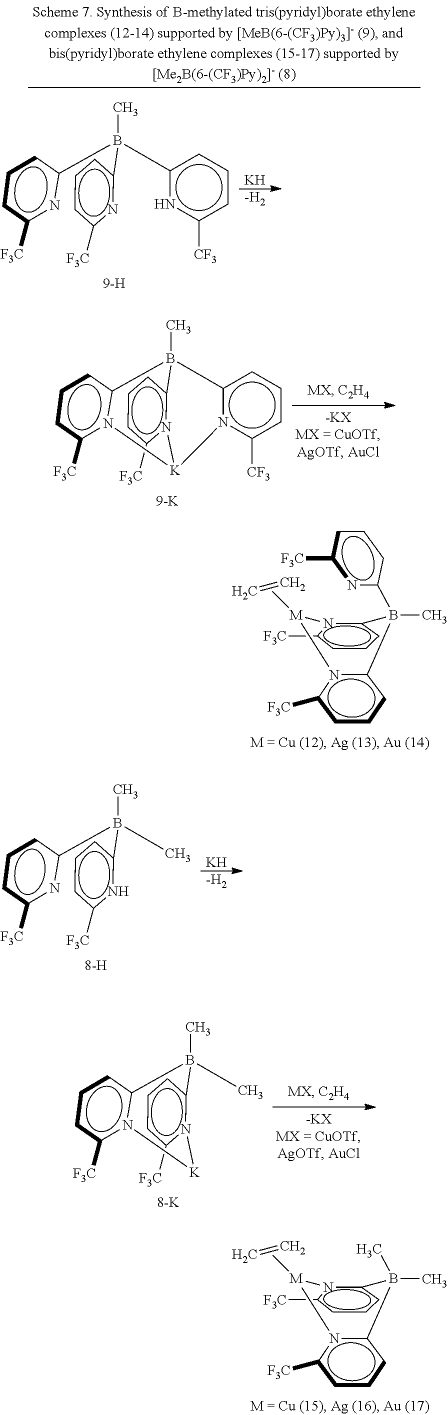

Considering the current interest in coinage metal ethylene complexes, the experiment set out to investigate the ability of [MeB(6-(CF₃)Py)₃]⁻ (9) and [Me₂B(6-(CF₃)Py)₂]⁻ (8) to stabilize such species. For this purpose, potassium salts of the ligands 8 and 9, [Me₂B(6-(CF₃)Py)₂]K (8-K) and [MeB(6-(CF₃)Py)₃]K (9-K) were prepared by the deprotonation of the corresponding protonated ligands (8-H and 9-H) with KH and obtained in essentially quantitative yields (Scheme 7). These salts were then reacted with CuOTf, AgOTf, and AuCl under an ethylene atmosphere to prepare the corresponding copper(I), silver(I) and gold(I) ethylene complexes 12-17 (Scheme 7).

The copper(I) complexes [MeB(6-(CF₃)Py)₃]Cu(C₂H₄) (12) and [Me₂B(6-(CF₃)Py)₂]Cu(C₂H₄) (15) were stable under reduced pressure and do not lose ethylene readily, unless prolonged vacuum is applied. On the other hand, the silver(I) complexes [MeB(6-(CF₃)Py)₃]Ag(C₂H₄) (13) and [Me₂B(6-(CF₃)Py)₂]Ag(C₂H₄) (16) lose ethylene under reduced pressure. The dimethylbis(pyridyl)borate ligand supported silver(I) complex 16 displays a dynamic equilibrium with the ethylene dissociated species in CDCl₃ solution at room temperature as observed by ¹H and ¹³C NMR spectroscopy. Compounds 12, 13, and 15 are stable in solution at room temperature, with no observable decomposition in their NMR spectra. The gold(I) complexes [MeB(6-(CF₃)Py)₃]Au(C₂H₄) (14) and [Me₂B(6-(CF₃)Py)₂]Au(C₂H₄) (17) are fairly stable at lower temperatures (−20° C.) both in solid state and in solution. However, both 14 and 17 gradually decompose at the room temperature even in the solid state under a nitrogen atmosphere, as evident from the formation of purple solids with no observable bound ethylene (based on NMR data) within 1 hour.

TABLE 9
Selected ¹H and ¹³C{¹H} NMR data (ppm) of poly(pyridyl)borate
and poly(pyrazolyl)borate coinage metal ethylene complexes. δH and
δC refers to the chemical shift of the bound ethylene resonances, ΔδH and ΔδC refers
to the change in chemical shift relative to free ethylene (5.40 (¹H) and 123.13
(¹³C) in CDCl₃), where Δδ = δ (free ethylene
resonance) − δ (ethylene resonance of the metal complex).

| Compound | δ_{H} (H₂C═) | Δδ_{H} | δ_{C} (H₂C═) | Δδ_{C} |
|---|---|---|---|---|
| [t-BuC₆H₄B(6-(CF₃)Py)₃]Cu(C₂H₄) (3) | 3.57 | −1.83 | 85.1 | −38.0 |
| [MeB(6-(CF₃)Py)₃]Cu(C₂H₄) (12) | 3.55 | −1.85 | 83.3 | −39.9 |
| [Me₂B(6-(CF₃)Py)₂]Cu(C₂H₄) (15) | 4.43 | −0.97 | 82.8 | −40.3 |
| [PhB(3-(C₂F₅)Pz)₃]Cu(C₂H₄) (18) | 3.70 | −1.70 | 85.5 | −37.6 |
| [t-BuC₆H₄B(6-(CF₃)Py)₃]Ag(C₂H₄) (4) | 4.66 | −0.74 | 103.2 | −19.9 |
| [MeB(6-(CF₃)Py)₃]Ag(C₂H₄) (13) | 4.74 | −0.66 | 104.3 | −18.8 |
| [Me₂B(6-(CF₃)Py)₂]Ag(C₂H₄) (16) | 5.42 | +0.02 | 102.8 | −20.3 |
| [PhB(3-(C₂F₅)Pz)₃]Ag(C₂H₄) (19) | 4.62 | −0.78 | 102.0 | −21.1 |
| [t-BuC₆H₄B(6-(CF₃)Py)₃]Au(C₂H₄) (5) | 2.66 | −2.74 | 58.7 | −64.4 |
| [MeB(6-(CF₃)Py)₃]Au(C₂H₄) (14) | 2.69 | −2.71 | 57.6 | −65.5 |
| [Me₂B(6-(CF₃)Py)₂]Au(C₂H₄) (17) | 3.41 | −1.99 | 57.1 | −66.0 |
| [PhB(3-(C₂F₅)Pz)₃]Au(C₂H₄) (20) | 2.89 | −2.51 | 59.3 | −63.8 |

The key NMR spectroscopic features of the ethylene complexes are summarized in Table 9. In comparison to free ethylene, the ¹H and ¹³C NMR spectra of the copper(I) complex 12 display coordination induced upfield shifts of 1.85 ppm and 39.9 ppm for the ethylene protons and carbon resonances respectively, while the dimethylbis(pyridyl)borate supported copper(I) complex 15 displays a smaller upfield shift of 0.97 ppm in the ethylene proton signals and almost identical (40.3 ppm) shift of the ¹³C signal. The difference in the ¹H chemical shift can most likely be rationalized as an effect of the ring current of the flanking pyridyl ring (from a κ²-bound tris(pyridyl)borate), as the chemical shifts of 12 are quite similar to those of the previously reported tert-butylphenyltris(pyridyl)borate 3 and phenyltris(pyrazolyl)borate supported copper(I) complexes (e.g., [PhB(3-(C₂F₅)Pz)₃]Cu(C₂H₄) (18)) (Dias, H. V. R.; Wu, J., Structurally Similar, Thermally Stable Copper(I), Silver(I), and Gold(I) Ethylene Complexes Supported by a Fluorinated Scorpionate. Organometallics 2012, 31 (4), 1511-1517) which both feature flanking phenyl rings and κ²-bound scorpionate ligands. A similar trend is also observed amongst heavier group 11 relatives, Ag and Au, between B-methyl and B-arylated systems (Table 9). For example, the analogous silver(I) complex of the methyltris(pyridyl)borate 13 shows an upfield chemical shift of 0.66 ppm and dimethylbis(pyridyl)borate 16 shows a downfield chemical shift of 0.02 ppm in their proton NMR, while the ¹³C peak silver bound ethylene groups display similar upfield chemical shifts of 18.8 and 20.3 ppm, respectively. Compared to copper and silver analogs, the gold(I) complexes 14 and 17 display the largest upfield shifts of ethylene moiety signals in both the ¹H NMR (i.e., upfield shifts of 2.71 and 1.99 ppm, respectively) and the ¹³C NMR (i.e., upfield shifts of 65.5 and 66.0 ppm, respectively) relative to those of the free ethylene (Table 9). (Kazi, A. B.; Rasika Dias, H. V.; Tekarli, S. M.; Morello, G. R.; Cundari, T. R., Coinage Metal-Ethylene Complexes Supported by Tris(pyrazolyl)borates: A Computational Study. Organometallics 2009, 28 (6), 1826-1831; Dias, H. V. R.; Wu, J., Structurally Characterized Coinage-Metal-Ethylene Complexes. Eur. J. Inorg. Chem. 2008, (4), 509-522; Munoz-Castro, A.; Dias, H. V. R., Bonding and ¹³C-NMR properties of coinage metal tris(ethylene) and tris(norbornene) complexes: Evaluation of the role of relativistic effects from DFT calculations. J. Comput. Chem. 2022, 43 (27), 1848-1855.) This trend within the coinage metal family (group 11) is also observed among the group 10 metals, nickel(II), palladium(II), and platinum(II), in which the 5d metal platinum displays the largest coordination shifts. In 2005, Forniés reported an isostructural series of group 10 ethylene complexes similar to Zeise's salt, [NBu₄][(C₆F₅)₃M(C₂H₄)] (M=Ni(II), Pd(II), Pt(II)), in which the ethylene resonances were observed at δ 4.96, 5.12, and 4.33 ppm in the ¹H NMR spectra for the nickel, palladium, and platinum complexes respectively. (Forniés, J.; Martín, A.; Martín, L. F.; Menjón, B.; Tsipis, A., All-Organometallic Analogues of Zeise's Salt for the Three Group 10 Metals. Organometallics 2005, 24 (14), 3539-3546; Zeise, W. C., Von der Wirkung zwischen Platinchlorid und Alkohol, und von den dabei entstehenden neuen Substanzen. Annalen der Physik 1831, 97 (4), 497-541.) The ethylene resonances for the palladium and platinum complexes were reported at δ 97.6 and 78.9 ppm respectively in the ¹³C NMR, but the data on nickel were not reported, perhaps due high reactivity.

The ¹H and ¹³C NMR spectra of the dimethylbis(pyridyl)borate silver(I) ethylene complex 16 display a rapid equilibrium with an ethylene-dissociated complex, but peaks can be unambiguously assigned to the ethylene complex and the ethylene-dissociated complex (8-Ag), which is indicative of a weak silver-ethylene bond.

TABLE 10
Selected bond distances (Å) and angles (deg) of coinage metal ethylene
complexes of methyltris(pyridyl)borate and dimethylbis(pyridyl)borate ligands.

| | [MeB(6- | [MeB(6- | [MeB(6- | [Me₂B(6- | [Me₂B(6- |
|---|---|---|---|---|---|
| | (CF₃)Py)₃]Cu(C₂H₄) | (CF₃)Py)₃]Ag(C₂H₄) | (CF₃)Py)₃]Au(C₂H₄) | (CF₃)Py)₂]Cu(C₂H₄) | (CF₃)Py)₂]Au(C₂H₄)^{c} |
| Parameter | (12) | (13)^{c} | (14) | (15) | (17) |
| C═C | 1.360(2) | 1.334(3) | 1.409(3) | 1.3670(17) | 1.402(15) |
| | | 1.325(4) | | | 1.377(16) |
| M—N | 2.0104(9), 1.9959(9) | 2.2525(14), 2.2711(14) | 2.1884(16), 2.2170(15) | 2.0106(9), 2.0128(9) | 2.204(8), 2.206(8) |
| | | 2.2598(13), 2.2887(13) | | | 2.200(8), 2.213(8) |
| M—C | 2.0202(12), 2.0240(12) | 2.2684(19), 2.2720(19) | 2.095(2), 2.1040(19) | 2.0355(11), 2.0382(11) | 2.102(10), 2.113(10) |
| | | 2.282(2), 2.278(2) | | | 2.091(10), 2.100(10) |
| ∠NMN | 93.50(4) | 87.09(5) | 83.42(6) | 94.25(3) | 85.3(3) |
| | | 84.85(4) | | | 85.0(3) |
| ∠CMC | 39.30(6) | 34.16(7) | 39.21(9) | 39.22(5) | 38.8(4) |
| | | 33.79(9) | | | 38.4(4) |
| M•••C(B)^{a} | 2.792 | 2.825 | 2.863 | 2.889 | 3.106 |
| | | 2.746 | | | 3.07 |
| Σ at M^{b} | 359.54 | 359.98 | 359.70 | 359.72 | 359.99 |
| | | 359.97 | | | 359.87 |

^{a}The M•••C(B) is the ipso-carbon separation between the M and flanking pyridyl or methyl groups.
^{b}Σ at M represents the sum of angles at M involving two nitrogen atoms bonded to M and the centroid of the ethylene carbons.
^{c}Italicized values represent the second molecule in the asymmetric unit.

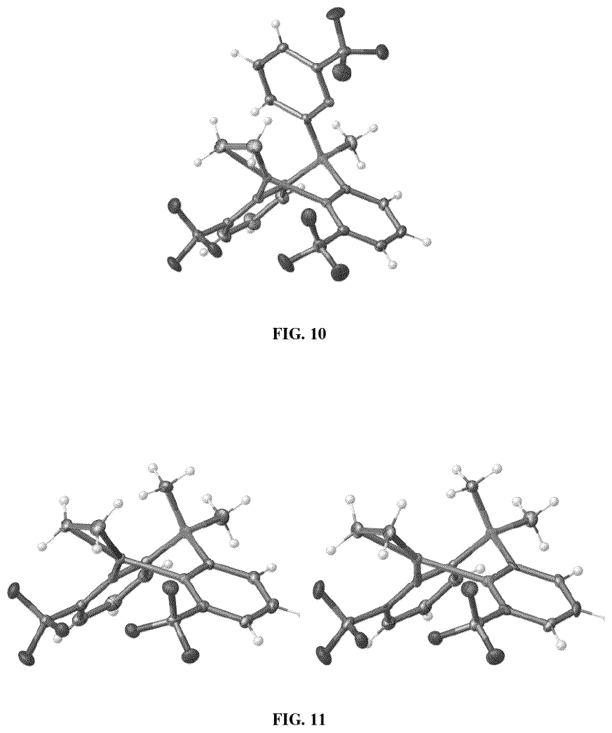

The analysis of the coinage metal ethylene complexes of [MeB(6-(CF₃)Py)₃]⁻ (12-14) using X-ray crystallography (FIG. 10) reveals that all three are three-coordinate, trigonal planar species, featuring the κ² coordination mode of the tris(pyridyl)borate with two pyridyl arms coordinated, and the other twisted to be almost parallel to the metal-ethylene plane. The selected bond distances and angles are presented in Table 10. The sum of angles at the metal sites of 12-14 is essentially 360°, which is indicative of a trigonal planar coordination geometry. The observed κ² coordination is consistent with the relatively large upfield shifts observed in ethylene proton signals, which were attributed to the flanking-pyridyl moieties likely present in solution. However, only one set of resonances for the pyridyl rings were observed in the ¹H, ¹³C, and ¹⁹F NMR spectra at room temperature, which suggests there is a fast interconversion of the N-coordinated and non-coordinated rings in solution. This fluxional behavior is consistent with previous findings with tris(pyrazolyl)borate coinage metal-ethylene complexes which feature κ²-coordination mode of the scorpionate. This fast interconversion of pyridyl arms on the NMR time scale however, contrasts the observations involving copper(I) ethylene complex 3 (supported by B-arylated, [t-BuC₆H₄B(6-(CF₃)Py)₃]⁻), which displayed two sets of well resolved resonances in the ¹H, ¹³C, and ¹⁹F NMR for coordinated and non-coordinated pyridyl arms. This could be due to competitive phenyl/pyridyl coordination to the metal center in 3, which is not possible in the B-methylated system 12. The related tris(pyrazolyl)borate family members [MeB(3-(CF₃)Pz)₃]Cu(C₂H₄) and [MeB(3-(CF₃)Pz)₃]Ag(C₂H₄) (11) (Dias, H. V. R.; Wu, J.; Wang, X.; Rangan, K., Structural Variations of Silver Ethylene Complexes Supported by Boron-Protected Fluorinated Scorpionates and the Isolation of a Ligand-Directed Silver Helix. Inorg. Chem. 2007, 46 (6), 1960-1962; Dias, H. V. R.; Wang, X.; Diyabalanage, H. V. K., Fluorinated Tris(pyrazolyl)borate Ligands without the Problematic Hydride Moiety: Isolation of Copper(I) Ethylene and Copper(I)-Tin(II) Complexes Using [MeB(3-(CF₃)Pz)₃]. Inorg. Chem. 2005, 44 (21), 7322-7324) are known and they display tetrahedral metal sites and κ³-coordination mode of the scorpionate. (Wu, J.; Noonikara-Poyil, A.; Munoz-Castro, A.; Dias, H. V. R., Gold(I) ethylene complexes supported by electron-rich scorpionates. Chem. Commun. 2021, 57 (8), 978-981; Dias, H. V. R.; Wu, J., Thermally Stable Gold(I) Ethylene Adducts: [(HB{3,5-(CF₃)₂Pz}₃)Au(CH₂CH₂)] and [(HB{3-(CF₃),5-(Ph)Pz}₃)Au(CH₂CH₂)]. Angew. Chem. Int. Ed. 2007, 46 (41), 7814-7816; Dias, H. V. R.; Wu, J., Structurally Similar, Thermally Stable Copper(I), Silver(I), and Gold(I) Ethylene Complexes Supported by a Fluorinated Scorpionate. Organometallics 2012, 31 (4), 1511-1517.) Thus, pyridyl and pyrazolyl ligand systems, [MeB(6-(CF₃)Py)₃]⁻ and [MeB(3-(CF₃)Pz)₃]⁻, adopt different modes of coordination in their copper and silver analogs, which was surprising. The related gold(I) complex is not available for comparisons.

The molecular structures of the copper and gold ethylene complexes 15 and 17 supported by bis(pyridyl)borate [Me₂B(6-(CF₃)Py)₂]⁻ are illustrated in FIG. 11. The experiment could not obtain the crystal structure of the silver analog due to facile dissociation of ethylene. Compounds 15 and 17 display the κ²-coordination mode of the scorpionate and feature trigonal planar metal sites. Selected bond distances and angles are given in Table 10.

In all five of the structurally characterized complexes the scorpionate ligand (12-14, 15 and 17) adopts the familiar B(CN)₂M boat shaped configuration involving the metal center, with the typical η² coordination of ethylene. Trigonal planar metal-ethylene complexes (L₂M(C₂H₄)) favor having the ethylene coplanar with the ligands and metal center to maximize orbital overlap and π-backbonding. (Fianchini, M.; Campana, C. F.; Chilukuri, B.; Cundari, T. R.; Petricek, V.; Dias, H. V. R., Use of [SbF₆]⁻ to Isolate Cationic Copper and Silver Adducts with More than One Ethylene on the Metal Center. Organometallics 2013, 32 (10), 3034-3041; Albright, T. A.; Hoffmann, R.; Thibeault, J. C.; Thorn, D. L., Ethylene complexes. Bonding, rotational barriers, and conformational preferences. J. Am. Chem. Soc. 1979, 101 (14), 3801-3812; Rosch, N.; Hoffmann, R., Geometry of transition metal complexes with ethylene or allyl groups as the only ligands. Inorg. Chem. 1974, 13 (11), 2656-2666; Pitzer, R. M.; Schaefer, H. F., III, Conformational preferences and electronic structures of bis (η²-ethene)nickel(0) and tris(η²-ethene)nickel(0). J. Am. Chem. Soc. 1979, 101 (24), 7176-7183.) The NMN and CMC planes are not exactly coplanar in the solid-state structures, where the copper(I) complexes 12 and 15 have torsion angles of 7.3° and 4.8° respectively, the silver(I) complex 16 features a torsion angle of 8.4° (average of two molecules in the asymmetric unit), and the gold complexes 14 and 17 display torsion angles of 4.6 and 3.1° (average of two molecules in the asymmetric unit), respectively. The relatively large torsion angle in the silver(I) complex 16 is perhaps indicative of the relatively weak R-backbonding capability of silver(I) compared to copper(I) and gold(I), (Dias, H. V. R.; Wu, J., Structurally Similar, Thermally Stable Copper(I), Silver(I), and Gold(I) Ethylene Complexes Supported by a Fluorinated Scorpionate. Organometallics 2012, 31 (4), 1511-1517; Mehara, J.; Watson, B. T.; Noonikara-Poyil, A.; Zacharias, A. O.; Roithová, J.; Rasika Dias, H. V., Binding Interactions in Copper, Silver and Gold R-Complexes. Chem. Eur. J. 2022, 28 (13), e202103984) as the extent of metal to olefin backdonation restricts olefin rotation from the preferred co-planar C₂MN₂ orientation. (Albright, T. A.; Hoffmann, R.; Thibeault, J. C.; Thorn, D. L., Ethylene complexes. Bonding, rotational barriers, and conformational preferences. J. Am. Chem. Soc. 1979, 101 (14), 3801-3812.) This large torsion angle and weak back-donation is consistent with previous findings on isostructural coinage metal complexes. (Dias, H. V. R.; Wu, J., Structurally Similar, Thermally Stable Copper(I), Silver(I), and Gold(I) Ethylene Complexes Supported by a Fluorinated Scorpionate. Organometallics 2012, 31 (4), 1511-1517; Mehara, J.; Watson, B. T.; Noonikara-Poyil, A.; Zacharias, A. O.; Roithová, J.; Rasika Dias, H. V., Binding Interactions in Copper, Silver and Gold π-Complexes. Chem. Eur. J. 2022, 28 (13), e202103984) These torsion angles are comparably larger than the closely related poly(pyrazolyl)borate coinage metal ethylene complexes, which can be rationalized by the closer proximity of the —CF₃ group on the pyridyl ring when compared to a pyrazolyl ring. For example, the separations between the metal center and the fluorine-bearing carbon (e.g. —CF₃ of 12-14, 15 and 17 and —CF₂CF₃ of 18-20) of the coordinated pyridyl and pyrazolyl rings are on average 3.28, 3.41, and 3.35 Å for the poly(pyridyl)borate complexes of copper(I), silver(I), and gold(I), respectively, and 3.65, 3.84, and 3.72 Å for the closely related poly(pyrazolyl)borate complexes of copper(I), silver(I), and gold(I), respectively. This close proximity of the pyridyl substituent and the steric congestion perhaps explains, at least to some degree, why κ³ coordination was not observed with 12-14, that have side-on bound ethylene ligands (see also the computational analysis below).

The metal to ipso-carbon on the boron center (either methyl or C² of the non-coordinated pyridyl ring) are 2.79 and 2.89 Å in the copper complexes 12 and 15, 2.79 (av.) A in the silver complex 13, and 2.86, 3.09 (av.) Å in the gold complexes 14 and 17. These separations are within the sum of van der Waals radii of M and C (for comparison, the sums of Bondi's van der Waals radii of M and C are 3.10, 3.42, and 3.36 Å for M=Cu, Ag, and Au respectively). (Alvarez, S., A cartography of the van der Waals territories. Dalton Trans. 2013, 42 (24), 8617-8636; Bondi, A., van der Waals Volumes and Radii. J. Phys. Chem. 1964, 68 (3), 441-451.) However, these contacts do not appear significant enough to distort the coordination geometry at the metal center, as all five complexes 12-14, 15 and 17 feature trigonal-planar metal geometries at the metal, as indicated by the sum of angles at the metal sites (˜360°).

The Cu—N<Au-N<Ag-N bond lengths follow the covalent radii of M(I), as silver is bigger than both gold and copper. (Bayler, A.; Schier, A.; Bowmaker, G. A.; Schmidbaur, H., Gold Is Smaller than Silver. Crystal Structures of [Bis(trimesitylphosphine)gold(I)] and [Bis(trimesitylphosphine)silver(I)] Tetrafluoroborate. J. Am. Chem. Soc. 1996, 118 (29), 7006-7007.) The M-C bond lengths follow this same trend and compare well with previously reported tris(pyrazolyl)borate and bis(pyrazolyl)methane supported coinage metal ethylene complexes. (Dias, H. V. R.; Wu, J., Thermally Stable Gold(I) Ethylene Adducts: [(HB{3,5-(CF₃)₂Pz}₃)Au(CH₂CH₂)] and [(HB{3-(CF₃),5-(Ph)Pz}₃)Au(CH₂CH₂)]. Angew. Chem. Int. Ed. 2007, 46 (41), 7814-7816; Dias, H. V. R.; Wu, J., Structurally Similar, Thermally Stable Copper(I), Silver(I), and Gold(I) Ethylene Complexes Supported by a Fluorinated Scorpionate. Organometallics 2012, 31 (4), 1511-1517; Mehara, J.; Watson, B. T.; Noonikara-Poyil, A.; Zacharias, A. O.; Roithová, J.; Rasika Dias, H. V., Binding Interactions in Copper, Silver and Gold π-Complexes. Chem. Eur. J. 2022, 28 (13), e202103984; Dias, H. V. R.; Wang, Z.; Jin, W., Synthesis and Chemistry of [Hydrotris(3,5-bis(trifluoromethyl)pyrazolyl)borato]silver(I) Complexes. Inorg. Chem. 1997, 36 (27), 6205-6215; Dias, H. V. R.; Lu, H.-L.; Kim, H.-J.; Polach, S. A.; Goh, T. K. H. H.; Browning, R. G.; Lovely, C. J., Copper(I) Ethylene Adducts and Aziridination Catalysts Based on Fluorinated Tris(pyrazolyl)borates [HB(3-(CF₃),5-(R)Pz)₃]⁻ (where R═CF₃, C₆H₅, H; Pz=pyrazolyl). Organometallics 2002, 21 (7), 1466-1473; Ridlen, S. G.; Wu, J.; Kulkarni, N. V.; Dias, H. V. R., Isolable Ethylene Complexes of Copper(I), Silver(I), and Gold(I) Supported by Fluorinated Scorpionates [HB{3-(CF₃),5-(CH₃)Pz}₃]⁻ and [HB{3-(CF₃),5-(Ph)Pz}₃]⁻. Eur. J. Inorg. Chem. 2016, 2016 (15-16), 2573-2580.) The ethylene C═C bond lengths could be utilized to compare the degree of metal-ethylene G/r-interaction in these molecules. For example, the C═C bond length in the isoleptic copper, silver, and gold-ethylene complexes 12, 13, and 14 are 1.360(2), av. 1.330(4), and 1.409(3) Å, respectively. This suggests the strongest metal-ethylene interaction in the gold adducts and the weakest in silver complexes. In fact, the silver adduct shows essentially no change in C═C distance upon coordination to the metal, which is not surprising as these changes are typically smaller and often overshadowed by the relatively high estimated standard deviations (esds) associated with the measurement, libration effects and anisotropy of the electron density. (Dias, H. V. R.; Wu, J., Structurally Characterized Coinage-Metal-Ethylene Complexes. Eur. J. Inorg. Chem. 2008, (4), 509-522; Reisinger, A.; Trapp, N.; Knapp, C.; Himmel, D.; Breher, F.; RUegger, H.; Krossing, I., Silver-Ethene Complexes [Ag(η²-C₂H₄)ₙ][Al(OR^{F})₄] with n=1, 2, 3 (R^{F}=Fluorine-Substituted Group). Chem. Eur. J. 2009, 15 (37), 9505-9520.) For comparison, the C═C bond length in free gaseous ethylene is estimated to be 1.3305(10) Å, and the corresponding X-ray data is 1.313 Å. (Craig, N. C.; Groner, P.; McKean, D. C., Equilibrium Structures for Butadiene and Ethylene: Compelling Evidence for Π-Electron Delocalization in Butadiene. J. Phys. Chem. A 2006, 110 (23), 7461-7469; Nes, G. J. H.; Vos, A., Single-crystal structures and electron density distributions of ethane, ethylene and acetylene. III. Single-crystal X-ray structure determination of ethylene at 85 K. Acta Crystallogr. B: Struct. Sci. Cryst. Eng. Mater. 1979, 35 (11), 2593-2601.)

In order to further evaluate the origin of the observed preference for κ² or κ³ coordination modes within different scorpionate ligands and metal centers, computational calculations were carried out. For [MeB(6-(CF₃)Py)₃]⁻ ligands, the κ² coordination mode is favored by 7.5 kcal/mol over κ³ for 12, which increases to 7.9 kcal/mol for 13, and 9.9 kcal/mol for 14, which is given by stabilization of both electrostatic and orbital interactions which overcome an increase of steric effects denoted by the destabilizing Pauli repulsion term. The 6-(CF₃) substituents increase the energy difference between such coordination modes, by introducing steric hindrance, as compared with calculated unsubstituted counterparts involving [MeB(Py)₃]⁻ indicating a much smaller κ²/κ³ difference of 2.4, 1.1, and 1.2 kcal/mol for, Cu, Ag, and Au. Replacement of the MeB group by B-phenyl substituent (PhB), as in the [PhB(6-(CF₃)Py)₃]⁻ ligand, leads to a similar but decreased preference for the κ² coordination mode amounting to 2.8, 4.0, and 4.8 kcal/mol, for Cu, Ag, and Au species, respectively.

The ethylene-M interaction energy is calculated to be −44.7 kcal/mol for [MeB(6-(CF₃)Py)₃]Cu(C₂H₄) (12), which decreases to −30.0 kcal/mol in [MeB(6-(CF₃)Py)₃]Ag(C₂H₄) (13), and increases to −63.3 kcal/mol in [MeB(6-(CF₃)Py)₃]Au(C₂H₄) (14). They are relatively smaller, i.e., −41.0, −19.6, and −58.7 kcal/mol, respectively, for the analogous systems with the hypothetical κ³ coordination modes, owing to an increase of steric effects accounted by the Pauli term. In compounds 12-14, the M→π²-C₂H₄ backdonation accounts for about 60% and the M←π¹-C₂H₄ s-donation is about 30% of the bonding contributions of the orbital interaction term. The 6-(CF₃) substituents decrease the ethylene-M interaction energy slightly as compared to hypothetical unsubstituted counterparts (i.e., the ethylene-metal interaction energies of Cu, Ag, and Au ethylene complexes of [MeB(Py)₃]⁻ are −46.2, −31.2, −68.2 kcal/mol, respectively). For the bis(pyridyl)borate compounds 15, 16, and 17 (Scheme 7) supported by the [Me₂B(6-(CF₃)Py)₂]⁻, the ethylene-M interaction energy is slightly lower than those calculated for [MeB(6-(CF₃)Py)₃]⁻ species, amounting to −41.6, −26.6, and −61.9 kcal/mol.

Interestingly, the computational analysis of κ² or κ³ coordination modes of the coinage metal ethylene complexes supported by the better known pyrazolate based scorpionates, namely [MeB(3-(CF₃)Pz)₃]⁻ and [PhB(3-(CF₃)Pz)₃]⁻, show a shift between MeB and PhB, where for the former, κ³ coordination is favored by 1.3, 2.1, and 5.9 kcal/mol, for ethylene complexes of Cu, Ag, and Au, respectively. In contrast, for [PhB(3-(CF₃)Pz)₃]M(C₂H₄), the κ² coordination mode is preferred by 13.6, 14.6, and 2.1 kcal/mol for M=Cu, Ag, and Au, respectively.

### Conclusions

This example describes the synthesis and coinage metal ethylene chemistry of a new “fluorine-lined” bis(pyridyl)borate and the related tris(pyridyl)borate ligand with methyl groups on the boron (vs. B-aryl systems) and CF₃ groups at the pyridyl ring 6-positions. The study also demonstrated the use of air-stable trifluoroborate [MeBF₃]⁻ as the boron-precursor in the ligand synthesis, avoiding the reactive and troublesome MeBBr₂. Furthermore, the study illustrated the effects of using 6-membered pyridyl donors instead of 5-membered pyrazolyl rings in scorpionates on metal-ion coordination modes. The NMR spectroscopic data of [MeB(6-(CF₃)Py)₃]M(C₂H₄) and [Me₂B(6-(CF₃)Py)₂]M(C₂H₄) (M=Cu, Ag, Au) show that the gold complexes display the largest coordination induced upfield shifts of the ethylene ¹³C resonance (˜66 ppm) relative to that of the free ethylene while the silver complexes show the smallest shift (˜19 ppm). The magnitude of the metal coordination induced upfield shifts of ethylene carbon signal correlate well with the computed ethylene-M interaction energies of these metal-ethylene complexes, which point to the strongest and weakest interactions with gold(I) and silver(I), respectively. X-ray crystal structures of [MeB(6-(CF₃)Py)₃]M(C₂H₄) (M=Cu, Ag, Au) and [Me₂B(6-(CF₃)Py)₂]M(C₂H₄) (M=Cu, Au) show that these complexes adopt κ² coordination mode of the scorpionate, which was a surprise for the former group as κ³ coordination mode is more common with such facial capping tridentate ligands. Data from the computational investigation agree with the experimental observations, which indicate that κ² coordination mode is favored over the κ³-mode in these tris(pyridyl)borate coinage metal ethylene complexes. The estimated κ²/κ³-energy difference, however, is much smaller for the [MeB(Py)₃]M(C₂H₄) systems involving the CF₃-substituent free ligand, pointing to some steric influence on coordination modes. Interestingly, the coinage metal ethylene complexes of the related tris(pyrazolyl)borate show the preference for κ³ coordination mode.

### Experimental Details

General information: All preparations and manipulations were carried out under an atmosphere of purified nitrogen using standard Schlenk techniques or in an MBraun drybox equipped with a −25° C. refrigerator. Dichloromethane, hexanes, toluene, and diethyl ether were dried by passing HPLC grade solvent through a Solvent Purification System (SPS, innovative technologies inc.) and stored in Straus flasks. Tetrahydrofuran was distilled from a sodium/ketyl still. Cyclohexane was distilled from sodium and degassed by 3 freeze-pump-thaw cycles. Glassware was oven dried overnight at 150° C. NMR spectra were acquired at 25° C., on a JEOL Eclipse 500 spectrometer and processed on MNova (¹H, 500 MHz; ¹³C, 126 MHz; ¹⁹F, 471 MHz). ¹⁹F NMR values were referenced to external CFCl₃. ¹H and ¹³C NMR spectra were referenced internally to solvent signals (CDCl₃: 7.26 ppm for ¹H NMR, 77.16 ppm for ¹³C NMR; DMSO-d₆: 2.50 ppm for ¹H NMR, 39.52 ppm for ¹³C NMR), or externally to SiMe₄ (0 ppm). ¹H, ¹³C, and ¹⁹F NMR chemical shifts are reported in ppm and coupling constants (J) are reported in Hertz (Hz). Abbreviations used for signal assignments: Py=pyridyl, s=singlet, d=doublet, t=triplet, q=quartet, q*=1:1:1:1 quartet, m=multiplet, br s=broad singlet. NMR solvents were purchased from Cambridge Isotopes Laboratories and used as received. Ethylene gas was purchased from Matheson. Elemental analyses were performed using a Perkin-Elmer Model 2400 CHN analyzer. The compounds {(6-(CF₃)-2-Py)MgCl}2·(THF)₃ and Me₂BBr and (CuOTf)₂·PhMe were prepared by modified literature procedures. (Vanga, M.; Munoz-Castro, A.; Dias, H. V. R., Fluorinated tris(pyridyl)borate ligand support on coinage metals. Dalton Trans. 2022, 51 (4), 1308-1312; Guindon, Y.; Yoakim, C.; Morton, H. E., Dimethylboron bromide and diphenylboron bromide: cleavage of acetals and ketals. J. Org. Chem. 1984, 49 (21), 3912-3920; Flores, D. M.; Schmidt, V. A., Intermolecular 2+2 Carbonyl-Olefin Photocycloadditions Enabled by Cu(I)-Norbornene MLCT. J. Am. Chem. Soc. 2019, 141 (22), 8741-8745.) All other reagents were obtained from commercial sources and used as received. Silver and gold complexes were prepared in reaction vessels protected from light using aluminum foil.

[Me₂B(6-(CF₃)Py)₂]H (8-H): Dimethylboron bromide (neat, 4.23 g, 35 mmol, 1 eq, freshly prepared and distilled) was diluted with 40 mL of dichloromethane (c.a. 1 M solution) and cooled to 0° C. Separately, 6-trifluoromethyl-2-pyridyl magnesium chloride (assumed {(6-(CF₃)-2-Py)MgCl}2·(THF)₃, 26.4 g, 42 mmol, 1.2 eq (2.4 eq PyMgCl·(THF)_{1.5})) was cooled to −20° C. and dissolved in c.a. 350 mL of dichloromethane in a 500 mL Schlenk RBF. Utilizing high N₂ pressure and a bleed needle, the dimethylboron bromide solution was cannula transferred dropwise into the Grignard solution, maintaining a temperature of −20° C. (N.B. dimethylboron bromide is volatile (b.p. 30-31° C.), using vacuum to transfer may lower the yield). After the addition was complete, an additional 10 mL of dichloromethane can be used to rinse the dimethylboron bromide flask. The reaction was allowed to warm to room temperature and kept stirring for 48 hours. The light brown reaction mixture was added to a vigorously stirring solution of saturated sodium bicarbonate (c.a. 200 mL) and left stirring for 1 hour. The organic layer was separated, and the aqueous was extracted with additional dichloromethane (3×50 mL). The organic layers were combined, washed with brine, and concentrated via rotary evaporation to yield 12 g of an orange powder which contains the 2-trifluoromethylpyridine byproduct (quenched pyridyl Grignard). This can be washed/triturated with minimal cold n-pentane to yield [Me₂B(6-(CF₃)Py)₂]H in 5.60 g yield as a pure white powder. The filtrate can be concentrated and crystallized from n-pentane or hexanes for additional crops, or alternatively subjected to flash column chromatography (silica gel, 10% ethyl acetate in hexanes, R_{f}=0.3) to yield an additional 3.9 g. Single crystals can be grown from a saturated solution of dichloromethane at −20° C. or by dissolving in minimal boiling hexanes and cooling to room temperature. N.B. any future reactions using these ligands can be pooled and treated with identical work-up (NaHCO₃, crystallization or chromatographed) to reclaim the protonated ligand ([Me₂B(6-(CF₃)Py)₂]H) rather than discarding, in order to minimize the wastage of time and resources of repeated syntheses. Yield: 10.5 g (90%). Anal. Calc. C₁₄H₁₃B₁F₆N2: C, 50.33%; H, 3.92%; N, 8.39%. Found: C, 50.17%; H, 3.91%; N, 8.27%. ¹H NMR (500 MHz, CDCl₃): δ (ppm) 19.32 (br s, 1H, NH), 8.05 (d, ³J=9.0 Hz, 2H, Py^{3/5}), 7.86 (t, ³J=8.0 Hz, 2H, Py⁴), 7.52 (dd, ³J=7.7, 1.4 Hz, 2H, Py^{5/3}), 0.12 (s, 3H, BMe), 0.11 (s, 3H, BMe). ¹³C{¹H} NMR (126 MHz, CDCl₃): δ (ppm) 194.8 (q*, ¹J_{C-B}=46.9 Hz, Py²), 140.2 (q, ²J_{C-F}=43.2 Hz, Py⁶), 137.3 (Py), 133.1 (Py), 121.2 (q, ¹J_{C-F}=275.2 Hz, CF₃), 116.7 (Py), 13.7 (q*, ¹J_{C-B}=42.1 Hz, BMe). ¹⁹F NMR (471 MHz, CDCl₃): δ (ppm) −66.76.

[MeB(6-(CF₃)Py)₃]H (9-H): To a suspension of {(6-(CF₃)-2-Py)MgCl}2·(THF)₃ (14.39 g, 22.92 mmol, 2.1 eq) in anhydrous toluene (305 mL) at −30° C. was added a suspension of [MeBF₃][NBu₄] (3.55 g, 10.91 mmol, 1 eq) in anhydrous toluene (100 mL) at 0° C. After stirring for 6 hours at 0° C. in an ice bath, the reaction mixture then slowly warmed to rt and continued stirring for an additional 48 hours. The reaction mixture was then poured into water (200 mL) and ethyl acetate (200 mL) mixture, 5 g of Na₂CO₃ was added, and the mixture was kept stirring for 3 hours. The layers were separated, and the aqueous layer was extracted with ethyl acetate (3×30 mL). The organic extracts were combined, washed with brine, dried over Na₂SO₄, and evaporated to dryness. The resulting residue was purified through silica gel column chromatography using hexane and ethyl acetate (9:1) as eluent. The solvent was removed under reduced pressure and then the resulted solid was further recrystallized from hot hexanes to obtain the desired [MeB(6-(CF₃)Py)₃]H as a white crystalline solid. Yield: 2.6 g (51%). Anal. Calc. C₁₉H₁₃B₁F₉N₃: C, 49.06%; H, 2.82%; N, 9.03%. Found: C, 48.88%; H, 2.53%; N, 8.91%. ¹H NMR (500 MHz, CDCl₃): δ (ppm) 7.76-7.70 (m, 6H, Py^{3.5}), 7.45 (dd, ³J=7.3, 1.6 Hz, 3H, Py⁴), 0.57 (s, 3H, BMe). ¹³C{¹H} NMR (126 MHz, CDCl₃): δ (ppm) 185.9 (q*, ¹J_{C-B}=51.2 Hz, Py²), 142.8 (q, ²J_{C-F}=35.8 Hz, Py⁶), 136.7 (Py), 132.1 (Py), 121.5 (q, ¹J_{C-F}=274.3 Hz, Py), 116.8 (Py), 10.2 (q*, ¹J_{C-B}=43.2 Hz, BMe). ¹⁹F NMR (471 MHz, CDCl₃): δ (ppm) −67.60 (s).

[Me₂B(6-(CF₃)Py)₂]K (8-K): To a suspension of KH (0.160 g, 3.90 mmol, 1.3 eq, pre-washed) in 10 mL of THE at 0° C. was slowly added via cannula transfer a solution of [Me₂B(6-(CF₃)Py)₂]H (8-H, 1.00 g, 3.00 mmol, 1 eq) in 30 mL of THE. After complete cessation of hydrogen gas evolution, the reaction was allowed to warm temperature and kept stirring for 12 hours. Alternatively, the reaction can be brought to reflux for 1 hour. This yellow solution was filtered through a celite packed frit to remove unreacted KH. The colorless filtrate was concentrated under reduced pressure to obtain [Me₂B(6-(CF₃)Py)₂]K as an off-white solid. The compound was further dried at 60° C. under reduced pressure overnight to remove trace solvent. Yield: 1.06 g (95%). Anal. Calc. C₁₄H₁₂B₁F₆N₂K₁: C, 45.18%; H, 3.25%; N, 7.53%. Found: C, 45.06%; H, 3.28%; N, 7.53%. ¹H NMR (500 MHz, DMSO-d₆): δ (ppm) 7.50 (d, ³J=7.6 Hz, 2H, Py^{3/5}), 7.40 (t, ³J=7.8 Hz, 2H, Py⁴), 7.15 (d, ³J=6.9 Hz, 2H, Py^{5/3}), −0.04 (s, 6H, BMe). ¹³C{¹H} NMR (126 MHz, DMSO-d₆): δ (ppm) 195.4 (q*, ¹J_{C-B}=52.9 Hz, Py²), 144.4 (q, ²J_{C-F}=32.3 Hz, Py⁶), 132.2 (Py), 129.9 (Py), 123.0 (q, ¹J_{C-F}=274.7 Hz, CF₃), 113.2 (Py), 14.1 (q*, ¹J_{C-B}=43.3 Hz, BMe). ¹⁹F NMR (471 MHz, DMSO-d₆): a (ppm) −65.15.

[MeB(6-(CF₃)Py)₃]K (9-K): To a suspension of KH (0.26 g, 6.55 mmol, 1.5 eq) in anhydrous THE (25 mL) at 0° C. was slowly added a solution of [MeB(6-(CF₃)Py)₃]H (9-H, 2.00 g, 4.36 mmol, 1 eq) in THE (25 mL). After complete cessation of hydrogen gas evolution, the reaction mixture was allowed to warm to room temperature and then kept stirring for 12 hours. The solution was filtered through a Celite packed frit to remove unreacted KH. The solvent in the filtrate collected was removed under reduced pressure to obtain [MeB(6-(CF₃)Py)₃]K as a white solid. The compound was further dried at 90° C. for 6 hours under reduced pressure to remove all trace solvent. Yield: 2.00 g (92%). Anal. Calc. C₁₉H₁₂B₁F₉K₁N₃: C, 45.35%; H, 2.40%; N, 8.35%. Found: C, 45.30%; H, 2.45%; N, 8.08%. ¹H NMR (500 MHz, DMSO-d₆): δ (ppm) 7.54 (d, ³J=7.8 Hz, 3H, Py^{3/5}), 7.48 (t, ³J=7.7 Hz, 3H, Py⁴), 7.25 (d, ³J=7.5 Hz, 3H, Py^{5/3}), 0.40 (s, 3H, BMe). ¹³C{¹H} NMR (126 MHz, DMSO-d₆): δ (ppm) 190.5 (q*, ¹J_{C-B}=54.2 Hz, Py²), 144.6 (q, ²J_{C-F}=32.4 Hz, Py⁶), 132.5 (Py), 131.3 (Py), 122.8 (q, ¹J_{C-F}=273.5 Hz, CF₃), 113.9 (Py), 12.0 (q*, ¹J_{C-B}=44.4 Hz, BMe). ¹⁹F NMR (471 MHz, CDCl₃): a (ppm) −66.15.

[MeB(6-(CF₃)Py)₃]Cu(C₂H₄) (12): To a mixture of [MeB(6-(CF₃)Py)₃]K (9-K, 150 mg, 298 μmol) and (CuOTf)₂-PhMe (85 mg, 164 μmol) in a 50 mL Schlenk flask was added anhydrous dichloromethane (20 mL) and then bubbled with ethylene. The reaction mixture was kept stirring for 3 hours then cannula filtered through a celite packed frit to remove KOTf. The solvent was then removed reduced pressure and the compound was recrystallized from ethylene saturated CH₂Cl₂/hexane mixture at −20° C. to obtain colorless X-ray quality single crystals of [MeB(6-(CF₃)Py)₃]Cu(C₂H₄). Yield: 0.141 g (85%). Anal. Calc. C₂₁H₁₆B₁Cu₁F₉N₃: C, 45.39%; H, 2.90%; N, 7.56%. Found: C, 45.65%; H, 3.11%; N, 7.13%. ¹H NMR (500 MHz, CDCl₃): δ (ppm) 7.74-7.65 (m, 6H, Py^{3.5}), 7.42 (d, ³J=7.3 Hz, 3H, Py⁴), 3.55 (s, 4H, C₂H₄), 0.57 (s, 3H, BMe). ¹³C{¹H} NMR (126 MHz, CDCl₃): δ (ppm) 187.1 (q*, ¹J_{C-B}=54.0 Hz, Py²), 145.9 (q, ²J_{C-F}=31.4 Hz, Py⁶), 135.5 (Py), 132.3 (Py), 122.1 (q, ¹J_{C-F}=273.5 Hz, CF₃), 117.1 (Py), 83.3 (C₂H₄), 11.3 (q*, ¹J_{C-B}=44.4 Hz, BMe). ¹⁹F NMR (471 MHz, CDCl₃): δ (ppm) −66.53.

[MeB(6-(CF₃)Py)₃]Ag(C₂H₄) (13): To a mixture of [MeB(6-(CF₃)Py)₃]K (9-K, 150 mg, 298 μmol) and AgOTf (84 mg, 328 μmol) in a 50 mL Schlenk flask was added anhydrous dichloromethane (20 mL) and then bubbled with ethylene. The reaction mixture was kept stirring for 3 hours then cannula filtered through a celite packed frit to remove KOTf. The solvent was then removed reduced pressure and the compound was recrystallized from ethylene saturated CH₂Cl₂/hexane mixture at −20° C. to obtain colorless X-ray quality single crystals of [MeB(6-(CF₃)Py)₃]Ag(C₂H₄). Solid samples of [MeB(6-(CF₃)Py)₃]Ag(C₂H₄) lose ethylene as evidenced from its CHN analysis. Anal. Calc. C₁₉H₁₂B₁Ag₁F₉N₃: C, 39.90%; H, 2.11%; N, 7.35%. Found: C, 39.98%; H, 2.13%; N, 7.17%. Yield: 0.135 g (75%). ¹H NMR (500 MHz, CDCl₃): δ (ppm) 7.71 (d, ³J=7.9 Hz, 3H, Py^{3/5}), 7.62 (t, ³J=7.8 Hz, 3H, Py⁴), 7.39 (d, ³J=7.7 Hz, 3H, Py^{5/3}), 4.74 (s, 4H, C₂H₄), 0.55 (s, 3H, CH₃). ¹³C{¹H} NMR (126 MHz, CDCl₃): δ (ppm) 187.6 (q*, ¹J_{C-B}=52.8 Hz, Py²), 146.0 (q, ²J_{C-F}=31.7 Hz, Py⁶), 135.3 (Py), 132.1 (Py), 122.2 (q, ¹J_{C-F}=273.5 Hz, CF₃), 116.3 (Py), 104.3 (C₂H₄), 11.3 (q*, ¹J_{C-B}=43.2 Hz, CH₃). ¹⁹F NMR (471 MHz, CDCl₃): a (ppm) −67.88.

[MeB(6-(CF₃)Py)₃]Au(C₂H₄) (14): Ethylene saturated dichloromethane (20 mL) at −20° C. was cannula transferred to a 50 mL Schlenk flask containing a mixture of [MeB(6-(CF₃)Py)₃]K (9-K, 130 mg, 0.258 mmol) and AuCl (66 mg, 0.284 mmol). The reaction mixture was slowly warmed to room temperature and kept stirred for 3 hours then cannula filtered through a celite packed frit to remove KCl. The solvent was then removed reduced pressure and the compound was recrystallized from CH₂Cl₂/hexane mixture at −20° C. to obtain colorless X-ray quality single crystals of [MeB(6-(CF₃)Py)₃]Au(C₂H₄). This complex decomposes at room temperature within 1 hour when stored under a nitrogen atmosphere. As a result, satisfactory CHN data could not be obtained. Yield: 120 mg (67%). ¹H NMR (500 MHz, CDCl₃): δ (ppm) 7.74 (d, ³J=7.6 Hz, 3H, Py^{3/5}), 7.64 (t, ³J=7.8 Hz, 3H, Py⁴), 7.44 (d, 3J=6.8 Hz, 3H, Py^{5/3}), 2.69 (s, 4H, C₂H₄), 0.59 (s, 3H, BMe). ¹³C{¹H} NMR (126 MHz, CDCl₃): δ (ppm) 187.7 (q*, ¹J_{C-B}=52.8 Hz, Py²), 146.1 (q, ²J_{C-F}=32.7 Hz, Py⁶), 135.5 (Py), 132.6 (Py), 122.0 (q, ¹J_{C-F}=273.5 Hz, CF₃), 117.2 (Py), 57.6 (C₂H₄), 11.0 (q*, J_{C-B}=47.0 Hz, BMe). ¹⁹F NMR (471 MHz, CDCl₃): δ (ppm) −66.87.

[Me₂B(6-(CF₃)Py)₂]Cu(C₂H₄) (15): [Me₂B(6-(CF₃)Py)₂]K (8-K, 100 mg, 0.27 mmol, 1 eq) and (CuOTf)₂-PhMe (73 mg, 0.14 mmol, 0.52 eq) were combined in a 50 mL Schlenk flask and 8 mL of dichloromethane was added. Ethylene was bubbled into the solution and headspace for c.a. 10 seconds every 30 minutes for 2 hours until the reaction turned colorless. Insoluble materials ((CuOTf)₂-PhMe, KOTf) were removed via cannula filtration through a celite packed frit, and the solvent was removed under reduced pressure to yield a yellow powder. This was recrystallized from a concentrated dichloromethane solution at −30° C. overnight to obtain colorless X-ray quality single crystals. Yield: 0.093 g (82%). Anal. Calc. C₁₆H₁₆B₁F₆N₂Cu₁: C, 45.25%; H, 3.80%; N, 6.60%. Found: C, 44.94%; H, 3.45%; N, 6.32%. ¹H NMR (500 MHz, CDCl₃): δ (ppm) 7.95 (d, ³J=9.0 Hz, 2H, Py³¹⁵), 7.65 (t, ³J=8.3 Hz, 2H, Py⁴), 7.41 (d, ³J=8.7 Hz, 2H, Py^{5/3}), 4.43 (s, 4H, C₂H₄), 0.39 (s, 3H, BMe), 0.21 (s, 3H, BMe). ¹³C{¹H} NMR (126 MHz, CDCl₃): δ (ppm) 192.3 (q*, ¹J_{C-B}=47.6 Hz, Py²), 145.0 (q, ²J_{C-F}=34.2 Hz, Py⁶), 135.6 (Py), 131.5 (Py), 122.2 (q, ¹J_{C-F}=274.3 Hz, CF₃), 117.2 (Py), 82.8 (C₂H₄), 14.2 (q*, ¹J_{C-B}=39.6 Hz, BMe), 11.1 (q*, ¹J_{C-B}=46.0 Hz, BMe). ¹⁹F NMR (471 MHz, CDCl₃): a (ppm) −65.04.

[Me₂B(6-(CF₃)Py)₂]Ag(C₂H₄) (16): [Me₂B(6-(CF₃)Py)₂]K (8-K, 100 mg, 0.27 mmol, 1 eq) and AgOTf (109 mg, 0.28 mmol, 0.52 eq) were combined in a 50 mL Schlenk flask and 8 mL of dichloromethane was added. Ethylene was bubbled into the solution and headspace for c.a. 10 seconds every 30 minutes for 2 hours until the reaction turned colorless. Insoluble materials (AgOTf, KOTf) were removed via cannula filtration through a celite packed frit, and the solvent was removed under reduced pressure to yield a white powder. Attempts at recrystallization yielded an ethylene dissociated precipitate, in solution and solid-state this complex loses ethylene over time. Yield: 0.093 g (82%). Anal. Calc. C₁₆H₁₆B₁F₆N₂Ag₁: C, 40.98%; H, 3.44%; N, 6.25%. Found: C, 38.26%; H, 2.95%; N, 6.25%, This is a close match for ethylene dissociated C₁₄H₁₂B₁F₆N₂Ag₁: C, 38.14%; H, 2.74%; N, 6.35%. ¹H NMR (500 MHz, CDCl₃): δ (ppm) 7.93 (d, ³J=9.0 Hz, 2H, Py^{3/5}), 7.59 (t, ³J=8.0 Hz, 2H, Py⁴), 7.37 (dd, ³J=7.8, 1.3 Hz, 2H, Py^{5/3}), 5.42 (s, 4H, C₂H₄), 0.32 (br s, 6H, BMe₂). ¹³C{¹H} NMR (126 MHz, CDCl₃): δ (ppm) 145.3 (q, ²J_{C-F}=29.6 Hz, Py⁶), 135.3 (Py), 131.3 (Py), 122.4 (q, ¹J_{C-F}=273.5 Hz, CF₃), 116.2 (Py), 102.8 (C₂H₄), 12.4 (q*, ¹J_{C-B}=40.8 Hz, BMe), Py² not observed. ¹⁹F NMR (471 MHz, CDCl₃): δ (ppm) −67.18.

[Me₂B(6-(CF₃)Py)₂]Au(C₂H₄) (17): [Me₂B(6-(CF₃)Py)₂]K (8-K, 100 mg, (0.27 mmol, 1 eq) and AuCl (66 mg, 0.28 mmol, 1.05 eq) were combined in a 50 mL Schlenk flask and 5 mL of cyclohexane and 1 mL of dichloromethane was added at c.a. 10° C. Ethylene was bubbled into the solution and headspace for c.a. 10 seconds every 30 minutes for 1 hour until the reaction turned colorless. Insoluble materials (AuCl, KCl) were removed via cannula filtration through a celite packed frit, and the solvent was removed under reduced pressure to yield a white powder. This was recrystallized from a concentrated dichloromethane solution at −30° C. overnight to yield colorless X-ray quality single crystals. This complex decomposes within 1 hour when stored under a nitrogen atmosphere at room temperature. Consequently, satisfactory CHN analysis could not be performed. Yield: 0.131 g (88%). ¹H NMR (500 MHz, CDCl₃): δ (ppm) 8.08 (d, ³J=8.7 Hz, 2H, Py³¹⁵), 7.86 (t, ³J=8.3 Hz, 2H, Py⁴), 7.52-7.48 (m, 2H, Py^{5/3}), 3.41 (s, 4H, C₂H₄), 0.38 (br s, 6H, BMe₂). ¹³C{¹H} NMR (126 MHz, CDCl₃): δ (ppm) 192.7 (q*, ¹J_{C-B}=50.6 Hz, Py²), 145.5 (q, ²J_{C-F}=31.8 Hz, Py⁶), 135.8 (Py), 132.6 (Py), 122.1 (q, ¹J_{C-F}=274.2 Hz, CF₃), 117.8 (Py), 57.1 (C₂H₄), 13.7 (q*, ¹J_{C-B}=40.2 Hz, BMe). ¹⁹F NMR (471 MHz, CDCl₃): a (ppm) −65.40.

X-ray Data Collection and Structure Determinations. A suitable crystal covered with a layer of hydrocarbon/Paratone-N oil was selected and mounted on a Cryo-loop, and immediately placed in the low-temperature nitrogen stream. The X-ray intensity data of [MeB(6-(CF₃)Py)₃]H (9-H), [Me₂B(6-(CF₃)Py)₂]H (8-H), [MeB(6-(CF₃)Py)₃]Cu(C₂H₄) (12), [MeB(6-(CF₃)Py)₃]Ag(C₂H₄) (13), [MeB(6-(CF₃)Py)₃]Au(C₂H₄) (14), [Me₂B(6-(CF₃)Py)₂]Cu(C₂H₄) (15), [Me₂B(6-(CF₃)Py)₂]Au(C₂H₄) (17) were on a Bruker instrument with Smart ApexII detector, equipped with an Oxford Cryosystems 700 series cooler, a graphite monochromator, and a Mo Ku fine-focus sealed tube (λ=0.71073 Å). Intensity data were processed using the Bruker Apex program suite. Data were collected at 100(2) K (except the data of 13 at 150(2) K, due to crystal cracking issues). Absorption corrections were applied by using programs in Bruker Apex3 or 4 suites. Initial atomic positions were located by SHELXT, and the structures of the compounds were refined by the least-squares method using SHELXL within Olex2 GUI. (Sheldrick, G., SHELXT—Integrated space-group and crystal-structure determination. Acta Crystallogr. A 2015, 71 (1), 3-8; Sheldrick, G., Crystal structure refinement with SHELXL. Acta Crystallogr. C 2015, 71 (1), 3-8; Dolomanov, O. V.; Bourhis, L. J.; Gildea, R. J.; Howard, J. A. K.; Puschmann, H., OLEX2: a complete structure solution, refinement and analysis program. J. Appl. Crystallogr. 2009, 42 (2), 339-341.) All the non-hydrogen atoms were refined anisotropically. The remaining hydrogen atoms, except those noted below, were included at their calculated positions and refined as riding on the atoms to which they are joined. The hydrogen atoms on ethylene carbons of [MeB(6-(CF₃)Py)₃]Cu(C₂H₄) (12), [MeB(6-(CF₃)Py)₃]Ag(C₂H₄) (13), and complexes and on nitrogens of [MeB(6-(CF₃)Py)₃]H (9-H) and [Me₂B(6-(CF₃)Py)₂]H (8-H) were located in the difference map and refined freely. There are two half-molecules of [Me₂B(6-(CF₃)Py)₂]H (8-H) in the asymmetric unit, with each fragment sitting on a mirror plane. The asymmetric unit of [Me₂B(6-(CF₃)Py)₂]Au(C₂H₄) (17) contains two molecules. There were disordered hexane molecules in the asymmetric units of [MeB(6-(CF₃)Py)₃]Cu(C₂H₄) (12) and [MeB(6-(CF₃)Py)₃]Au(C₂H₄) (14) which could not be modeled satisfactorily, and therefore removed from the election density map using the OLEX2 solvent mask command. X-ray structural figures were generated using Olex2. (Dolomanov, O. V.; Bourhis, L. J.; Gildea, R. J.; Howard, J. A. K.; Puschmann, H., OLEX2: a complete structure solution, refinement and analysis program. J. Appl. Crystallogr. 2009, 42 (2), 339-341.)

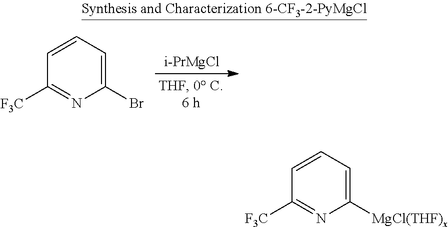

This was prepared and isolated in a similar manner to Example 2, but with slight modifications to minimize decomposition and greatly increase the yield (38%→82%).

2-bromo-6-(trifluoromethyl)pyridine (25.0 g, 110.6 mmol, 1 eq) was dissolved in THE (55 mL, c.a. 2 M). This was cooled to 0° C., and iso-propylmagnesium chloride (60 mL, 2 M, 121.6 mmol, 1.1 eq; prepared from 11.1 mL of i-PrCl, 3.50 g Mg turnings, 50 mL THF) was added dropwise with stirring. Once the addition was complete, the reaction was kept stirring while maintaining 0° C. for an additional 6-8 hours or until precipitation is observed. N.B. The study observed significantly lower yields when the pyridyl Grignard is allowed to come to room temperature in solution. All THE was thoroughly removed via reduced pressure, yielding brown solids. These solids were suspended in minimal (c.a. 30-50 mL) cold diethyl ether (0° C.) and transferred to a fritted addition funnel under careful nitrogen protection. Additional cold diethyl ether and scratching with a long spatula can be used to aid in complete transfer. The tan product was collected on the frit and washed with minimal cold diethyl ether until the washings were no longer colored, leaving behind a fluffy tan powder. This can be further dried under reduced pressure overnight. Once thoroughly dry, the off-white product can be carefully transferred into a tared Schlenk flask or stored in a glovebox.

This compound is stable as a solid for months when stored in a Schlenk flask under nitrogen in a −20° C. freezer or inside the glovebox. Yield: 28.50 g (82% if ((6-(CF₃)-2-PyMgCl)₂·(THF)₃) is assumed). This product was used directly without further purification or characterization.

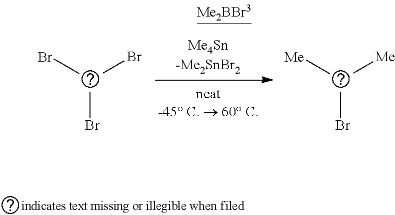

A dry 2 neck flask was equipped with a stir bar, new septum, and a short path distillation apparatus with a tared 50 mL Schlenk receiving flask and the setup was thoroughly dried. The flask was cooled to −78° C. (boron tribromide freezes at −46° C.) and charged with boron tribromide (5 mL, 13.2 g, 52.7 mmol, 1 eq) and tetramethyltin (7.3 mL, 9.42 g, 52.7 mmol, 1 eq). The flask was allowed to warm to c.a. −45° C. (xylene/dry-ice or 60% glycol 40% ethanol+dry ice) so that the boron tribromide would melt and kept stirring for 2 hours before allowing to warm to room temperature for a subsequent hour. The flask was then warmed slowly to c.a. 40° C. until dimethylboron bromide began to distill over (b.p. 30-31° C.) as a colorless liquid. Heating was progressively increased to 70° C. until no more distillate occurred, leaving behind dimethyltin dibromide as a greyish white solid. The colorless product can be used neat immediately, but rapidly fumes and decomposes. It is best handled and stored by diluting with toluene or dichloromethane to c.a. 1 M, transferred to a Teflon sealed pressure flask (AlkylₓBX_{y} compounds react with grease and lead to frozen joints otherwise), and kept in an explosion-proof refrigerator (0° C.). Yield: 5.60 g (88%). Purity can be analyzed via ¹¹B NMR spectroscopy. N.B. the dimethyltin dibromide byproduct can be stored rather than discarded and transformed back into tetramethyltin by treatment with methylmagnesium iodide or methyllithium followed by distillation. ¹¹B NMR (160 MHz, non-deuterated toluene, referenced to external BF₃·OEt₂) δ (ppm)=78.39 (Me₂BBr), 61.32 (MeBBr₂, trace) 40.54 (BBr₃, trace) 32.17 (MeB(OH)₂, trace from adventitious moisture during sample preparation).

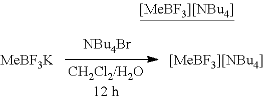

To a solution of MeBF₃K (4.9 g, 40.2 mmol, 1.25 eq) in water (40 mL) was added a solution of ⁿBu₄NBr (10.36 g, 32.2 mmol, 1 eq) in dichloromethane (120 mL) and kept stirring for 12 h. The layers were separated, and the aqueous layer was extracted with additional dichloromethane (3×25 mL). The organic extracts were combined, dried over Na₂SO₄, and evaporated to dryness to give the MeBF₃ⁿBu₄N as a white colored solid. Yield: 9.92 g (94.9%). ¹H NMR (500 MHz, CDCl₃) δ=3.21 (t, J=7.5 Hz, 8H, NCH₂CH₂CH₂CH₃), 1.60 (quint, J=7.5 Hz, 8H, NCH₂CH₂CH₂CH₃), 1.41 (sext, J=8 Hz, 8H, NCH₂CH₂CH₂CH₃), 0.98 (t, J=7.5 Hz, 12H, NCH₂CH₂CH₂CH₃), −0.30 (q, ²J_{H-F}=8.3 Hz, 3H, BMe). ¹³C{¹H} NMR (126 MHz, CDCl₃) δ=58.64, 23.97, 19.74, 13.72, BMe Unobserved due to ¹J_{C-B} and ²J_{C-F}. ¹⁹F NMR (471 MHz, CDCl₃) δ=−134.3 (q*, ¹J_{F-B}=55.0 Hz).

The methods and compositions of the appended claims are not limited in scope by the specific methods and compositions described herein, which are intended as illustrations of a few aspects of the claims and any methods and compositions that are functionally equivalent are within the scope of this disclosure. Various modifications of the methods and compositions in addition to those shown and described herein are intended to fall within the scope of the appended claims. Further, while only certain representative methods, compositions, and aspects of these methods and compositions are specifically described, other methods and compositions and combinations of various features of the methods and compositions are intended to fall within the scope of the appended claims, even if not specifically recited. Thus, a combination of steps, elements, components, or constituents can be explicitly mentioned herein; however, all other combinations of steps, elements, components, and constituents are included, even though not explicitly stated.

What is claimed is:

1. A poly(pyridyl)borate ligand defined by Formula I: 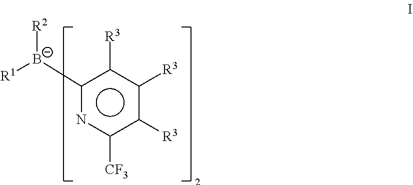
wherein
R¹ and R² are independently selected from hydrogen, a substituted or unsubstituted C₁-C₄ alkyl, a substituted or unsubstituted C₆-C₁₀ aryl or C₄-C₁₀ heteroaryl, or a halogen; and each R³ is independently hydrogen, a halogen, a substituted or unsubstituted C₁-C₄ alkyl, or a substituted or unsubstituted C₁-C₄ alkoxy.

2. The poly(pyridyl)borate ligand of claim 1, wherein the poly(pyridyl)borate ligand is further defined by Formula II: 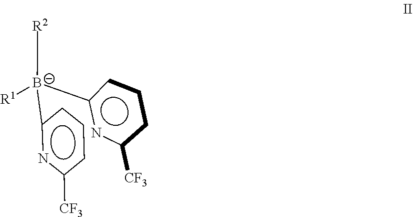
wherein
R¹ and R² are independently selected from hydrogen, a substituted or unsubstituted C₁-C₄ alkyl, a substituted or unsubstituted C₆-C₁₀ aryl or C₄-C₁₀ heteroaryl, or a halogen.

3. The poly(pyridyl)borate ligand of claim 1, wherein R¹ is:

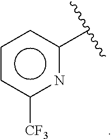

4. The poly(pyridyl)borate ligand of claim 1, wherein R¹ is an unsubstituted C₁-C₄ alkyl.

5. The poly(pyridyl)borate ligand of claim 1, wherein R¹ is —CH₃.

6. The poly(pyridyl)borate ligand of claim 1, wherein R¹ is hydrogen.

7. The poly(pyridyl)borate ligand of claim 3, wherein the poly(pyridyl)borate ligand is further defined by Formula III: 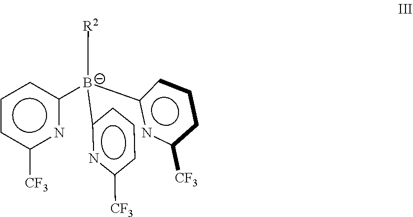
wherein
R² is selected from hydrogen, a substituted or unsubstituted C₁-C₄ alkyl, a substituted or unsubstituted C₆-C₁₀ aryl or C₄-C₁₀ heteroaryl, or a halogen.

8. The poly(pyridyl)borate ligand of claim 1, wherein R² is a substituted or unsubstituted aryl group.

9. The poly(pyridyl)borate ligand of claim 1, wherein R² is 4-tert-butylphenyl.

10. The poly(pyridyl)borate ligand of claim 1, wherein R² is phenyl.

11. The poly(pyridyl)borate ligand of claim 1, wherein R² is —CH₃.

12. A metal complex comprising the poly(pyridyl)borate ligand of claim 1 and a transition metal.

13. The metal complex of claim 12, wherein the metal complex is further defined by Formula IV: 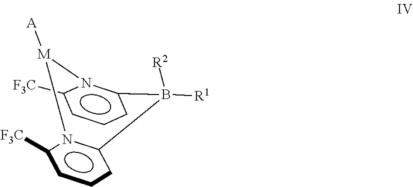
wherein
R¹ and R² are independently selected from hydrogen, a substituted or unsubstituted C₁-C₄ alkyl, a substituted or unsubstituted C₆-C₁₀ aryl or C₄-C₁₀ heteroaryl, or a halogen;
M is a transition metal; and
A is selected from an olefin, isocyanide, or CO.

14. The metal complex of claim 12, wherein the metal complex is further defined by Formula V: 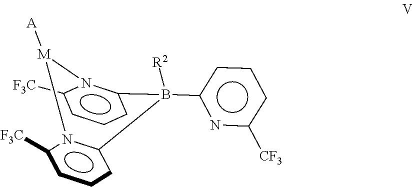
wherein
R² is selected from hydrogen, a substituted or unsubstituted C₁-C₄ alkyl, a substituted or unsubstituted C₆-C₁₀ aryl or C₄-C₁₀ heteroaryl, or a halogen;
M is a transition metal; and
A is selected from an olefin, isocyanide, or CO.

15. The metal complex of claim 12, wherein A is ethylene.

16. The metal complex of claim 12, wherein M is selected from Au, Ag, Cu.

17. The metal complex of claim 12, wherein M is Au.

18. The metal complex of claim 12, wherein M is Ag.

19. The metal complex of claim 12, wherein M is Cu.

20. A method of preparing a poly(pyridyl)borate ligand comprising: contacting a boron precursor comprising a trifluoroborate with a pyridine reagent to form the poly(pyridyl)borate ligand.
